(19) United States
(12) Patent Application Publication
(10) Pub. No.: US 2007/0010399 A1
(43) Pub. Date: Jan. 11, 2007

(54) Crop plant-compatible herbicidal compositions comprising herbicides and safeners

(75) Inventors: Christopher Rosinger, Hofheim (DE); Paul Evans, Odenthal (DE); Erwin Hacker, Hochheim (DE)

Correspondence Address: CONNOLLY BOVE LODGE & HUTZ, LLP, P O BOX 2207, WILMINGTON, DE, 19899, US

(73) Assignee: Bayer CropScience GmbH, Frankfurt am Main (DE)

(21) Appl. No.: 11/482,087

(22) Filed: Jul. 6, 2006

(30) Foreign Application Priority Data
Jul. 7, 2005 (DE) 10 2005 031 787.1

(51) Int. Cl. A01N 25/32

(52) U.S. Cl. 504/111

(57) ABSTRACT

Crop plant-compatible herbicidal compositions comprising herbicides and safeners Crop plant-compatible herbicidal compositions comprising
A) a compound from the group of the acylsulfamoylbenzamides of the formula (I), 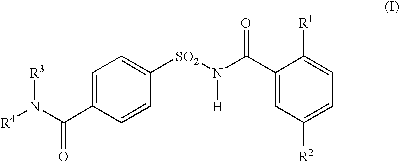
in which R¹, R², R³ and R⁴ are hydrogen, chlorine or various organic radicals, B) at least one herbicide and C) if appropriate a fungicide and/or insecticide are described as herbicides which are active against monocotyledonous and/or dicotyledonous harmful plants. Compared to the herbicides used on their own, these compositions have better compatibility with crop plants.

The invention relates to the technical field of crop protection compositions which can be used against unwanted vegetation and which comprise, as active compounds, a combination of at least one herbicide and at least one safener.

In general, herbicides are not always sufficiently compatible with (i.e. not selective enough in) some important crop plants such as corn, rice or cereals, so that their use is strictly limited. As a result, in some crops, they can not be used or only be used at application rates which are so low that the desired broad herbicidal activity against harmful plants is not ensured. Specifically, many herbicides cannot be used entirely selectively against harmful plants in corn, rice, cereals, sugarcane and some other crops.

To overcome these disadvantages, it is known to use herbicides in combination with a safener or antidote. A safener is to be understood as meaning a compound which eliminates or reduces the phytotoxic properties of a herbicide in respect to useful plants, without substantially reducing the herbicidal activity against harmful plants. Herbicidal compositions comprising herbicides and safeners are already known from some documents. Thus, for example, WO 96/14304 describes herbicidal compositions of sulfonylureas and WO 03/022050 describes herbicidal compositions of benzoylisoxazoles, in each case with a large number of safeners of various structures. U.S. Pat. No. 6,251,827 discloses safeners of the type of the acylsulfamoyl-benzamides. However, in practice, the use of the herbicidal compositions known from these publications is frequently associated with disadvantages. Thus, the herbicidal activity of the known compounds is not always sufficient, or, if the herbicidal activity is sufficient, then undesired damage to the useful plants is observed.

It is an object of the present invention to provide herbicidal compositions having better properties than those of the prior art.

It has now been found that selected combinations of certain herbicides with a number of safeners are highly compatible with crops of useful plants and, at the same time, highly effective against unwanted harmful plants.

The invention provides selected herbicidal compositions, characterized in that they comprise an effective amount of

A) an antidotically effective amount of one or more safeners from the group of the acylsulfamoylbenzamides of the formula (I), if appropriate also in salt form, (component A) 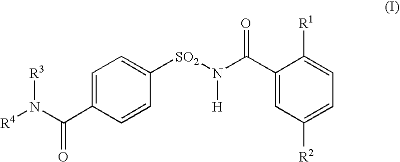
in which
R¹ is methyl, methoxy or trifluoromethoxy;
R² is hydrogen, chlorine or methyl;
R³ is hydrogen, ethyl or propargyl;
R⁴ is ethyl, cyclopropyl, isopropyl or propargyl, or
R³ and R⁴ together form the group (CH₂)₄;
and

B) a herbicidally effective amount of one or more herbicides (component B) selected from groups B1 to B10:

B1 inhibitors of the amino acid biosynthesis flucarbazone (B1.1), foramsulfuron (B1.2), iodosulfuron (B1.3), metosulam (B1.4), metsulfuron (B1.5), nicosulfuron (B1.6), primisulfuron (B1.7), prosulfuron (B1.8), thifensulfuron (B1.9), tribenuron (B1.10), cloransulam-methyl (B1.11), chlorimuron (B1.12), ethoxysulfuron (B1.13), flazasulfuron (B1.14), florasulam (B1.15), flumetsulam.(B1.16), halosulfuron (B1.17), imazamox (B1.18), imazapic (B1.19), imazapyr (B1.20), imazethapyr (B1.21), mesosulfuron (B1.22), propoxycarbazone (B1.23), sulfosulfuron (B1.24), amidosulfuron (B1.25), chlorsulfuron (B1.26), imazaquin (B1.27), triasulfuron (B1.28), sulfometuron (B1.29), cyclosulfamuron (B1.30), flupyrsulfuron (B1.31), pyrazosulfuron (B1.32), azimsulfuron (B1.33), bensulfuron (B1.34), bispyribac (B1.35), rimsulfuron (B1.36), tritosulfuron (B1.37);

B2 inhibitors of hydroxyphenylpyruvate dioxygenase sulcotrione (B2.1), clomazone (B2.2), mesotrione (B2.3), topramezone (B2.4);

B3 inhibitors of the photosynthesis electron transport metribuzin (B3.1), bentazone (B3.2), bromoxynil (B3.3), propanil (B3.4), atrazine (B3.5), terbuthylazine (B3.6);

B4 inhibitors of the fatty acid biosynthesis EPTC (B4.1), tepraloxydim (B4.2), clethodim (B4.3), alloxydim (B4.4), sethoxydim (B4.5), tralkoxydim (B4.6), clodinafop-propargyl (B4.7), cyhalofop-butyl (B4.8), diclofop-methyl (B4.9), fenoxaprop-P-ethyl (B4.10), fluazifop-P-butyl (B4.11), haloxyfop-methyl (B4.12), haloxyfop-etotyl (B4.13), haloxyfop-R-methyl (B4.14), haloxyfop-ethoxyethyl (B4.15), propaquizafop (B4.16), quizalofop-P-tefuryl (B4.17), quizalofop-P-ethyl (B4.18);

B5 inhibitors of cell division acetochlor (B5.1), S-metolachlor (B5.2),

B6 inhibitors of protoporphyrinogen oxidase flumioxazin (B6.1), flumiclorac (B6.2), fomesafen (B6.3), sulfentrazone (B6.4);

B7 synthetic auxins dicamba (B7.1), MCPA (B7.2), MCPB (B7.3), 2,4-D (B7.4), clopyralid (B7.5), fluroxypyr (B7.6),.picloram (B7.7), triclopyr (B7.8);

B8 glufosinate (B8.1);

B9 glyphosate (B9.1);

B10 pendimethalin (B10.1),

where these compositions comprise components A and B in a weight ratio of from 1:200 to 200:1, preferably from 1:100 to 100:1, particularly preferably from 1:50 to 50:1.

The chemical structures of the active compounds, referred to above and also below by their common names, are known, for example, from “The Pesticide Manual” 13th edition, 2003, British Crop Protection Council, and from the Website http://www.hclrss.demon.co.uk.

If, in the context of this description, the short form of the common name of an active compound is used, this includes in each case all customary derivatives, such as esters and salts, and isomers, in particular optical isomers, and in particular the commercially available form or forms. If the common name refers to an ester or salt, it also includes in each case all other customary derivatives, such as other esters and salts, the free acids and neutral compounds, and isomers, in particular optical isomers, in particular the commercially available form or forms. The stated chemical compound names refer to at least one of the compounds embraced by the common name, frequently a preferred compound.

Hereinbelow, the terms “component A” and “safener A” are to be understood as meaning the same. This applies analogously to the terms “component B” and “herbicide B”.

The safeners A can also be employed in the form of their salts. These include in particular the salts of the alkali metals and alkaline earth metals, such as sodium, potassium, magnesium and calcium. The salts can be prepared by reactions known to the person skilled in the art, for example by reacting the safeners A with the appropriate bases, such as sodium hydroxide or potassium hydroxide.

The herbicidal compositions according to the invention are highly compatible with crop plants. The high compatibility with crop plants can be observed, for example, when components A and B are applied together, and frequently it can also be observed when the components are applied at different times (splitting). It is also possible to use the individual herbicides and safeners or the herbicide/safener combinations in a plurality of portions (sequential application), for example applications by the pre-emergence method, followed by post-emergence applications or early post-emergence applications, followed by applications at medium or late post-emergence. Preferred is the joint or nearly simultaneous application of the active compounds' safener and herbicide.

The invention also embraces herbicidal compositions comprising, in addition to components A and B, one or more further agrochemically active compound(s) of a different structure, such as herbicides, insecticides, fungicides or safeners. The preferred conditions illustrated above and below also apply to these herbicidal compositions.

The invention also embraces herbicidal compositions comprising, in addition to components A and B, fertilizers, such as ammonium sulfate, ammonium nitrate, urea, potassium nitrate and mixtures thereof. The preferred conditions illustrated above and below also apply to these herbicidal compositions.

The invention also embraces herbicidal compositions comprising, in addition to components A and B, adjuvants, such as emulsifiers, dispersants, mineral and vegetable oils and mixtures thereof. The preferred conditions illustrated above and below also apply to these herbicidal compositions.

Of particular interest are herbicidal compositions comprising

A) as component A acylsulfamoylbenzamides of the formula (I) as defined above and

B) as component B one or more herbicides selected from groups B1 to B10:

B1 inhibitors of the amino acid biosynthesis flucarbazone (B1.1), foramsulfuron (B1.2), iodosulfuron (B1.3), metosulam (B1.4), metsulfuron (B1.5), nicosulfuron (B1.6), primisulfuron (B1.7), prosulfuron (B1.8), thifensulfuron (B1.9), tribenuron (B1.10), cloransulam-methyl (B1.11), chlorimuron (B1.12), ethoxysulfuron (B1.13), flazasulfuron (B1.14), florasulam (B1.15), flumetsulam (B1.16), halosulfuron (B1.17), imazamox (B1.18), imazapic (B1.19), imazapyr (B1.20), imazethapyr (B1.21), mesosulfuron (B1.22), propoxycarbazone (B1.23), sulfosulfuron (B1.24), amidosulfuron (B1.25), chlorsulfuron (B1.26), imazaquin (B1.27), triasulfuron (B1.28), sulfometuron (B1.29), cyclosulfamuron (B1.30), flupyrsulfuron (B1.31), pyrazosulfuron (B1.32), azimsulfuron (B1.33), bensulfuron (B1.34), bispyribac (B1.35);

B2 inhibitors of hydroxyphenylpyruvate dioxygenase sulcotrione (B2.1), clomazone (B2.2), mesotrione (B2.3), topramezone (B2.4);

B3 inhibitors of the photosynthesis electron transport metribuzin (B3.1), bentazone (B3.2), bromoxynil (B3.3), propanil (B3.4);

B4 inhibitors of the fatty acid biosynthesis EPTC (B4.1), tepraloxydim (B4.2), clethodim (B4.3);

B5 inhibitors of cell division acetochlor (B5.1), S-metolachlor (B5.2),

B6 inhibitors of protoporphyrinogen oxidase flumioxazin (B6.1), flumiclorac (B6.2), fomesafen (B6.3), sulfentrazone (B6.4);

B7 synthetic auxins dicamba (B7.1), MCPA (B7.2), MCPB (B7.3), 2,4-D (B7.4), clopyralid (B7.5), fluroxypyr (B7.6), picloram (B7.7), triclopyr (B7.8);

B8 glufosinate (B8.1);

B9 glyphosate (B9.1);

B10 pendimethalin (B10.1).

Also of particular interest are herbicidal compositions comprising, as component A, acylsulfamoylbenzamides of the formula (I) in which
R¹ is methoxy;
R² is hydrogen, chlorine or methyl;
R³ is hydrogen or ethyl;
R⁴ is ethyl, cyclopropyl or isopropyl.

Of very particular interest are herbicidal compositions comprising, as component A, one or more of the safeners A1, A2, A3 or A4:

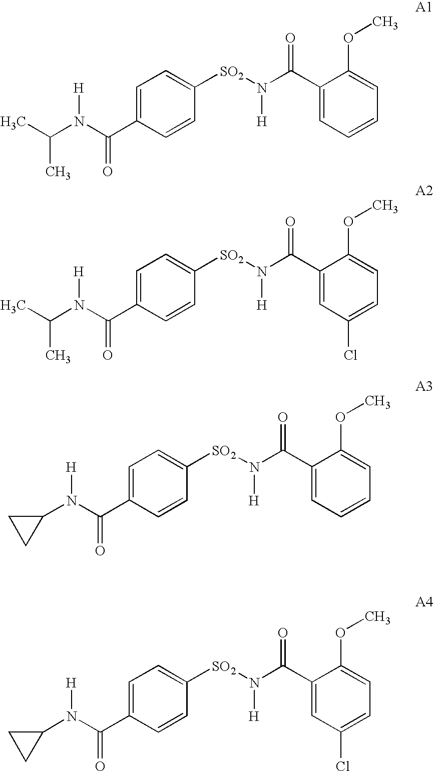

Also of very particular interest are herbicidal compositions comprising, as component B, one or more herbicides selected from the group consisting of flucarbazone, foramsulfuron, iodosulfuron, metosulam, metsulfuron, nicosulfuron, primisulfuron, prosulfuron, thifensulfuron, tribenuron, cloransulam-methyl, chlorimuron, ethoxysulfuron, flazasulfuron, florasulam, flumetsulam, halosulfuron, imazamox, imazapic, imazapyr, imazethapyr, mesosulfuron, propoxycarbazone, sulfosulfuron, sulcotrione, mesotrione, topramezone, metribuzin, acetochlor, S-metolachlor, sulfentrazone, dicamba, MCPA, MCPB, 2,4-D, glufosinate and glyphosate.

Preferred herbicidal compositions are those comprising one or more of the combinations, mentioned in Table 1, of components A and B.

TABLE 1
(A1 + B1.1), (A1 + B1.2), (A1 + B1.3), (A1 + B1.4), (A1 + B1.5), (A1 + B1.6), (A1 + B1.7),
(A1 + B1.8), (A1 + B1.9), (A1 + B1.10), (A1 + B1.11), (A1 + B1.12), (A1 + B1.13),
(A1 + B1.14), (A1 + B1.15), (A1 + B1.16), (A1 + B1.17), (A1 + B1.18), (A1 + B1.19),
(A1 + B1.20), (A1 + B1.21), (A1 + B1.22), (A1 + B1.23), (A1 + B1.24), (A1 + B2.1),
(A1 + B2.2), (A1 + B2.3), (A1 + B2.4), (A1 + B3.1), (A1 + B5.1), (A1 + B5.2), (A1 + B6.4),
(A1 + B7.1), (A1 + B7.2), (A1 + B7.3), (A1 + B7.4), (A1 + B8.1), (A1 + B9.1), (A1 + B10.1),
(A2 + B1.1), (A2 + B1.2), (A2 + B1.3), (A2 + B1.4), (A2 + B1.5), (A2 + B1.6), (A2 + B1.7),
(A2 + B1.8), (A2 + B1.9), (A2 + B1.10), (A2 + B1.11), (A2 + B1.12), (A2 + B1.13),
(A2 + B1.14), (A2 + B1.15), (A2 + B1.16), (A2 + B1.17), (A2 + B1.18), (A2 + B1.19),
(A2 + B1.20), (A2 + B1.21), (A2 + B1.22), (A2 + B1.23), (A2 + B1.24), (A2 + B2.1),
(A2 + B2.2), (A2 + B2.3), (A2 + B2.4), (A2 + B3.1), (A2 + B5.1), (A2 + B5.2), (A2 + B6.4),
(A2 + B7.1), (A2 + B7.2), (A2 + B7.3), (A2 + B7.4), (A2 + B8.1), (A2 + B9.1), (A2 + B10.1),
(A3 + B1.1), (A3 + B1.2), (A3 + B1.3), (A3 + B1.4), (A3 + B1.5), (A3 + B1.6), (A3 + B1.7),
(A3 + B1.8), (A3 + B1.9), (A3 + B1.10), (A3 + B1.11), (A3 + B1.12), (A3 + B1.13),
(A3 + B1.14), (A3 + B1.15), (A3 + B1.16), (A3 + B1.17), (A3 + B1.18), (A3 + B1.19),
(A3 + B1.20), (A3 + B1.21), (A3 + B1.22), (A3 + B1.23), (A3 + B1.24), (A3 + B2.1),
(A3 + B2.2), (A3 + B2.3), (A3 + B2.4), (A3 + B3.1), (A3 + B5.1), (A3 + B5.2), (A3 + B6.4),
(A3 + B7.1), (A3 + B7.2), (A3 + B7.3), (A3 + B7.4), (A3 + B8.1), (A3 + B9.1), (A3 + B10.1),
(A4 + B1.1), (A4 + B1.2), (A4 + B1.3), (A4 + B1.4), (A4 + B1.5), (A4 + B1.6), (A4 + B1.7),
(A4 + B1.8), (A4 + B1.9), (A4 + B1.10), (A4 + B1.11), (A4 + B1.12), (A4 + B1.13),
(A4 + B1.14), (A4 + B1.15), (A4 + B1.16), (A4 + B1.17), (A4 + B1.18), (A4 + B1.19),
(A4 + B1.20), (A4 + B1.21), (A4 + B1.22), (A4 + B1.23), (A4 + B1.24), (A4 + B2.1),
(A4 + B2.2), (A4 + B2.3), (A4 + B2.4), (A4 + B3.1), (A4 + B5.1), (A4 + B5.2), (A4 + B6.4),
(A4 + B7.1), (A4 + B7.2), (A4 + B7.3), (A4 + B7.4), (A4 + B8.1), (A4 + B9.1), (A4 + B10.1).

Other preferred herbicidal compositions are those comprising one or more of the combinations, mentioned in Table 2, of components A and B

TABLE 2
(A1 + B1.36), (A1 + B1.37), (A1 + B3.5), (A1 + B3.6), (A1 + B4.4), (A1 + B4.5), (A1 + B4.6),
(A1 + B4.7), (A1 + B4.8), (A1 + B4.9), (A1 + B4.10), (A1 + B4.11), (A1 + B4.12), (A1 + B4.13),
(A1 + B4.14), (A1 + B4.15, (A1 + B4.16), (A1 + B4.17), (A1 + B4.18), (A1 + B4.19),
(A2 + B1.36), (A2 + B1.37), (A2 + B3.5), (A2 + B3.6), (A2 + B4.4), (A2 + B4.5), (A2 + B4.6),
(A2 + B4.7), (A2 + B4.8), (A2 + B4.9), (A2 + B4.10), (A2 + B4.11), (A2 + B4.12), (A2 + B4.13),
(A2 + B4.14), (A2 + B4.15, (A2 + B4.16), (A2 + B4.17), (A2 + B4.18), (A2 + B4.19),
(A3 + B1.36), (A3 + B1.37), (A3 + B3.5), (A3 + B3.6), (A3 + B4.4), (A3 + B4.5), (A3 + B4.6),
(A3 + B4.7), (A3 + B4.8), (A3 + B4.9), (A3 + B4.10), (A3 + B4.11), (A3 + B4.12), (A3 + B4.13),
(A3 + B4.14), (A3 + B4.15, (A3 + B4.16), (A3 + B4.17), (A3 + B4.18), (A3 + B4.19),
(A4 + B1.36), (A4 + B1.37), (A4 + B3.5), (A4 + B3.6), (A4 + B4.4), (A4 + B4.5), (A4 + B4.6),
(A4 + B4.7), (A4 + B4.8), (A4 + B4.9), (A4 + B4.10), (A4 + B4.11), (A4 + B4.12), (A4 + B4.13),
(A4 + B4.14), (A4 + B4.15, (A4 + B4.16), (A4 + B4.17), (A4 + B4.18), (A4 + B4.19).

Particularly preferred herbicidal compositions comprising one or more of the combinations, mentioned. in Table 3, of components A and B.

TABLE 3
(A1 + B1.1), (A1 + B1.2), (A1 + B1.3), (A1 + B1.4), (A1 + B1.5), (A1 + B1.6), (A1 + B1.7),
(A1 + B1.8), (A1 + B1.9), (A1 + B1.10), (A1 + B2.1), (A1 + B2.2), (A1 + B2.3), (A1 + B2.4),
(A1 + B5.1), (A1 + B5.2), (A1 + B7.1), (A1 + B8.1), (A1 + B9.1), (A1 + B10.1),
(A2 + B1.1), (A2 + B1.2), (A2 + B1.3), (A2 + B1.4), (A2 + B1.5), (A2 + B1.6), (A2 + B1.7),
(A2 + B1.8), (A2 + B1.9), (A2 + B1.10), (A2 + B2.1), (A2 + B2.2), (A2 + B2.3), (A2 + B2.4),
(A2 + B5.1), (A2 + B5.2), (A2 + B7.1), (A2 + B8.1), (A2 + B9.1), (A2 + B10.1),
(A3 + B1.1), (A3 + B1.2), (A3 + B1.3), (A3 + B1.4), (A3 + B1.5), (A3 + B1.6), (A3 + B1.7),
(A3 + B1.8), (A3 + B1.9), (A3 + B1.10), (A3 + B2.1), (A3 + B2.2), (A3 + B2.3), (A3 + B2.4),
(A3 + B5.1), (A3 + B5.2), (A3 + B7.1), (A3 + B8.1), (A3 + B9.1), (A3 + B10.1),
(A4 + B1.1), (A4 + B1.2), (A4 + B1.3), (A4 + B1.4), (A4 + B1.5), (A4 + B1.6), (A4 + B1.7),
(A4 + B1.8), (A4 + B1.9), (A4 + B1.10), (A4 + B2.1), (A4 + B2.2), (A4 + B2.3), (A4 + B2.4),
(A4 + B5.1), (A4 + B5.2), (A4 + B7.1), (A4 + B8.1), (A4 + B9.1), (A4 + B10.1).

In a further preferred embodiment, the herbicidal compositions according to the invention comprise one component A and two different components B of the abovementioned groups B1 to B10. In a particularly preferred embodiment, the herbicidal compositions according to the invention comprise, as component A, the safener A3, and one component B of in each case one of groups B1 to B10. In a further particularly preferred embodiment, the herbicidal compositions according to the invention comprise, as component A, the safener A3, and two different components B. Such particularly preferred embodiments are listed in Table 4.

TABLE 4
(A3 + B1.1 + B1.2), (A3 + B1.1 + B1.3), (A3 + B1.1 + B1.4), (A3 + B1.1 + B1.5),
(A3 + B1.1 + B1.6), (A3 + B1.1 + B1.7), (A3 + B1.1 + B1.8), (A3 + B1.1 + B1.9),
(A3 + B1.1 + B1.10), (A3 + B1.1 + B1.11), (A3 + B1.1 + B1.12), (A3 + B1.1 + B1.13),
(A3 + B1.1 + B1.14), (A3 + B1.1 + B1.15), (A3 + B1.1 + B1.16), (A3 + B1.1 + B1.17),
(A3 + B1.1 + B1.18), (A3 + B1.1 + B1.19), (A3 + B1.1 + B1.21), (A3 + B1.1 + B1.22),
(A3 + B1.1 + B1.23), (A3 + B1.1 + B1.24), (A3 + B1.1 + B1.25), (A3 + B1.1 + B1.26),
(A3 + B1.1 + B1.27), (A3 + B1.1 + B1.28), (A3 + B1.1 + B1.29), (A3 + B1.1 + B1.30),
(A3 + B1.1 + B1.31), (A3 + B1.1 + B1.32), (A3 + B1.1 + B1.33), (A3 + B1.1 + B1.34),
(A3 + B1.1 + B1.35), (A3 + B1.1 + B1.36), (A3 + B1.1 + B1.37),
(A3 + B1.1 + B2.1), (A3 + B1.1 + B2.2), (A3 + B1.1 + B2.3), (A3 + B1.1 + B2.4),
(A3 + B1.1 + B3.1), (A3 + B1.1 + B3.2), (A3 + B1.1 + B3.3), (A3 + B1.1 + B3.4),
(A3 + B1.1 + B3.5), (A3 + B1.1 + B3.6),
(A3 + B1.1 + B4.1), (A3 + B1.1 + B4.2), (A3 + B1.1 + B4.3), (A3 + B1.1 + B4.4),
(A3 + B1.1 + B4.5), (A3 + B1.1 + B4.6), (A3 + B1.1 + B4.7), (A3 + B1.1 + B4.8),
(A3 + B1.1 + B4.9), (A3 + B1.1 + B4.10), (A3 + B1.1 + B4.11), (A3 + B1.1 + B4.12),
(A3 + B1.1 + B4.13), (A3 + B1.1 + B4.14), (A3 + B1.1 + B4.15), (A3 + B1.1 + B4.16),
(A3 + B1.1 + B4.17), (A3 + B1.1 + B4.18), (A3 + B1.1 + B4.19),
(A3 + B1.1 + B5.1), (A3 + B1.1 + B5.2),
(A3 + B1.1 + B6.1), (A3 + B1.1 + B6.2), (A3 + B1.1 + B6.3), (A3 + B1.1 + B6.4),
(A3 + B1.1 + B7.1), (A3 + B1.1 + B7.2), (A3 + B1.1 + B7.3), (A3 + B1.1 + B7.4),
(A3 + B1.1 + B7.5), (A3 + B1.1 + B7.6), (A3 + B1.1 + B7.7), (A3 + B1.1 + B7.8),
(A3 + B1.1 + B8.1), (A3 + B1.1 + B9.1), (A3 + B1.1 + B10.1),
(A3 + B1.2 + B1.3), (A3 + B1.2 + B1.4), (A3 + B1.2 + B1.5), (A3 + B1.2 + B1.6),
(A3 + B1.2 + B1.7), (A3 + B1.2 + B1.8), (A3 + B1.2 + B1.9), (A3 + B1.2 + B1.10),
(A3 + B1.2 + B1.11), (A3 + B1.2 + B1.12), (A3 + B1.2 + B1.13), (A3 + B1.2 + B1.14),
(A3 + B1.2 + B1.15), (A3 + B1.2 + B1.16), (A3 + B1.2 + B1.17), (A3 + B1.2 + B1.18),
(A3 + B1.2 + B1.19), (A3 + B1.2 + B1.21), (A3 + B1.2 + B1.22), (A3 + B1.2 + B1.23),
(A3 + B1.2 + B1.24), (A3 + B1.2 + B1.25), (A3 + B1.2 + B1.26), (A3 + B1.2 + B1.27),
(A3 + B1.2 + B1.28), (A3 + B1.2 + B1.29), (A3 + B1.2 + B1.30), (A3 + B1.2 + B1.31),
(A3 + B1.2 + B1.32), (A3 + B1.2 + B1.33), (A3 + B1.2 + B1.34), (A3 + B1.2 + B1.35),
(A3 + B1.2 + B1.36), (A3 + B1.2 + B1.37),
(A3 + B1.2 + B2.1), (A3 + B1.2 + B2.2), (A3 + B1.2 + B2.3), (A3 + B1.2 + B2.4),
(A3 + B1.2 + B3.1), (A3 + B1.2 + B3.2), (A3 + B1.2 + B3.3), (A3 + B1.2 + B3.4),
(A3 + B1.2 + B3.5), (A3 + B1.2 + B3.6),
(A3 + B1.2 + B4.1), (A3 + B1.2 + B4.2), (A3 + B1.2 + B4.3), (A3 + B1.2 + B4.4),
(A3 + B1.2 + B4.5), (A3 + B1.2 + B4.6), (A3 + B1.2 + B4.7), (A3 + B1.2 + B4.8),
(A3 + B1.2 + B4.9), (A3 + B1.2 + B4.10), (A3 + B1.2 + B4.11), (A3 + B1.2 + B4.12),
(A3 + B1.2 + B4.13), (A3 + B1.2 + B4.14), (A3 + B1.2 + B4.15), (A3 + B1.2 + B4.16),
(A3 + B1.2 + B4.17), (A3 + B1.2 + B4.18), (A3 + B1.2 + B4.19),
(A3 + B1.2 + B5.1), (A3 + B1.2 + B5.2), (A3 + B1.2 + B6.1), (A3 + B1.2 + B6.2),
(A3 + B1.2 + B6.3), (A3 + B1.2 + B6.4),
(A3 + B1.2 + B7.1), (A3 + B1.2 + B7.2), (A3 + B1.2 + B7.3), (A3 + B1.2 + B7.4),
(A3 + B1.2 + B7.5), (A3 + B1.2 + B7.6), (A3 + B1.2 + B7.7), (A3 + B1.2 + B7.8),
(A3 + B1.2 + B9.1), (A3 + B1.2 + B8.1), (A3 + B1.2 + B10.1),
(A3 + B1.3 + B1.4), (A3 + B1.3 + B1.5), (A3 + B1.3 + B1.6), (A3 + B1.3 + B1.7),
(A3 + B1.3 + B1.8), (A3 + B1.3 + B1.9), (A3 + B1.3 + B1.10), (A3 + B1.3 + B1.11),
(A3 + B1.3 + B1.12), (A3 + B1.3 + B1.13), (A3 + B1.3 + B1.14), (A3 + B1.3 + B1.15),
(A3 + B1.3 + B1.16), (A3 + B1.3 + B1.17), (A3 + B1.3 + B1.18), (A3 + B1.3 + B1.19),
(A3 + B1.3 + B1.21), (A3 + B1.3 + B1.22), (A3 + B1.3 + B1.23), (A3 + B1.3 + B1.24),
(A3 + B1.3 + B1.25), (A3 + B1.3 + B1.26), (A3 + B1.3 + B1.27), (A3 + B1.3 + B1.28),
(A3 + B1.3 + B1.29), (A3 + B1.3 + B1.30), (A3 + B1.3 + B1.31), (A3 + B1.3 + B1.32),
(A3 + B1.3 + B1.33), (A3 + B1.3 + B1.34), (A3 + B1.3 + B1.35), (A3 + B1.3 + B1.36),
(A3 + B1.3 + B1.37),
(A3 + B1.3 + B2.1), (A3 + B1.3 + B2.2), (A3 + B1.3 + B2.3), (A3 + B1.3 + B2.4),
(A3 + B1.3 + B3.1), (A3 + B1.3 + B3.2), (A3 + B1.3 + B3.3), (A3 + B1.3 + B3.4),
(A3 + B1.3 + B3.5), (A3 + B1.3 + B3.6),
(A3 + B1.3 + B4.1), (A3 + B1.3 + B4.2), (A3 + B1.3 + B4.3), (A3 + B1.3 + B4.4),
(A3 + B1.3 + B4.5), (A3 + B1.3 + B4.6), (A3 + B1.3 + B4.7), (A3 + B1.3 + B4.8),
(A3 + B1.3 + B4.9), (A3 + B1.3 + B4.10), (A3 + B1.3 + B4.11), (A3 + B1.3 + B4.12),
(A3 + B1.3 + B4.13), (A3 + B1.3 + B4.14), (A3 + B1.3 + B4.15), (A3 + B1.3 + B4.16),
(A3 + B1.3 + B4.17), (A3 + B1.3 + B4.18), (A3 + B1.3 + B4.19),
(A3 + B1.3 + B5.1), (A3 + B1.3 + B5.2), (A3 + B1.3 + B6.1), (A3 + B1.3 + B6.2),
(A3 + B1.3 + B6.3), (A3 + B1.3 + B6.4),
(A3 + B1.3 + B7.1), (A3 + B1.3 + B7.2), (A3 + B1.3 + B7.3), (A3 + B1.3 + B7.4),
(A3 + B1.3 + B7.5), (A3 + B1.3 + B7.6), (A3 + B1.3 + B7.7), (A3 + B1.3 + B7.8),
(A3 + B1.3 + B8.1), (A3 + B1.3 + B9.1), (A3 + B1.3 + B10.1),
(A3 + B1.4 + B1.5), (A3 + B1.4 + B1.6), (A3 + B1.4 + B1.7), (A3 + B1.4 + B1.8),
(A3 + B1.4 + B1.9), (A3 + B1.4 + B1.10), (A3 + B1.4 + B1.11), (A3 + B1.4 + B1.12),
(A3 + B1.4 + B1.13), (A3 + B1.4 + B1.14), (A3 + B1.4 + B1.15), (A3 + B1.4 + B1.16),
(A3 + B1.4 + B1.17), (A3 + B1.4 + B1.18), (A3 + B1.4 + B1.19), (A3 + B1.4 + B1.21),
(A3 + B1.4 + B1.22), (A3 + B1.4 + B1.23), (A3 + B1.4 + B1.24), (A3 + B1.4 + B1.25),
(A3 + B1.4 + B1.26), (A3 + B1.4 + B1.27), (A3 + B1.4 + B1.28), (A3 + B1.4 + B1.29),
(A3 + B1.4 + B1.30), (A3 + B1.4 + B1.31), (A3 + B1.4 + B1.32), (A3 + B1.4 + B1.33),
(A3 + B1.4 + B1.34), (A3 + B1.4 + B1.35), (A3 + B1.4 + B1.36), (A3 + B1.4 + B1.37),
(A3 + B1.4 + B2.1), (A3 + B1.4 + B2.2), (A3 + B1.4 + B2.3), (A3 + B1.4 + B2.4),
(A3 + B1.4 + B3.1), (A3 + B1.4 + B3.2), (A3 + B1.4 + B3.3), (A3 + B1.4 + B3.4),
(A3 + B1.4 + B3.5), (A3 + B1.4 + B3.6),
(A3 + B1.4 + B4.1), (A3 + B1.4 + B4.2), (A3 + B1.4 + B4.3), (A3 + B1.4 + B4.4),
(A3 + B1.4 + B4.5), (A3 + B1.4 + B4.6), (A3 + B1.4 + B4.7), (A3 + B1.4 + B4.8),
(A3 + B1.4 + B4.9), (A3 + B1.4 + B4.10), (A3 + B1.4 + B4.11), (A3 + B1.4 + B4.12),
(A3 + B1.4 + B4.13), (A3 + B1.4 + B4.14), (A3 + B1.4 + B4.15), (A3 + B1.4 + B4.16),
(A3 + B1.4 + B4.17), (A3 + B1.4 + B4.18), (A3 + B1.4 + B4.19),
(A3 + B1.4 + B5.1), (A3 + B1.4 + B5.2),
(A3 + B1.4 + B6.1), (A3 + B1.4 + B6.2), (A3 + B1.4 + B6.3), (A3 + B1.4 + B6.4),
(A3 + B1.4 + B7.1), (A3 + B1.4 + B7.2), (A3 + B1.4 + B7.3), (A3 + B1.4 + B7.4),
(A3 + B1.4 + B7.5), (A3 + B1.4 + B7.6), (A3 + B1.4 + B7.7), (A3 + B1.4 + B7.8),
(A3 + B1.4 + B9.1), (A3 + B1.4 + B8.1), (A3 + B1.4 + B10.1),
(A3 + B1.5 + B1.6), (A3 + B1.5 + B1.7), (A3 + B1.5 + B1.8), (A3 + B1.5 + B1.9),
(A3 + B1.5 + B1.10), (A3 + B1.5 + B1.11), (A3 + B1.5 + B1.12), (A3 + B1.5 + B1.13),
(A3 + B1.5 + B1.14), (A3 + B1.5 + B1.15), (A3 + B1.5 + B1.16), (A3 + B1.5 + B1.17),
(A3 + B1.5 + B1.18), (A3 + B1.5 + B1.19), (A3 + B1.5 + B1.21), (A3 + B1.5 + B1.22),
(A3 + B1.5 + B1.23), (A3 + B1.5 + B1.24), (A3 + B1.5 + B1.25), (A3 + B1.5 + B1.26),
(A3 + B1.5 + B1.27), (A3 + B1.5 + B1.28), (A3 + B1.5 + B1.29), (A3 + B1.5 + B1.30),
(A3 + B1.5 + B1.31), (A3 + B1.5 + B1.32), (A3 + B1.5 + B1.33), (A3 + B1.5 + B1.34),
(A3 + B1.5 + B1.35), (A3 + B1.5 + B1.36), (A3 + B1.5 + B1.37),
(A3 + B1.5 + B2.1), (A3 + B1.5 + B2.2), (A3 + B1.5 + B2.3), (A3 + B1.5 + B2.4),
(A3 + B1.5 + B3.1), (A3 + B1.5 + B3.2), (A3 + B1.5 + B3.3), (A3 + B1.5 + B3.4),
(A3 + B1.5 + B3.5), (A3 + B1.5 + B3.6),
(A3 + B1.5 + B4.1), (A3 + B1.5 + B4.2), (A3 + B1.5 + B4.3), (A3 + B1.5 + B4.4),
(A3 + B1.5 + B4.5), (A3 + B1.5 + B4.6), (A3 + B1.5 + B4.7), (A3 + B1.5 + B4.8),
(A3 + B1.5 + B4.9), (A3 + B1.5 + B4.10), (A3 + B1.5 + B4.11), (A3 + B1.5 + B4.12),
(A3 + B1.5 + B4.13), (A3 + B1.5 + B4.14), (A3 + B1.5 + B4.15), (A3 + B1.5 + B4.16),
(A3 + B1.5 + B4.17), (A3 + B1.5 + B4.18), (A3 + B1.5 + B4.19),
(A3 + B1.5 + B5.1), (A3 + B1.5 + B5.2),
(A3 + B1.5 + B6.1), (A3 + B1.5 + B6.2), (A3 + B1.5 + B6.3), (A3 + B1.5 + B6.4),
(A3 + B1.5 + B7.1), (A3 + B1.5 + B7.2), (A3 + B1.5 + B7.3), (A3 + B1.5 + B7.4),
(A3 + B1.5 + B7.5), (A3 + B1.5 + B7.6), (A3 + B1.5 + B7.7), (A3 + B1.5 + B7.8),
(A3 + B1.5 + B9.1), (A3 + B1.5 + B8.1), (A3 + B1.5 + B10.1),
(A3 + B1.6 + B1.7), (A3 + B1.6 + B1.8), (A3 + B1.6 + B1.9), (A3 + B1.6 + B1.10),
(A3 + B1.6 + B1.11), (A3 + B1.6 + B1.12), (A3 + B1.6 + B1.13), (A3 + B1.6 + B1.14),
(A3 + B1.6 + B1.15), (A3 + B1.6 + B1.16), (A3 + B1.6 + B1.17), (A3 + B1.6 + B1.18),
(A3 + B1.6 + B1.19), (A3 + B1.6 + B1.21), (A3 + B1.6 + B1.22), (A3 + B1.6 + B1.23),
(A3 + B1.6 + B1.24), (A3 + B1.6 + B1.25), (A3 + B1.6 + B1.26), (A3 + B1.6 + B1.27),
(A3 + B1.6 + B1.28), (A3 + B1.6 + B1.29), (A3 + B1.6 + B1.30), (A3 + B1.6 + B1.31),
(A3 + B1.6 + B1.32), (A3 + B1.6 + B1.33), (A3 + B1.6 + B1.34), (A3 + B1.6 + B1.35),
(A3 + B1.6 + B1.36), (A3 + B1.6 + B1.37),
(A3 + B1.6 + B2.1), (A3 + B1.6 + B2.2), (A3 + B1.6 + B2.3), (A3 + B1.6 + B2.4),
(A3 + B1.6 + B3.1), (A3 + B1.6 + B3.2), (A3 + B1.6 + B3.3), (A3 + B1.6 + B3.4),
(A3 + B1.6 + B3.5), (A3 + B1.6 + B3.6),
(A3 + B1.6 + B4.1), (A3 + B1.6 + B4.2), (A3 + B1.6 + B4.3), (A3 + B1.6 + B4.4),
(A3 + B1.6 + B4.5), (A3 + B1.6 + B4.6), (A3 + B1.6 + B4.7), (A3 + B1.6 + B4.8),
(A3 + B1.6 + B4.9), (A3 + B1.6 + B4.10), (A3 + B1.6 + B4.11), (A3 + B1.6 + B4.12),
(A3 + B1.6 + B4.13), (A3 + B1.6 + B4.14), (A3 + B1.6 + B4.15), (A3 + B1.6 + B4.16),
(A3 + B1.6 + B4.17), (A3 + B1.6 + B4.18), (A3 + B1.6 + B4.19),
(A3 + B1.6 + B5.1), (A3 + B1.6 + B5.2),
(A3 + B1.6 + B6.1), (A3 + B1.6 + B6.2), (A3 + B1.6 + B6.3), (A3 + B1.6 + B6.4),
(A3 + B1.6 + B7.1), (A3 + B1.6 + B7.2), (A3 + B1.6 + B7.3), (A3 + B1.6 + B7.4),
(A3 + B1.6 + B7.5), (A3 + B1.6 + B7.6), (A3 + B1.6 + B7.7), (A3 + B1.6 + B7.8),
(A3 + B1.6 + B9.1), (A3 + B1.6 + B8.1), (A3 + B1.6 + B10.1),
(A3 + B1.7 + B1.8), (A3 + B1.7 + B1.9), (A3 + B1.7 + B1.10), (A3 + B1.7 + B1.11),
(A3 + B1.7 + B1.12), (A3 + B1.7 + B1.13), (A3 + B1.7 + B1.14), (A3 + B1.7 + B1.15),
(A3 + B1.7 + B1.16), (A3 + B1.7 + B1.17), (A3 + B1.7 + B1.18), (A3 + B1.7 + B1.19),
(A3 + B1.7 + B1.21), (A3 + B1.7 + B1.22), (A3 + B1.7 + B1.23), (A3 + B1.7 + B1.24),
(A3 + B1.7 + B1.25), (A3 + B1.7 + B1.26), (A3 + B1.7 + B1.27), (A3 + B1.7 + B1.28),
(A3 + B1.7 + B1.29), (A3 + B1.7 + B1.30), (A3 + B1.7 + B1.31), (A3 + B1.7 + B1.32),
(A3 + B1.7 + B1.33), (A3 + B1.7 + B1.34), (A3 + B1.7 + B1.35), (A3 + B1.7 + B1.36),
(A3 + B1.7 + B1.37),
(A3 + B1.7 + B2.1), (A3 + B1.7 + B2.2), (A3 + B1.7 + B2.3), (A3 + B1.7 + B2.4),
(A3 + B1.7 + B3.1), (A3 + B1.7 + B3.2), (A3 + B1.7 + B3.3), (A3 + B1.7 + B3.4),
(A3 + B1.7 + B3.5), (A3 + B1.7 + B3.6),
(A3 + B1.7 + B4.1), (A3 + B1.7 + B4.2), (A3 + B1.7 + B4.3), (A3 + B1.7 + B4.4),
(A3 + B1.7 + B4.5), (A3 + B1.7 + B4.6), (A3 + B1.7 + B4.7), (A3 + B1.7 + B4.8),
(A3 + B1.7 + B4.9), (A3 + B1.7 + B4.10), (A3 + B1.7 + B4.11), (A3 + B1.7 + B4.12),
(A3 + B1.7 + B4.13), (A3 + B1.7 + B4.14), (A3 + B1.7 + B4.15), (A3 + B1.7 + B4.16),
(A3 + B1.7 + B4.17), (A3 + B1.7 + B4.18), (A3 + B1.7 + B4.19),
(A3 + B1.7 + B5.1), (A3 + B1.7 + B5.2),
(A3 + B1.7 + B6.1), (A3 + B1.7 + B6.2), (A3 + B1.7 + B6.3), (A3 + B1.7 + B6.4),
(A3 + B1.7 + B7.1), (A3 + B1.7 + B7.2), (A3 + B1.7 + B7.3), (A3 + B1.7 + B7.4),
(A3 + B1.7 + B7.5), (A3 + B1.7 + B7.6), (A3 + B1.7 + B7.7), (A3 + B1.7 + B7.8),
(A3 + B1.7 + B9.1), (A3 + B1.7 + B8.1), (A3 + B1.7 + B10.1),
(A3 + B1.8 + B1.9), (A3 + B1.8 + B1.10), (A3 + B1.8 + B1.11), (A3 + B1.8 + B1.12),
(A3 + B1.8 + B1.13), (A3 + B1.8 + B1.14), (A3 + B1.8 + B1.15), (A3 + B1.8 + B1.16),
(A3 + B1.8 + B1.17), (A3 + B1.8 + B1.18), (A3 + B1.8 + B1.19), (A3 + B1.8 + B1.21),
(A3 + B1.8 + B1.22), (A3 + B1.8 + B1.23), (A3 + B1.8 + B1.24), (A3 + B1.8 + B1.25),
(A3 + B1.8 + B1.26), (A3 + B1.8 + B1.27), (A3 + B1.8 + B1.28), (A3 + B1.8 + B1.29),
(A3 + B1.8 + B1.30), (A3 + B1.8 + B1.31), (A3 + B1.8 + B1.32), (A3 + B1.8 + B1.33),
(A3 + B1.8 + B1.34), (A3 + B1.8 + B1.35), (A3 + B1.8 + B1.36), (A3 + B1.8 + B1.37),
(A3 + B1.8 + B2.1), (A3 + B1.8 + B2.2), (A3 + B1.8 + B2.3), (A3 + B1.8 + B2.4),
(A3 + B1.8 + B3.1), (A3 + B1.8 + B3.2), (A3 + B1.8 + B3.3), (A3 + B1.8 + B3.4),
(A3 + B1.8 + B3.5), (A3 + B1.8 + B3.6),
(A3 + B1.8 + B4.1), (A3 + B1.8 + B4.2), (A3 + B1.8 + B4.3), (A3 + B1.8 + B4.4),
(A3 + B1.8 + B4.5), (A3 + B1.8 + B4.6), (A3 + B1.8 + B4.7), (A3 + B1.8 + B4.8),
(A3 + B1.8 + B4.9), (A3 + B1.8 + B4.10), (A3 + B1.8 + B4.11), (A3 + B1.8 + B4.12),
(A3 + B1.8 + B4.13), (A3 + B1.8 + B4.14), (A3 + B1.8 + B4.15), (A3 + B1.8 + B4.16),
(A3 + B1.8 + B4.17), (A3 + B1.8 + B4.18), (A3 + B1.8 + B4.19),
(A3 + B1.8 + B5.1), (A3 + B1.8 + B5.2),
(A3 + B1.8 + B6.1), (A3 + B1.8 + B6.2), (A3 + B1.8 + B6.3), (A3 + B1.8 + B6.4),
(A3 + B1.8 + B7.1), (A3 + B1.8 + B7.2), (A3 + B1.8 + B7.3), (A3 + B1.8 + B7.4),
(A3 + B1.8 + B7.5), (A3 + B1.8 + B7.6), (A3 + B1.8 + B7.7), (A3 + B1.8 + B7.8),
(A3 + B1.8 + B9.1), (A3 + B1.8 + B8.1), (A3 + B1.8 + B10.1),
(A3 + B1.9 + B1.10), (A3 + B1.9 + B1.11), (A3 + B1.9 + B1.12), (A3 + B1.9 + B1.13),
(A3 + B1.9 + B1.14), (A3 + B1.9 + B1.15), (A3 + B1.9 + B1.16), (A3 + B1.9 + B1.17),
(A3 + B1.9 + B1.18), (A3 + B1.9 + B1.19), (A3 + B1.9 + B1.21), (A3 + B1.9 + B1.22),
(A3 + B1.9 + B1.23), (A3 + B1.9 + B1.24), (A3 + B1.9 + B1.25), (A3 + B1.9 + B1.26),
(A3 + B1.9 + B1.27), (A3 + B1.9 + B1.28), (A3 + B1.9 + B1.29), (A3 + B1.9 + B1.30),
(A3 + B1.9 + B1.31), (A3 + B1.9 + B1.32), (A3 + B1.9 + B1.33), (A3 + B1.9 + B1.34),
(A3 + B1.9 + B1.35), (A3 + B1.9 + B1.36), (A3 + B1.9 + B1.37),
(A3 + B1.9 + B2.1), (A3 + B1.9 + B2.2), (A3 + B1.9 + B2.3), (A3 + B1.9 + B2.4),
(A3 + B1.9 + B3.1), (A3 + B1.9 + B3.2), (A3 + B1.9 + B3.3), (A3 + B1.9 + B3.4),
(A3 + B1.9 + B3.5), (A3 + B1.9 + B3.6),
(A3 + B1.9 + B4.1), (A3 + B1.9 + B4.2), (A3 + B1.9 + B4.3), (A3 + B1.9 + B4.4),
(A3 + B1.9 + B4.5), (A3 + B1.9 + B4.6), (A3 + B1.9 + B4.7), (A3 + B1.9 + B4.8),
(A3 + B1.9 + B4.9), (A3 + B1.9 + B4.10), (A3 + B1.9 + B4.11), (A3 + B1.9 + B4.12),
(A3 + B1.9 + B4.13), (A3 + B1.9 + B4.14), (A3 + B1.9 + B4.15), (A3 + B1.9 + B4.16),
(A3 + B1.9 + B4.17), (A3 + B1.9 + B4.18), (A3 + B1.9 + B4.19),
(A3 + B1.9 + B5.1), (A3 + B1.9 + B5.2),
(A3 + B1.9 + B6.1), (A3 + B1.9 + B6.2), (A3 + B1.9 + B6.3), (A3 + B1.9 + B6.4),
(A3 + B1.9 + B7.1), (A3 + B1.9 + B7.2), (A3 + B1.9 + B7.3), (A3 + B1.9 + B7.4),
(A3 + B1.9 + B7.5), (A3 + B1.9 + B7.6), (A3 + B1.9 + B7.7), (A3 + B1.9 + B7.8),
(A3 + B1.9 + B9.1), (A3 + B1.9 + B8.1), (A3 + B1.9 + B10.1),
(A3 + B1.10 + B1.11), (A3 + B1.10 + B1.12), (A3 + B1.10 + B1.13), (A3 + B1.10 + B1.14),
(A3 + B1.10 + B1.15), (A3 + B1.10 + B1.16), (A3 + B1.10 + B1.17), (A3 + B1.10 + B1.18),
(A3 + B1.10 + B1.19), (A3 + B1.10 + B1.21), (A3 + B1.10 + B1.22), (A3 + B1.10 + B1.23),
(A3 + B1.10 + B1.24), (A3 + B1.10 + B1.25), (A3 + B1.10 + B1.26), (A3 + B1.10 + B1.27),
(A3 + B1.10 + B1.28), (A3 + B1.10 + B1.29), (A3 + B1.10 + B1.30), (A3 + B1.10 + B1.31),
(A3 + B1.10 + B1.32), (A3 + B1.10 + B1.33), (A3 + B1.10 + B1.34), (A3 + B1.10 + B1.35),
(A3 + B1.10 + B1.36), (A3 + B1.10 + B1.37),
(A3 + B1.10 + B2.1), (A3 + B1.10 + B2.2), (A3 + B1.10 + B2.3), (A3 + B1.10 + B2.4),
(A3 + B1.10 + B3.1), (A3 + B1.10 + B3.2), (A3 + B1.10 + B3.3), (A3 + B1.10 + B3.4),
(A3 + B1.10 + B3.5), (A3 + B1.10 + B3.6),
(A3 + B1.10 + B4.1), (A3 + B1.10 + B4.2), (A3 + B1.10 + B4.3), (A3 + B1.10 + B4.4),
(A3 + B1.10 + B4.5), (A3 + B1.10 + B4.6), (A3 + B1.10 + B4.7), (A3 + B1.10 + B4.8),
(A3 + B1.10 + B4.9), (A3 + B1.10 + B4.10), (A3 + B1.10 + B4.11), (A3 + B1.10 + B4.12),
(A3 + B1.10 + B4.13), (A3 + B1.10 + B4.14), (A3 + B1.10 + B4.15), (A3 + B1.10 + B4.16),
(A3 + B1.10 + B4.17), (A3 + B1.10 + B4.18), (A3 + B1.10 + B4.19),
(A3 + B1.10 + B5.1), (A3 + B1.10 + B5.2),
(A3 + B1.10 + B6.1), (A3 + B1.10 + B6.2), (A3 + B1.10 + B6.3), (A3 + B1.10 + B6.4),
(A3 + B1.10 + B7.1), (A3 + B1.10 + B7.2), (A3 + B1.10 + B7.3), (A3 + B1.10 + B7.4),
(A3 + B1.10 + B7.5), (A3 + B1.10 + B7.6), (A3 + B1.10 + B7.7), (A3 + B1.10 + B7.8),
(A3 + B1.10 + B9.1), (A3 + B1.10 + B8.1), (A3 + B1.10 + B10.1),
(A3 + B1.11 + B1.12), (A3 + B1.11 + B1.13), (A3 + B1.11 + B1.14), (A3 + B1.11 + B1.15),
(A3 + B1.11 + B1.16), (A3 + B1.11 + B1.17), (A3 + B1.11 + B1.18), (A3 + B1.11 + B1.19),
(A3 + B1.11 + B1.21), (A3 + B1.11 + B1.22), (A3 + B1.11 + B1.23), (A3 + B1.11 + B1.24),
(A3 + B1.11 + B1.25), (A3 + B1.11 + B1.26), (A3 + B1.11 + B1.27), (A3 + B1.11 + B1.28),
(A3 + B1.11 + B1.29), (A3 + B1.11 + B1.30), (A3 + B1.11 + B1.31), (A3 + B1.11 + B1.32),
(A3 + B1.11 + B1.33), (A3 + B1.11 + B1.34), (A3 + B1.11 + B1.35), (A3 + B1.11 + B1.36),
(A3 + B1.11 + B1.37),
(A3 + B1.11 + B2.1), (A3 + B1.11 + B2.2), (A3 + B1.11 + B2.3), (A3 + B1.11 + B2.4),
(A3 + B1.11 + B3.1), (A3 + B1.11 + B3.2), (A3 + B1.11 + B3.3), (A3 + B1.11 + B3.4),
(A3 + B1.11 + B3.5), (A3 + B1.11 + B3.6),
(A3 + B1.11 + B4.1), (A3 + B1.11 + B4.2), (A3 + B1.11 + B4.3), (A3 + B1.11 + B4.4),
(A3 + B1.11 + B4.5), (A3 + B1.11 + B4.6), (A3 + B1.11 + B4.7), (A3 + B1.11 + B4.8),
(A3 + B1.11 + B4.9), (A3 + B1.11 + B4.10), (A3 + B1.11 + B4.11), (A3 + B1.11 + B4.12),
(A3 + B1.11 + B4.13), (A3 + B1.11 + B4.14), (A3 + B1.11 + B4.15), (A3 + B1.11 + B4.16),
(A3 + B1.11 + B4.17), (A3 + B1.11 + B4.18), (A3 + B1.11 + B4.19),
(A3 + B1.11 + B5.1), (A3 + B1.11 + B5.2),
(A3 + B1.11 + B6.1), (A3 + B1.11 + B6.2), (A3 + B1.11 + B6.3), (A3 + B1.11 + B6.4),
(A3 + B1.11 + B7.1), (A3 + B1.11 + B7.2), (A3 + B1.11 + B7.3), (A3 + B1.11 + B7.4),
(A3 + B1.11 + B7.5), (A3 + B1.11 + B7.6), (A3 + B1.11 + B7.7), (A3 + B1.11 + B7.8),
(A3 + B1.11 + B9.1), (A3 + B1.11 + B8.1), (A3 + B1.11 + B10.1),
(A3 + B1.12 + B1.13), (A3 + B1.12 + B1.14), (A3 + B1.12 + B1.15), (A3 + B1.12 + B1.16),
(A3 + B1.12 + B1.17), (A3 + B1.12 + B1.18), (A3 + B1.12 + B1.19), (A3 + B1.12 + B1.21),
(A3 + B1.12 + B1.22), (A3 + B1.12 + B1.23), (A3 + B1.12 + B1.24), (A3 + B1.12 + B1.25),
(A3 + B1.12 + B1.26), (A3 + B1.12 + B1.27), (A3 + B1.12 + B1.28), (A3 + B1.12 + B1.29),
(A3 + B1.12 + B1.30), (A3 + B1.12 + B1.31), (A3 + B1.12 + B1.32), (A3 + B1.12 + B1.33),
(A3 + B1.12 + B1.34), (A3 + B1.12 + B1.35), (A3 + B1.12 + B1.36), (A3 + B1.12 + B1.37),
(A3 + B1.12 + B2.1), (A3 + B1.12 + B2.2), (A3 + B1.12 + B2.3), (A3 + B1.12 + B2.4),
(A3 + B1.12 + B3.1), (A3 + B1.12 + B3.2), (A3 + B1.12 + B3.3), (A3 + B1.12 + B3.4),
(A3 + B1.12 + B3.5), (A3 + B1.12 + B3.6),
(A3 + B1.12 + B4.1), (A3 + B1.12 + B4.2), (A3 + B1.12 + B4.3), (A3 + B1.12 + B4.4),
(A3 + B1.12 + B4.5), (A3 + B1.12 + B4.6), (A3 + B1.12 + B4.7), (A3 + B1.12 + B4.8),
(A3 + B1.12 + B4.9), (A3 + B1.12 + B4.10), (A3 + B1.12 + B4.11), (A3 + B1.12 + B4.12),
(A3 + B1.12 + B4.13), (A3 + B1.12 + B4.14), (A3 + B1.12 + B4.15), (A3 + B1.12 + B4.16),
(A3 + B1.12 + B4.17), (A3 + B1.12 + B4.18), (A3 + B1.12 + B4.19),
(A3 + B1.12 + B5.1), (A3 + B1.12 + B5.2),
(A3 + B1.12 + B6.1), (A3 + B1.12 + B6.2), (A3 + B1.12 + B6.3), (A3 + B1.12 + B6.4),
(A3 + B1.12 + B7.1), (A3 + B1.12 + B7.2), (A3 + B1.12 + B7.3), (A3 + B1.12 + B7.4),
(A3 + B1.12 + B7.5), (A3 + B1.12 + B7.6), (A3 + B1.12 + B7.7), (A3 + B1.12 + B7.8),
(A3 + B1.12 + B9.1), (A3 + B1.12 + B8.1), (A3 + B1.12 + B10.1),
(A3 + B1.13 + B1.14), (A3 + B1.13 + B1.15), (A3 + B1.13 + B1.16), (A3 + B1.13 + B1.17),
(A3 + B1.13 + B1.18), (A3 + B1.13 + B1.19), (A3 + B1.13 + B1.21), (A3 + B1.13 + B1.22),
(A3 + B1.13 + B1.23), (A3 + B1.13 + B1.24), (A3 + B1.13 + B1.25), (A3 + B1.13 + B1.26),
(A3 + B1.13 + B1.27), (A3 + B1.13 + B1.28), (A3 + B1.13 + B1.29), (A3 + B1.13 + B1.30),
(A3 + B1.13 + B1.31), (A3 + B1.13 + B1.32), (A3 + B1.13 + B1.33), (A3 + B1.13 + B1.34),
(A3 + B1.13 + B1.35), (A3 + B1.13 + B1.36), (A3 + B1.13 + B1.37),
(A3 + B1.13 + B2.1), (A3 + B1.13 + B2.2), (A3 + B1.13 + B2.3), (A3 + B1.13 + B2.4),
(A3 + B1.13 + B3.1), (A3 + B1.13 + B3.2), (A3 + B1.13 + B3.3), (A3 + B1.13 + B3.4),
(A3 + B1.13 + B3.5), (A3 + B1.13 + B3.6),
(A3 + B1.13 + B4.1), (A3 + B1.13 + B4.2), (A3 + B1.13 + B4.3), (A3 + B1.13 + B4.4),
(A3 + B1.13 + B4.5), (A3 + B1.13 + B4.6), (A3 + B1.13 + B4.7), (A3 + B1.13 + B4.8),
(A3 + B1.13 + B4.9), (A3 + B1.13 + B4.10), (A3 + B1.13 + B4.11), (A3 + B1.13 + B4.12),
(A3 + B1.13 + B4.13), (A3 + B1.13 + B4.14), (A3 + B1.13 + B4.15), (A3 + B1.13 + B4.16),
(A3 + B1.13 + B4.17), (A3 + B1.13 + B4.18), (A3 + B1.13 + B4.19),
(A3 + B1.13 + B5.1), (A3 + B1.13 + B5.2),
(A3 + B1.13 + B6.1), (A3 + B1.13 + B6.2), (A3 + B1.13 + B6.3), (A3 + B1.13 + B6.4),
(A3 + B1.13 + B7.1), (A3 + B1.13 + B7.2), (A3 + B1.13 + B7.3), (A3 + B1.13 + B7.4),
(A3 + B1.13 + B7.5), (A3 + B1.13 + B7.6), (A3 + B1.13 + B7.7), (A3 + B1.13 + B7.8),
(A3 + B1.13 + B9.1), (A3 + B1.13 + B8.1), (A3 + B1.13 + B10.1),
(A3 + B1.14 + B1.15), (A3 + B1.14 + B1.16), (A3 + B1.14 + B1.17), (A3 + B1.14 + B1.18),
(A3 + B1.14 + B1.19), (A3 + B1.14 + B1.21), (A3 + B1.14 + B1.22), (A3 + B1.14 + B1.23),
(A3 + B1.14 + B1.24), (A3 + B1.14 + B1.25), (A3 + B1.14 + B1.26), (A3 + B1.14 + B1.27),
(A3 + B1.14 + B1.28), (A3 + B1.14 + B1.29), (A3 + B1.14 + B1.30), (A3 + B1.14 + B1.31),
(A3 + B1.14 + B1.32), (A3 + B1.14 + B1.33), (A3 + B1.14 + B1.34), (A3 + B1.14 + B1.35),
(A3 + B1.14 + B1.36), (A3 + B1.14 + B1.37), (A3 + B1.14 + B2.1), (A3 + B1.14 + B2.2),
(A3 + B1.14 + B2.3), (A3 + B1.14 + B2.4), (A3 + B1.14 + B3.1), (A3 + B1.14 + B3.2),
(A3 + B1.14 + B3.3), (A3 + B1.14 + B3.4), (A3 + B1.14 + B3.5), (A3 + B1.14 + B3.6),
(A3 + B1.14 + B4.1), (A3 + B1.14 + B4.2), (A3 + B1.14 + B4.3), (A3 + B1.14 + B4.4),
(A3 + B1.14 + B4.5), (A3 + B1.14 + B4.6), (A3 + B1.14 + B4.7), (A3 + B1.14 + B4.8),
(A3 + B1.14 + B4.9), (A3 + B1.14 + B4.10), (A3 + B1.14 + B4.11), (A3 + B1.14 + B4.12),
(A3 + B1.14 + B4.13), (A3 + B1.14 + B4.14), (A3 + B1.14 + B4.15), (A3 + B1.14 + B4.16),
(A3 + B1.14 + B4.17), (A3 + B1.14 + B4.18), (A3 + B1.14 + B4.19),
(A3 + B1.14 + B5.1), (A3 + B1.14 + B5.2),
(A3 + B1.14 + B6.1), (A3 + B1.14 + B6.2), (A3 + B1.14 + B6.3), (A3 + B1.14 + B6.4),
(A3 + B1.14 + B7.1), (A3 + B1.14 + B7.2), (A3 + B1.14 + B7.3), (A3 + B1.14 + B7.4),
(A3 + B1.14 + B7.5), (A3 + B1.14 + B7.6), (A3 + B1.14 + B7.7), (A3 + B1.14 + B7.8),
(A3 + B1.14 + B9.1), (A3 + B1.14 + B8.1), (A3 + B1.14 + B10.1),
(A3 + B1.15 + B1.16), (A3 + B1.15 + B1.17), (A3 + B1.15 + B1.18), (A3 + B1.15 + B1.19),
(A3 + B1.15 + B1.21), (A3 + B1.15 + B1.22), (A3 + B1.15 + B1.23), (A3 + B1.15 + B1.24),
(A3 + B1.15 + B1.25), (A3 + B1.15 + B1.26), (A3 + B1.15 + B1.27), (A3 + B1.15 + B1.28),
(A3 + B1.15 + B1.29), (A3 + B1.15 + B1.30), (A3 + B1.15 + B1.31), (A3 + B1.15 + B1.32),
(A3 + B1.15 + B1.33), (A3 + B1.15 + B1.34), (A3 + B1.15 + B1.35), (A3 + B1.15 + B1.36),
(A3 + B1.15 + B1.37), (A3 + B1.15 + B2.1), (A3 + B1.15 + B2.2), (A3 + B1.15 + B2.3),
(A3 + B1.15 + B2.4), (A3 + B1.15 + B3.1), (A3 + B1.15 + B3.2), (A3 + B1.15 + B3.3),
(A3 + B1.15 + B3.4), (A3 + B1.15 + B3.5), (A3 + B1.15 + B3.6),
(A3 + B1.15 + B4.1), (A3 + B1.15 + B4.2), (A3 + B1.15 + B4.3), (A3 + B1.15 + B4.4),
(A3 + B1.15 + B4.5), (A3 + B1.15 + B4.6), (A3 + B1.15 + B4.7), (A3 + B1.15 + B4.8),
(A3 + B1.15 + B4.9), (A3 + B1.15 + B4.10), (A3 + B1.15 + B4.11), (A3 + B1.15 + B4.12),
(A3 + B1.15 + B4.13), (A3 + B1.15 + B4.14), (A3 + B1.15 + B4.15), (A3 + B1.15 + B4.16),
(A3 + B1.15 + B4.17), (A3 + B1.15 + B4.18), (A3 + B1.15 + B4.19),
(A3 + B1.15 + B5.1), (A3 + B1.15 + B5.2),
(A3 + B1.15 + B6.1), (A3 + B1.15 + B6.2), (A3 + B1.15 + B6.3), (A3 + B1.15 + B6.4),
(A3 + B1.15 + B7.1), (A3 + B1.15 + B7.2), (A3 + B1.15 + B7.3), (A3 + B1.15 + B7.4),
(A3 + B1.15 + B7.5), (A3 + B1.15 + B7.6), (A3 + B1.15 + B7.7), (A3 + B1.15 + B7.8),
(A3 + B1.15 + B9.1), (A3 + B1.15 + B8.1), (A3 + B1.15 + B10.1),
(A3 + B1.16 + B1.17), (A3 + B1.16 + B1.18), (A3 + B1.16 + B1.19), (A3 + B1.16 + B1.21),
(A3 + B1.16 + B1.22), (A3 + B1.16 + B1.23), (A3 + B1.16 + B1.24), (A3 + B1.16 + B1.25),
(A3 + B1.16 + B1.26), (A3 + B1.16 + B1.27), (A3 + B1.16 + B1.28), (A3 + B1.16 + B1.29),
(A3 + B1.16 + B1.30), (A3 + B1.16 + B1.31), (A3 + B1.16 + B1.32), (A3 + B1.16 + B1.33),
(A3 + B1.16 + B1.34), (A3 + B1.16 + B1.35), (A3 + B1.16 + B1.36), (A3 + B1.16 + B1.37),
(A3 + B1.16 + B2.1), (A3 + B1.16 + B2.2), (A3 + B1.16 + B2.3), (A3 + B1.16 + B2.4),
(A3 + B1.16 + B3.1), (A3 + B1.16 + B3.2), (A3 + B1.16 + B3.3), (A3 + B1.16 + B3.4),
(A3 + B1.16 + B3.5), (A3 + B1.16 + B3.6),
(A3 + B1.16 + B4.1), (A3 + B1.16 + B4.2), (A3 + B1.16 + B4.3), (A3 + B1.16 + B4.4),
(A3 + B1.16 + B4.5), (A3 + B1.16 + B4.6), (A3 + B1.16 + B4.7), (A3 + B1.16 + B4.8),
(A3 + B1.16 + B4.9), (A3 + B1.16 + B4.10), (A3 + B1.16 + B4.11), (A3 + B1.16 + B4.12),
(A3 + B1.16 + B4.13), (A3 + B1.16 + B4.14), (A3 + B1.16 + B4.15), (A3 + B1.16 + B4.16),
(A3 + B1.16 + B4.17), (A3 + B1.16 + B4.18), (A3 + B1.16 + B4.19),
(A3 + B1.16 + B5.1), (A3 + B1.16 + B5.2),
(A3 + B1.16 + B6.1), (A3 + B1.16 + B6.2), (A3 + B1.16 + B6.3), (A3 + B1.16 + B6.4),
(A3 + B1.16 + B7.1), (A3 + B1.16 + B7.2), (A3 + B1.16 + B7.3), (A3 + B1.16 + B7.4),
(A3 + B1.16 + B7.5), (A3 + B1.16 + B7.6), (A3 + B1.16 + B7.7), (A3 + B1.16 + B7.8),
(A3 + B1.16 + B9.1), (A3 + B1.16 + B8.1), (A3 + B1.16 + B10.1),
(A3 + B1.17 + B1.18), (A3 + B1.17 + B1.19), (A3 + B1.17 + B1.21), (A3 + B1.17 + B1.22),
(A3 + B1.17 + B1.23), (A3 + B1.17 + B1.24), (A3 + B1.17 + B1.25), (A3 + B1.17 + B1.26),
(A3 + B1.17 + B1.27), (A3 + B1.17 + B1.28), (A3 + B1.17 + B1.29), (A3 + B1.17 + B1.30),
(A3 + B1.17 + B1.31), (A3 + B1.17 + B1.32), (A3 + B1.17 + B1.33), (A3 + B1.17 + B1.34),
(A3 + B1.17 + B1.35), (A3 + B1.17 + B1.36), (A3 + B1.17 + B1.37), (A3 + B1.17 + B2.1),
(A3 + B1.17 + B2.2), (A3 + B1.17 + B2.3), (A3 + B1.17 + B2.4), (A3 + B1.17 + B3.1),
(A3 + B1.17 + B3.2), (A3 + B1.17 + B3.3), (A3 + B1.17 + B3.4), (A3 + B1.17 + B3.5),
(A3 + B1.17 + B3.6),
(A3 + B1.17 + B4.1), (A3 + B1.17 + B4.2), (A3 + B1.17 + B4.3), (A3 + B1.17 + B4.4),
(A3 + B1.17 + B4.5), (A3 + B1.17 + B4.6), (A3 + B1.17 + B4.7), (A3 + B1.17 + B4.8),
(A3 + B1.17 + B4.9), (A3 + B1.17 + B4.10), (A3 + B1.17 + B4.11), (A3 + B1.17 + B4.12),
(A3 + B1.17 + B4.13), (A3 + B1.17 + B4.14), (A3 + B1.17 + B4.15), (A3 + B1.17 + B4.16),
(A3 + B1.17 + B4.17), (A3 + B1.17 + B4.18), (A3 + B1.17 + B4.19),
(A3 + B1.17 + B5.1), (A3 + B1.17 + B5.2),
(A3 + B1.17 + B6.1), (A3 + B1.17 + B6.2), (A3 + B1.17 + B6.3), (A3 + B1.17 + B6.4),
(A3 + B1.17 + B7.1), (A3 + B1.17 + B7.2), (A3 + B1.17 + B7.3), (A3 + B1.17 + B7.4),
(A3 + B1.17 + B7.5), (A3 + B1.17 + B7.6), (A3 + B1.17 + B7.7), (A3 + B1.17 + B7.8),
(A3 + B1.17 + B9.1), (A3 + B1.17 + B8.1), (A3 + B1.17 + B10.1),
(A3 + B1.18 + B1.19), (A3 + B1.18 + B1.21), (A3 + B1.18 + B1.22), (A3 + B1.18 + B1.23),
(A3 + B1.18 + B1.24), (A3 + B1.18 + B1.25), (A3 + B1.18 + B1.26), (A3 + B1.18 + B1.27),
(A3 + B1.18 + B1.28), (A3 + B1.18 + B1.29), (A3 + B1.18 + B1.30), (A3 + B1.18 + B1.31),
(A3 + B1.18 + B1.32), (A3 + B1.18 + B1.33), (A3 + B1.18 + B1.34), (A3 + B1.18 + B1.35),
(A3 + B1.18 + B1.36), (A3 + B1.18 + B1.37),
(A3 + B1.18 + B2.1), (A3 + B1.18 + B2.2), (A3 + B1.18 + B2.3), (A3 + B1.18 + B2.4),
(A3 + B1.18 + B3.1), (A3 + B1.18 + B3.2), (A3 + B1.18 + B3.3), (A3 + B1.18 + B3.4),
(A3 + B1.18 + B3.5), (A3 + B1.18 + B3.6),
(A3 + B1.18 + B4.1), (A3 + B1.18 + B4.2), (A3 + B1.18 + B4.3), (A3 + B1.18 + B4.4),
(A3 + B1.18 + B4.5), (A3 + B1.18 + B4.6), (A3 + B1.18 + B4.7), (A3 + B1.18 + B4.8),
(A3 + B1.18 + B4.9), (A3 + B1.18 + B4.10), (A3 + B1.18 + B4.11), (A3 + B1.18 + B4.12),
(A3 + B1.18 + B4.13), (A3 + B1.18 + B4.14), (A3 + B1.18 + B4.15), (A3 + B1.18 + B4.16),
(A3 + B1.18 + B4.17), (A3 + B1.18 + B4.18), (A3 + B1.18 + B4.19),
(A3 + B1.18 + B5.1), (A3 + B1.18 + B5.2), (A3 + B1.18 + B6.1), (A3 + B1.18 + B6.2),
(A3 + B1.18 + B6.3), (A3 + B1.18 + B6.4),
(A3 + B1.18 + B7.1), (A3 + B1.18 + B7.2), (A3 + B1.18 + B7.3), (A3 + B1.18 + B7.4),
(A3 + B1.18 + B7.5), (A3 + B1.18 + B7.6), (A3 + B1.18 + B7.7), (A3 + B1.18 + B7.8),
(A3 + B1.18 + B8.1), (A3 + B1.18 + B9.1), (A3 + B1.18 + B10.1),
(A3 + B1.19 + B1.20), (A3 + B1.19 + B1.21), (A3 + B1.19 + B1.22), (A3 + B1.19 + B1.23),
(A3 + B1.19 + B1.24), (A3 + B1.19 + B1.25), (A3 + B1.19 + B1.26), (A3 + B1.19 + B1.27),
(A3 + B1.19 + B1.28), (A3 + B1.19 + B1.29), (A3 + B1.19 + B1.30), (A3 + B1.19 + B1.31),
(A3 + B1.19 + B1.32), (A3 + B1.19 + B1.33), (A3 + B1.19 + B1.34), (A3 + B1.19 + B1.35),
(A3 + B1.19 + B1.36), (A3 + B1.19 + B1.37),
(A3 + B1.19 + B2.1), (A3 + B1.19 + B2.2), (A3 + B1.19 + B2.3), (A3 + B1.19 + B2.4),
(A3 + B1.19 + B3.1), (A3 + B1.19 + B3.2), (A3 + B1.19 + B3.3), (A3 + B1.19 + B3.4),
(A3 + B1.19 + B3.5), (A3 + B1.19 + B3.6),
(A3 + B1.19 + B4.1), (A3 + B1.19 + B4.2), (A3 + B1.19 + B4.3), (A3 + B1.19 + B4.4),
(A3 + B1.19 + B4.5), (A3 + B1.19 + B4.6), (A3 + B1.19 + B4.7), (A3 + B1.19 + B4.8),
(A3 + B1.19 + B4.9), (A3 + B1.19 + B4.10), (A3 + B1.19 + B4.11), (A3 + B1.19 + B4.12),
(A3 + B1.19 + B4.13), (A3 + B1.19 + B4.14), (A3 + B1.19 + B4.15), (A3 + B1.19 + B4.16),
(A3 + B1.19 + B4.17), (A3 + B1.19 + B4.18), (A3 + B1.19 + B4.19),
(A3 + B1.19 + B5.1), (A3 + B1.19 + B5.2), (A3 + B1.19 + B6.1), (A3 + B1.19 + B6.2),
(A3 + B1.19 + B6.3), (A3 + B1.19 + B6.4), (A3 + B1.19 + B7.1), (A3 + B1.19 + B7.2),
(A3 + B1.19 + B7.3), (A3 + B1.19 + B7.4), (A3 + B1.19 + B7.5), (A3 + B1.19 + B7.6),
(A3 + B1.19 + B7.7), (A3 + B1.19 + B7.8),
(A3 + B1.19 + B8.1), (A3 + B1.19 + B9.1), (A3 + B1.19 + B10.1),
(A3 + B1.20 + B1.21), (A3 + B1.20 + B1.22), (A3 + B1.20 + B1.23), (A3 + B1.20 + B1.24),
(A3 + B1.20 + B1.25), (A3 + B1.20 + B1.26), (A3 + B1.20 + B1.27), (A3 + B1.20 + B1.28),
(A3 + B1.20 + B1.29), (A3 + B1.20 + B1.30), (A3 + B1.20 + B1.31), (A3 + B1.20 + B1.32),
(A3 + B1.20 + B1.33), (A3 + B1.20 + B1.34), (A3 + B1.20 + B1.35), (A3 + B1.20 + B1.36),
(A3 + B1.20 + B1.37), (A3 + B1.20 + B2.1), (A3 + B1.20 + B2.2), (A3 + B1.20 + B2.3),
(A3 + B1.20 + B2.4), (A3 + B1.20 + B3.1), (A3 + B1.20 + B3.2), (A3 + B1.20 + B3.3),
(A3 + B1.20 + B3.4), (A3 + B1.20 + B3.5), (A3 + B1.20 + B3.6),
(A3 + B1.20 + B4.1), (A3 + B1.20 + B4.2), (A3 + B1.20 + B4.3), (A3 + B1.20 + B4.4),
(A3 + B1.20 + B4.5), (A3 + B1.20 + B4.6), (A3 + B1.20 + B4.7), (A3 + B1.20 + B4.8),
(A3 + B1.20 + B4.9), (A3 + B1.20 + B4.10), (A3 + B1.20 + B4.11), (A3 + B1.20 + B4.12),
(A3 + B1.20 + B4.13), (A3 + B1.20 + B4.14), (A3 + B1.20 + B4.15), (A3 + B1.20 + B4.16),
(A3 + B1.20 + B4.17), (A3 + B1.20 + B4.18), (A3 + B1.20 + B4.19),
(A3 + B1.20 + B5.1), (A3 + B1.20 + B5.2), (A3 + B1.20 + B6.1), (A3 + B1.20 + B6.2),
(A3 + B1.20 + B6.3), (A3 + B1.20 + B6.4), (A3 + B1.20 + B7.1), (A3 + B1.20 + B7.2),
(A3 + B1.20 + B7.3), (A3 + B1.20 + B7.4), (A3 + B1.20 + B7.5), (A3 + B1.20 + B7.6),
(A3 + B1.20 + B7.7), (A3 + B1.20 + B7.8),
(A3 + B1.20 + B8.1), (A3 + B1.20 + B9.1), (A3 + B1.20 + B10.1),
(A3 + B1.20 + B1.21), (A3 + B1.20 + B1.22), (A3 + B1.20 + B1.23), (A3 + B1.20 + B1.24),
(A3 + B1.20 + B1.25), (A3 + B1.20 + B1.26), (A3 + B1.20 + B1.27), (A3 + B1.20 + B1.28),
(A3 + B1.20 + B1.29), (A3 + B1.20 + B1.30), (A3 + B1.20 + B1.31), (A3 + B1.20 + B1.32),
(A3 + B1.20 + B1.33), (A3 + B1.20 + B1.34), (A3 + B1.20 + B1.35), (A3 + B1.20 + B1.36),
(A3 + B1.20 + B1.37), (A3 + B1.20 + B2.1), (A3 + B1.20 + B2.2), (A3 + B1.20 + B2.3),
(A3 + B1.20 + B2.4), (A3 + B1.20 + B3.1), (A3 + B1.20 + B3.2), (A3 + B1.20 + B3.3),
(A3 + B1.20 + B3.4), (A3 + B1.20 + B3.5), (A3 + B1.20 + B3.6),
(A3 + B1.20 + B4.1), (A3 + B1.20 + B4.2), (A3 + B1.20 + B4.3), (A3 + B1.20 + B4.4),
(A3 + B1.20 + B4.5), (A3 + B1.20 + B4.6), (A3 + B1.20 + B4.7), (A3 + B1.20 + B4.8),
(A3 + B1.20 + B4.9), (A3 + B1.20 + B4.10), (A3 + B1.20 + B4.11), (A3 + B1.20 + B4.12),
(A3 + B1.20 + B4.13), (A3 + B1.20 + B4.14), (A3 + B1.20 + B4.15), (A3 + B1.20 + B4.16),
(A3 + B1.20 + B4.17), (A3 + B1.20 + B4.18), (A3 + B1.20 + B4.19),
(A3 + B1.20 + B5.1), (A3 + B1.20 + B5.2), (A3 + B1.20 + B6.1), (A3 + B1.20 + B6.2),
(A3 + B1.20 + B6.3), (A3 + B1.20 + B6.4),
(A3 + B1.20 + B7.1), (A3 + B1.20 + B7.2), (A3 + B1.20 + B7.3), (A3 + B1.20 + B7.4),
(A3 + B1.20 + B7.5), (A3 + B1.20 + B7.6), (A3 + B1.20 + B7.7), (A3 + B1.20 + B7.8),
(A3 + B1.20 + B8.1), (A3 + B1.20 + B9.1), (A3 + B1.20 + B10.1),
(A3 + B1.22 + B1.23), (A3 + B1.22 + B1.24), (A3 + B1.22 + B1.25), (A3 + B1.22 + B1.26),
(A3 + B1.22 + B1.27), (A3 + B1.22 + B1.28), (A3 + B1.22 + B1.29), (A3 + B1.22 + B1.30),
(A3 + B1.22 + B1.31), (A3 + B1.22 + B1.32), (A3 + B1.22 + B1.33), (A3 + B1.22 + B1.34),
(A3 + B1.22 + B1.35), (A3 + B1.22 + B1.36), (A3 + B1.22 + B1.37),
(A3 + B1.22 + B2.1), (A3 + B1.22 + B2.2), (A3 + B1.22 + B2.3), (A3 + B1.22 + B2.4),
(A3 + B1.22 + B3.1), (A3 + B1.22 + B3.2), (A3 + B1.22 + B3.3), (A3 + B1.22 + B3.4),
(A3 + B1.22 + B3.5), (A3 + B1.22 + B3.6),
(A3 + B1.22 + B4.1), (A3 + B1.22 + B4.2), (A3 + B1.22 + B4.3), (A3 + B1.22 + B4.4),
(A3 + B1.22 + B4.5), (A3 + B1.22 + B4.6), (A3 + B1.22 + B4.7), (A3 + B1.22 + B4.8),
(A3 + B1.22 + B4.9), (A3 + B1.22 + B4.10), (A3 + B1.22 + B4.11), (A3 + B1.22 + B4.12),
(A3 + B1.22 + B4.13), (A3 + B1.22 + B4.14), (A3 + B1.22 + B4.15), (A3 + B1.22 + B4.16),
(A3 + B1.22 + B4.17), (A3 + B1.22 + B4.18), (A3 + B1.22 + B4.19),
(A3 + B1.22 + B5.1), (A3 + B1.22 + B5.2), (A3 + B1.22 + B6.1), (A3 + B1.22 + B6.2),
(A3 + B1.22 + B6.3), (A3 + B1.22 + B6.4), (A3 + B1.22 + B7.1), (A3 + B1.22 + B7.2),
(A3 + B1.22 + B7.3), (A3 + B1.22 + B7.4), (A3 + B1.22 + B7.5), (A3 + B1.22 + B7.6),
(A3 + B1.22 + B7.7), (A3 + B1.22 + B7.8),
(A3 + B1.22 + B9.1), (A3 + B1.22 + B8.1), (A3 + B1.22 + B10.1),
(A3 + B1.23 + B1.24), (A3 + B1.23 + B1.25), (A3 + B1.23 + B1.26), (A3 + B1.23 + B1.27),
(A3 + B1.23 + B1.28), (A3 + B1.23 + B1.29), (A3 + B1.23 + B1.30), (A3 + B1.23 + B1.31),
(A3 + B1.23 + B1.32), (A3 + B1.23 + B1.33), (A3 + B1.23 + B1.34), (A3 + B1.23 + B1.35),
(A3 + B1.23 + B1.36), (A3 + B1.23 + B1.37),
(A3 + B1.23 + B2.1), (A3 + B1.23 + B2.2), (A3 + B1.23 + B2.3), (A3 + B1.23 + B2.4),
(A3 + B1.23 + B3.1), (A3 + B1.23 + B3.2), (A3 + B1.23 + B3.3), (A3 + B1.23 + B3.4),
(A3 + B1.23 + B3.5), (A3 + B1.23 + B3.6),
(A3 + B1.23 + B4.1), (A3 + B1.23 + B4.2), (A3 + B1.23 + B4.3), (A3 + B1.23 + B4.4),
(A3 + B1.23 + B4.5), (A3 + B1.23 + B4.6), (A3 + B1.23 + B4.7), (A3 + B1.23 + B4.8),
(A3 + B1.23 + B4.9), (A3 + B1.23 + B4.10), (A3 + B1.23 + B4.11), (A3 + B1.23 + B4.12),
(A3 + B1.23 + B4.13), (A3 + B1.23 + B4.14), (A3 + B1.23 + B4.15), (A3 + B1.23 + B4.16),
(A3 + B1.23 + B4.17), (A3 + B1.23 + B4.18), (A3 + B1.23 + B4.19),
(A3 + B1.23 + B5.1), (A3 + B1.23 + B5.2), (A3 + B1.23 + B6.1), (A3 + B1.23 + B6.2),
(A3 + B1.23 + B6.3), (A3 + B1.23 + B6.4), (A3 + B1.23 + B7.1), (A3 + B1.23 + B7.2),
(A3 + B1.23 + B7.3), (A3 + B1.23 + B7.4), (A3 + B1.23 + B7.5), (A3 + B1.23 + B7.6),
(A3 + B1.23 + B7.7), (A3 + B1.23 + B7.8),
(A3 + B1.23 + B8.1), (A3 + B1.23 + B9.1), (A3 + B1.23 + B10.1),
(A3 + B1.24 + B1.25), (A3 + B1.24 + B1.26), (A3 + B1.24 + B1.27), (A3 + B1.24 + B1.28),
(A3 + B1.24 + B1.29), (A3 + B1.24 + B1.30), (A3 + B1.24 + B1.31), (A3 + B1.24 + B1.32),
(A3 + B1.24 + B1.33), (A3 + B1.24 + B1.34), (A3 + B1.24 + B1.35), (A3 + B1.24 + B1.36),
(A3 + B1.24 + B1.37),
(A3 + B1.24 + B2.1), (A3 + B1.24 + B2.2), (A3 + B1.24 + B2.3), (A3 + B1.24 + B2.4),
(A3 + B1.24 + B3.1), (A3 + B1.24 + B3.2), (A3 + B1.24 + B3.3), (A3 + B1.24 + B3.4),
(A3 + B1.24 + B3.5), (A3 + B1.24 + B3.6),
(A3 + B1.24 + B4.1), (A3 + B1.24 + B4.2), (A3 + B1.24 + B4.3), (A3 + B1.24 + B4.4),
(A3 + B1.24 + B4.5), (A3 + B1.24 + B4.6), (A3 + B1.24 + B4.7), (A3 + B1.24 + B4.8),
(A3 + B1.24 + B4.9), (A3 + B1.24 + B4.10), (A3 + B1.24 + B4.11), (A3 + B1.24 + B4.12),
(A3 + B1.24 + B4.13), (A3 + B1.24 + B4.14), (A3 + B1.24 + B4.15), (A3 + B1.24 + B4.16),
(A3 + B1.24 + B4.17), (A3 + B1.24 + B4.18), (A3 + B1.24 + B4.19),
(A3 + B1.24 + B5.1), (A3 + B1.24 + B5.2), (A3 + B1.24 + B6.1), (A3 + B1.24 + B6.2),
(A3 + B1.24 + B6.3), (A3 + B1.24 + B6.4),
(A3 + B1.24 + B7.1), (A3 + B1.24 + B7.2), (A3 + B1.24 + B7.3), (A3 + B1.24 + B7.4),
(A3 + B1.24 + B7.5), (A3 + B1.24 + B7.6), (A3 + B1.24 + B7.7), (A3 + B1.24 + B7.8),
(A3 + B1.24 + B8.1), (A3 + B1.24 + B9.1), (A3 + B1.24 + B10.1),
(A3 + B1.25 + B1.26), (A3 + B1.25 + B1.27), (A3 + B1.25 + B1.28), (A3 + B1.25 + B1.29),
(A3 + B1.25 + B1.30), (A3 + B1.25 + B1.31), (A3 + B1.25 + B1.32), (A3 + B1.25 + B1.33),
(A3 + B1.25 + B1.34), (A3 + B1.25 + B1.35), (A3 + B1.25 + B1.36), (A3 + B1.25 + B1.37),
(A3 + B1.25 + B2.1), (A3 + B1.25 + B2.2), (A3 + B1.25 + B2.3), (A3 + B1.25 + B2.4),
(A3 + B1.25 + B3.1), (A3 + B1.25 + B3.2), (A3 + B1.25 + B3.3), (A3 + B1.25 + B3.4),
(A3 + B1.25 + B3.5), (A3 + B1.25 + B3.6),
(A3 + B1.25 + B4.1), (A3 + B1.25 + B4.2), (A3 + B1.25 + B4.3), (A3 + B1.25 + B4.4),
(A3 + B1.25 + B4.5), (A3 + B1.25 + B4.6), (A3 + B1.25 + B4.7), (A3 + B1.25 + B4.8),
(A3 + B1.25 + B4.9), (A3 + B1.25 + B4.10), (A3 + B1.25 + B4.11), (A3 + B1.25 + B4.12),
(A3 + B1.25 + B4.13), (A3 + B1.25 + B4.14), (A3 + B1.25 + B4.15), (A3 + B1.25 + B4.16),
(A3 + B1.25 + B4.17), (A3 + B1.25 + B4.18), (A3 + B1.25 + B4.19),
(A3 + B1.25 + B5.1), (A3 + B1.25 + B5.2), (A3 + B1.25 + B6.1), (A3 + B1.25 + B6.2),
(A3 + B1.25 + B6.3), (A3 + B1.25 + B6.4),
(A3 + B1.25 + B7.1), (A3 + B1.25 + B7.2), (A3 + B1.25 + B7.3), (A3 + B1.25 + B7.4),
(A3 + B1.25 + B7.5), (A3 + B1.25 + B7.6), (A3 + B1.25 + B7.7), (A3 + B1.25 + B7.8),
(A3 + B1.25 + B8.1), (A3 + B1.25 + B9.1), (A3 + B1.25 + B10.1),
(A3 + B1.26 + B1.27), (A3 + B1.26 + B1.28), (A3 + B1.26 + B1.29), (A3 + B1.26 + B1.30),
(A3 + B1.26 + B1.31), (A3 + B1.26 + B1.32), (A3 + B1.26 + B1.33), (A3 + B1.26 + B1.34),
(A3 + B1.26 + B1.35), (A3 + B1.26 + B1.36), (A3 + B1.26 + B1.37),
(A3 + B1.26 + B2.1), (A3 + B1.26 + B2.2), (A3 + B1.26 + B2.3), (A3 + B1.26 + B2.4),
(A3 + B1.26 + B3.1), (A3 + B1.26 + B3.2), (A3 + B1.26 + B3.3), (A3 + B1.26 + B3.4),
(A3 + B1.26 + B3.5), (A3 + B1.26 + B3.6), (A3 + B1.26 + B4.1), (A3 + B1.26 + B4.2),
(A3 + B1.26 + B4.3), (A3 + B1.26 + B4.4), (A3 + B1.26 + B4.5), (A3 + B1.26 + B4.6),
(A3 + B1.26 + B4.7), (A3 + B1.26 + B4.8), (A3 + B1.26 + B4.9), (A3 + B1.26 + B4.10),
(A3 + B1.26 + B4.11), (A3 + B1.26 + B4.12), (A3 + B1.26 + B4.13), (A3 + B1.26 + B4.14),
(A3 + B1.26 + B4.15), (A3 + B1.26 + B4.16), (A3 + B1.26 + B4.17), (A3 + B1.26 + B4.18),
(A3 + B1.26 + B4.19),
(A3 + B1.26 + B5.1), (A3 + B1.26 + B5.2), (A3 + B1.26 + B6.1), (A3 + B1.26 + B6.2),
(A3 + B1.26 + B6.3), (A3 + B1.26 + B6.4),
(A3 + B1.26 + B7.1), (A3 + B1.26 + B7.2), (A3 + B1.26 + B7.3), (A3 + B1.26 + B7.4),
(A3 + B1.26 + B7.5), (A3 + B1.26 + B7.6), (A3 + B1.26 + B7.7), (A3 + B1.26 + B7.8),
(A3 + B1.26 + B8.1), (A3 + B1.26 + B9.1), (A3 + B1.26 + B10.1),
(A3 + B1.27 + B1.28), (A3 + B1.27 + B1.29), (A3 + B1.27 + B1.30), (A3 + B1.27 + B1.31),
(A3 + B1.27 + B1.32), (A3 + B1.27 + B1.33), (A3 + B1.27 + B1.34), (A3 + B1.27 + B1.35),
(A3 + B1.27 + B1.36), (A3 + B1.27 + B1.37),
(A3 + B1.27 + B2.1), (A3 + B1.27 + B2.2), (A3 + B1.27 + B2.3), (A3 + B1.27 + B2.4),
(A3 + B1.27 + B3.1), (A3 + B1.27 + B3.2), (A3 + B1.27 + B3.3), (A3 + B1.27 + B3.4),
(A3 + B1.27 + B3.5), (A3 + B1.27 + B3.6),
(A3 + B1.27 + B4.1), (A3 + B1.27 + B4.2), (A3 + B1.27 + B4.3), (A3 + B1.27 + B4.4),
(A3 + B1.27 + B4.5), (A3 + B1.27 + B4.6), (A3 + B1.27 + B4.7), (A3 + B1.27 + B4.8),
(A3 + B1.27 + B4.9), (A3 + B1.27 + B4.10), (A3 + B1.27 + B4.11), (A3 + B1.27 + B4.12),
(A3 + B1.27 + B4.13), (A3 + B1.27 + B4.14), (A3 + B1.27 + B4.15), (A3 + B1.27 + B4.16),
(A3 + B1.27 + B4.17), (A3 + B1.27 + B4.18), (A3 + B1.27 + B4.19),
(A3 + B1.27 + B5.1), (A3 + B1.27 + B5.2),
(A3 + B1.27 + B6.1), (A3 + B1.27 + B6.2), (A3 + B1.27 + B6.3), (A3 + B1.27 + B6.4),
(A3 + B1.27 + B7.1), (A3 + B1.27 + B7.2), (A3 + B1.27 + B7.3), (A3 + B1.27 + B7.4),
(A3 + B1.27 + B7.5), (A3 + B1.27 + B7.6), (A3 + B1.27 + B7.7), (A3 + B1.27 + B7.8),
(A3 + B1.27 + B8.1), (A3 + B1.27 + B9.1), (A3 + B1.27 + B10.1),
(A3 + B1.28 + B1.29), (A3 + B1.28 + B1.30), (A3 + B1.28 + B1.31), (A3 + B1.28 + B1.32),
(A3 + B1.28 + B1.33), (A3 + B1.28 + B1.34), (A3 + B1.28 + B1.35), (A3 + B1.28 + B1.36),
(A3 + B1.28 + B1.37),
(A3 + B1.28 + B2.1), (A3 + B1.28 + B2.2), (A3 + B1.28 + B2.3), (A3 + B1.28 + B2.4),
(A3 + B1.28 + B3.1), (A3 + B1.28 + B3.2), (A3 + B1.28 + B3.3), (A3 + B1.28 + B3.4),
(A3 + B1.28 + B3.5), (A3 + B1.28 + B3.6),
(A3 + B1.28 + B4.1), (A3 + B1.28 + B4.2), (A3 + B1.28 + B4.3), (A3 + B1.28 + B4.4),
(A3 + B1.28 + B4.5), (A3 + B1.28 + B4.6), (A3 + B1.28 + B4.7), (A3 + B1.28 + B4.8),
(A3 + B1.28 + B4.9), (A3 + B1.28 + B4.10), (A3 + B1.28 + B4.11), (A3 + B1.28 + B4.12),
(A3 + B1.28 + B4.13), (A3 + B1.28 + B4.14), (A3 + B1.28 + B4.15), (A3 + B1.28 + B4.16),
(A3 + B1.28 + B4.17), (A3 + B1.28 + B4.18), (A3 + B1.28 + B4.19),
(A3 + B1.28 + B5.1), (A3 + B1.28 + B5.2), (A3 + B1.28 + B6.1), (A3 + B1.28 + B6.2),
(A3 + B1.28 + B6.3), (A3 + B1.28 + B6.4), (A3 + B1.28 + B7.1), (A3 + B1.28 + B7.2),
(A3 + B1.28 + B7.3), (A3 + B1.28 + B7.4), (A3 + B1.28 + B7.5), (A3 + B1.28 + B7.6),
(A3 + B1.28 + B7.7), (A3 + B1.28 + B7.8),
(A3 + B1.28 + B8.1), (A3 + B1.28 + B9.1), (A3 + B1.28 + B10.1),
(A3 + B1.29 + B1.30), (A3 + B1.29 + B1.31), (A3 + B1.29 + B1.32), (A3 + B1.29 + B1.33),
(A3 + B1.29 + B1.34), (A3 + B1.29 + B1.35), (A3 + B1.29 + B1.36), (A3 + B1.29 + B1.37),
(A3 + B1.29 + B2.1), (A3 + B1.29 + B2.2), (A3 + B1.29 + B2.3), (A3 + B1.29 + B2.4),
(A3 + B1.29 + B3.1), (A3 + B1.29 + B3.2), (A3 + B1.29 + B3.3), (A3 + B1.29 + B3.4),
(A3 + B1.29 + B3.5), (A3 + B1.29 + B3.6),
(A3 + B1.29 + B4.1), (A3 + B1.29 + B4.2), (A3 + B1.29 + B4.3), (A3 + B1.29 + B4.4),
(A3 + B1.29 + B4.5), (A3 + B1.29 + B4.6), (A3 + B1.29 + B4.7), (A3 + B1.29 + B4.8),
(A3 + B1.29 + B4.9), (A3 + B1.29 + B4.10), (A3 + B1.29 + B4.11), (A3 + B1.29 + B4.12),
(A3 + B1.29 + B4.13), (A3 + B1.29 + B4.14), (A3 + B1.29 + B4.15), (A3 + B1.29 + B4.16),
(A3 + B1.29 + B4.17), (A3 + B1.29 + B4.18), (A3 + B1.29 + B4.19),
(A3 + B1.29 + B5.1), (A3 + B1.29 + B5.2), (A3 + B1.29 + B6.1), (A3 + B1.29 + B6.2),
(A3 + B1.29 + B6.3), (A3 + B1.29 + B6.4),
(A3 + B1.29 + B7.1), (A3 + B1.29 + B7.2), (A3 + B1.29 + B7.3), (A3 + B1.29 + B7.4),
(A3 + B1.29 + B7.5), (A3 + B1.29 + B7.6), (A3 + B1.29 + B7.7), (A3 + B1.29 + B7.8),
(A3 + B1.29 + B8.1), (A3 + B1.29 + B9.1), (A3 + B1.29 + B10.1),
(A3 + B1.30 + B1.31), (A3 + B1.30 + B1.32), (A3 + B1.30 + B1.33), (A3 + B1.30 + B1.34),
(A3 + B1.30 + B1.35), (A3 + B1.30 + B1.36), (A3 + B1.30 + B1.37),
(A3 + B1.30 + B2.1), (A3 + B1.30 + B2.2), (A3 + B1.30 + B2.3), (A3 + B1.30 + B2.4),
(A3 + B1.30 + B3.1), (A3 + B1.30 + B3.2), (A3 + B1.30 + B3.3), (A3 + B1.30 + B3.4),
(A3 + B1.30 + B3.5), (A3 + B1.30 + B3.6),
(A3 + B1.30 + B4.1), (A3 + B1.30 + B4.2), (A3 + B1.30 + B4.3), (A3 + B1.30 + B4.4),
(A3 + B1.30 + B4.5), (A3 + B1.30 + B4.6), (A3 + B1.30 + B4.7), (A3 + B1.30 + B4.8),
(A3 + B1.30 + B4.9), (A3 + B1.30 + B4.10), (A3 + B1.30 + B4.11), (A3 + B1.30 + B4.12),
(A3 + B1.30 + B4.13), (A3 + B1.30 + B4.14), (A3 + B1.30 + B4.15), (A3 + B1.30 + B4.16),
(A3 + B1.30 + B4.17), (A3 + B1.30 + B4.18), (A3 + B1.30 + B4.19),
(A3 + B1.30 + B5.1), (A3 + B1.30 + B5.2), (A3 + B1.30 + B6.1), (A3 + B1.30 + B6.2),
(A3 + B1.30 + B6.3), (A3 + B1.30 + B6.4),
(A3 + B1.30 + B7.1), (A3 + B1.30 + B7.2), (A3 + B1.30 + B7.3), (A3 + B1.30 + B7.4),
(A3 + B1.30 + B7.5), (A3 + B1.30 + B7.6), (A3 + B1.30 + B7.7), (A3 + B1.30 + B7.8),
(A3 + B1.30 + B8.1), (A3 + B1.30 + B9.1), (A3 + B1.30 + B10.1),
(A3 + B1.31 + B1.32), (A3 + B1.31 + B1.33), (A3 + B1.31 + B1.34), (A3 + B1.31 + B1.35),
(A3 + B1.31 + B1.36), (A3 + B1.31 + B1.37),
(A3 + B1.31 + B2.1), (A3 + B1.31 + B2.2), (A3 + B1.31 + B2.3), (A3 + B1.31 + B2.4),
(A3 + B1.31 + B3.1), (A3 + B1.31 + B3.2), (A3 + B1.31 + B3.3), (A3 + B1.31 + B3.4),
(A3 + B1.31 + B3.5), (A3 + B1.31 + B3.6),
(A3 + B1.31 + B4.1), (A3 + B1.31 + B4.2), (A3 + B1.31 + B4.3), (A3 + B1.31 + B4.4),
(A3 + B1.31 + B4.5), (A3 + B1.31 + B4.6), (A3 + B1.31 + B4.7), (A3 + B1.31 + B4.8),
(A3 + B1.31 + B4.9), (A3 + B1.31 + B4.10), (A3 + B1.31 + B4.11), (A3 + B1.31 + B4.12),
(A3 + B1.31 + B4.13), (A3 + B1.31 + B4.14), (A3 + B1.31 + B4.15), (A3 + B1.31 + B4.16),
(A3 + B1.31 + B4.17), (A3 + B1.31 + B4.18), (A3 + B1.31 + B4.19),
(A3 + B1.31 + B5.1), (A3 + B1.31 + B5.2), (A3 + B1.31 + B6.1), (A3 + B1.31 + B6.2),
(A3 + B1.31 + B6.3), (A3 + B1.31 + B6.4),
(A3 + B1.31 + B7.1), (A3 + B1.31 + B7.2), (A3 + B1.31 + B7.3), (A3 + B1.31 + B7.4),
(A3 + B1.31 + B7.5), (A3 + B1.31 + B7.6), (A3 + B1.31 + B7.7), (A3 + B1.31 + B7.8),
(A3 + B1.31 + B8.1), (A3 + B1.31 + B9.1), (A3 + B1.31 + B10.1),
(A3 + B1.32 + B1.33), (A3 + B1.32 + B1.34), (A3 + B1.32 + B1.35), (A3 + B1.32 + B1.36),
(A3 + B1.32 + B1.37),
(A3 + B1.32 + B2.1), (A3 + B1.32 + B2.2), (A3 + B1.32 + B2.3), (A3 + B1.32 + B2.4),
(A3 + B1.32 + B3.1), (A3 + B1.32 + B3.2), (A3 + B1.32 + B3.3), (A3 + B1.32 + B3.4),
(A3 + B1.32 + B3.5), (A3 + B1.32 + B3.6),
(A3 + B1.32 + B4.1), (A3 + B1.32 + B4.2), (A3 + B1.32 + B4.3), (A3 + B1.32 + B4.4),
(A3 + B1.32 + B4.5), (A3 + B1.32 + B4.6), (A3 + B1.32 + B4.7), (A3 + B1.32 + B4.8),
(A3 + B1.32 + B4.9), (A3 + B1.32 + B4.10), (A3 + B1.32 + B4.11), (A3 + B1.32 + B4.12),
(A3 + B1.32 + B4.13), (A3 + B1.32 + B4.14), (A3 + B1.32 + B4.15), (A3 + B1.32 + B4.16),
(A3 + B1.32 + B4.17), (A3 + B1.32 + B4.18), (A3 + B1.32 + B4.19),
(A3 + B1.32 + B5.1), (A3 + B1.32 + B5.2), (A3 + B1.32 + B6.1), (A3 + B1.32 + B6.2),
(A3 + B1.32 + B6.3), (A3 + B1.32 + B6.4),
(A3 + B1.32 + B7.1), (A3 + B1.32 + B7.2), (A3 + B1.32 + B7.3), (A3 + B1.32 + B7.4),
(A3 + B1.32 + B7.5), (A3 + B1.32 + B7.6), (A3 + B1.32 + B7.7), (A3 + B1.32 + B7.8),
(A3 + B1.32 + B8.1), (A3 + B1.32 + B9.1), (A3 + B1.32 + B10.1),
(A3 + B1.33 + B1.34), (A3 + B1.33 + B1.35), (A3 + B1.33 + B1.36), (A3 + B1.33 + B1.37),
(A3 + B1.33 + B2.1), (A3 + B1.33 + B2.2), (A3 + B1.33 + B2.3), (A3 + B1.33 + B2.4),
(A3 + B1.33 + B3.1), (A3 + B1.33 + B3.2), (A3 + B1.33 + B3.3), (A3 + B1.33 + B3.4),
(A3 + B1.33 + B3.5), (A3 + B1.33 + B3.6), (A3 + B1.33 + B4.1), (A3 + B1.33 + B4.2),
(A3 + B1.33 + B4.3), (A3 + B1.33 + B4.4), (A3 + B1.33 + B4.5), (A3 + B1.33 + B4.6),
(A3 + B1.33 + B4.7), (A3 + B1.33 + B4.8), (A3 + B1.33 + B4.9), (A3 + B1.33 + B4.10),
(A3 + B1.33 + B4.11), (A3 + B1.33 + B4.12), (A3 + B1.33 + B4.13), (A3 + B1.33 + B4.14),
(A3 + B1.33 + B4.15), (A3 + B1.33 + B4.16), (A3 + B1.33 + B4.17), (A3 + B1.33 + B4.18),
(A3 + B1.33 + B4.19),
(A3 + B1.33 + B5.1), (A3 + B1.33 + B5.2), (A3 + B1.33 + B6.1), (A3 + B1.33 + B6.2),
(A3 + B1.33 + B6.3), (A3 + B1.33 + B6.4),
(A3 + B1.33 + B7.1), (A3 + B1.33 + B7.2), (A3 + B1.33 + B7.3), (A3 + B1.33 + B7.4),
(A3 + B1.33 + B7.5), (A3 + B1.33 + B7.6), (A3 + B1.33 + B7.7), (A3 + B1.33 + B7.8),
(A3 + B1.33 + B8.1), (A3 + B1.33 + B9.1), (A3 + B1.33 + B10.1),
(A3 + B1.34 + B1.35), (A3 + B1.34 + B1.36), (A3 + B1.34 + B1.37),
(A3 + B1.34 + B2.1), (A3 + B1.34 + B2.2), (A3 + B1.34 + B2.3), (A3 + B1.34 + B2.4),
(A3 + B1.34 + B3.1), (A3 + B1.34 + B3.2), (A3 + B1.34 + B3.3), (A3 + B1.34 + B3.4),
(A3 + B1.34 + B3.5), (A3 + B1.34 + B3.6),
(A3 + B1.34 + B4.1), (A3 + B1.34 + B4.2), (A3 + B1.34 + B4.3), (A3 + B1.34 + B4.4),
(A3 + B1.34 + B4.5), (A3 + B1.34 + B4.6), (A3 + B1.34 + B4.7), (A3 + B1.34 + B4.8),
(A3 + B1.34 + B4.9), (A3 + B1.34 + B4.10), (A3 + B1.34 + B4.11), (A3 + B1.34 + B4.12),
(A3 + B1.34 + B4.13), (A3 + B1.34 + B4.14), (A3 + B1.34 + B4.15), (A3 + B1.34 + B4.16),
(A3 + B1.34 + B4.17), (A3 + B1.34 + B4.18), (A3 + B1.34 + B4.19),
(A3 + B1.34 + B5.1), (A3 + B1.34 + B5.2), (A3 + B1.34 + B6.1), (A3 + B1.34 + B6.2),
(A3 + B1.34 + B6.3), (A3 + B1.34 + B6.4),
(A3 + B1.34 + B7.1), (A3 + B1.34 + B7.2), (A3 + B1.34 + B7.3), (A3 + B1.34 + B7.4),
(A3 + B1.34 + B7.5), (A3 + B1.34 + B7.6), (A3 + B1.34 + B7.7), (A3 + B1.34 + B7.8),
(A3 + B1.34 + B8.1), (A3 + B1.34 + B9.1), (A3 + B1.34 + B10.1),
(A3 + B1.35 + B1.36), (A3 + B1.35 + B1.37),
(A3 + B1.35 + B2.1), (A3 + B1.35 + B2.2), (A3 + B1.35 + B2.3), (A3 + B1.35 + B2.4),
(A3 + B1.35 + B3.1), (A3 + B1.35 + B3.2), (A3 + B1.35 + B3.3), (A3 + B1.35 + B3.4),
(A3 + B1.35 + B3.5), (A3 + B1.35 + B3.6),
(A3 + B1.35 + B4.1), (A3 + B1.35 + B4.2), (A3 + B1.35 + B4.3), (A3 + B1.35 + B4.4),
(A3 + B1.35 + B4.5), (A3 + B1.35 + B4.6), (A3 + B1.35 + B4.7), (A3 + B1.35 + B4.8),
(A3 + B1.35 + B4.9), (A3 + B1.35 + B4.10), (A3 + B1.35 + B4.11), (A3 + B1.35 + B4.12),
(A3 + B1.35 + B4.13), (A3 + B1.35 + B4.14), (A3 + B1.35 + B4.15), (A3 + B1.35 + B4.16),
(A3 + B1.35 + B4.17), (A3 + B1.35 + B4.18), (A3 + B1.35 + B4.19),
(A3 + B1.35 + B5.1), (A3 + B1.35 + B5.2), (A3 + B1.35 + B6.1), (A3 + B1.35 + B6.2),
(A3 + B1.35 + B6.3), (A3 + B1.35 + B6.4),
(A3 + B1.35 + B7.1), (A3 + B1.35 + B7.2), (A3 + B1.35 + B7.3), (A3 + B1.35 + B7.4),
(A3 + B1.35 + B7.5), (A3 + B1.35 + B7.6), (A3 + B1.35 + B7.7), (A3 + B1.35 + B7.8),
(A3 + B1.35 + B8.1), (A3 + B1.35 + B9.1), (A3 + B1.35 + B10.1),
(A3 + B1.36 + B1.37),
(A3 + B1.36 + B2.1), (A3 + B1.36 + B2.2), (A3 + B1.36 + B2.3), (A3 + B1.36 + B2.4),
(A3 + B1.36 + B3.1), (A3 + B1.36 + B3.2), (A3 + B1.36 + B3.3), (A3 + B1.36 + B3.4),
(A3 + B1.36 + B3.5), (A3 + B1.36 + B3.6),
(A3 + B1.36 + B4.1), (A3 + B1.36 + B4.2), (A3 + B1.36 + B4.3), (A3 + B1.36 + B4.4),
(A3 + B1.36 + B4.5), (A3 + B1.36 + B4.6), (A3 + B1.36 + B4.7), (A3 + B1.36 + B4.8),
(A3 + B1.36 + B4.9), (A3 + B1.36 + B4.10), (A3 + B1.36 + B4.11), (A3 + B1.36 + B4.12),
(A3 + B1.36 + B4.13), (A3 + B1.36 + B4.14), (A3 + B1.36 + B4.15), (A3 + B1.36 + B4.16),
(A3 + B1.36 + B4.17), (A3 + B1.36 + B4.18), (A3 + B1.36 + B4.19),
(A3 + B1.36 + B5.1), (A3 + B1.36 + B5.2),
(A3 + B1.36 + B6.1), (A3 + B1.36 + B6.2), (A3 + B1.36 + B6.3), (A3 + B1.36 + B6.4),
(A3 + B1.36 + B7.1), (A3 + B1.36 + B7.2), (A3 + B1.36 + B7.3), (A3 + B1.36 + B7.4),
(A3 + B1.36 + B7.5), (A3 + B1.36 + B7.6), (A3 + B1.36 + B7.7), (A3 + B1.36 + B7.8),
(A3 + B1.36 + B8.1), (A3 + B1.36 + B9.1), (A3 + B1.36 + B10.1),
(A3 + B1.37 + B2.1), (A3 + B1.37 + B2.2), (A3 + B1.37 + B2.3), (A3 + B1.37 + B2.4),
(A3 + B1.37 + B3.1), (A3 + B1.37 + B3.2), (A3 + B1.37 + B3.3), (A3 + B1.37 + B3.4),
(A3 + B1.37 + B3.5), (A3 + B1.37 + B3.6),
(A3 + B1.37 + B4.1), (A3 + B1.37 + B4.2), (A3 + B1.37 + B4.3), (A3 + B1.37 + B4.4),
(A3 + B1.37 + B4.5), (A3 + B1.37 + B4.6), (A3 + B1.37 + B4.7), (A3 + B1.37 + B4.8),
(A3 + B1.37 + B4.9), (A3 + B1.37 + B4.10), (A3 + B1.37 + B4.11), (A3 + B1.37 + B4.12),
(A3 + B1.37 + B4.13), (A3 + B1.37 + B4.14), (A3 + B1.37 + B4.15), (A3 + B1.37 + B4.16),
(A3 + B1.37 + B4.17), (A3 + B1.37 + B4.18), (A3 + B1.37 + B4.19),
(A3 + B1.37 + B5.1), (A3 + B1.37 + B5.2),
(A3 + B1.37 + B6.1), (A3 + B1.37 + B6.2), (A3 + B1.37 + B6.3), (A3 + B1.37 + B6.4),
(A3 + B1.37 + B7.1), (A3 + B1.37 + B7.2), (A3 + B1.37 + B7.3), (A3 + B1.37 + B7.4),
(A3 + B1.37 + B7.5), (A3 + B1.37 + B7.6), (A3 + B1.37 + B7.7), (A3 + B1.37 + B7.8),
(A3 + B1.37 + B8.1), (A3 + B1.37 + B9.1), (A3 + B1.37 + B10.1),
(A3 + B2.1 + B2.2), (A3 + B2.1 + B2.3), (A3 + B2.1 + B2.4),
(A3 + B2.1 + B3.1), (A3 + B2.1 + B3.2), (A3 + B2.1 + B3.3), (A3 + B2.1 + B3.4),
(A3 + B2.1 + B3.5), (A3 + B2.1 + B3.6),
(A3 + B2.1 + B4.1), (A3 + B2.1 + B4.2), (A3 + B2.1 + B4.3), (A3 + B2.1 + B4.4),
(A3 + B2.1 + B4.5), (A3 + B2.1 + B4.6), (A3 + B2.1 + B4.7), (A3 + B2.1 + B4.8),
(A3 + B2.1 + B4.9), (A3 + B2.1 + B4.10), (A3 + B2.1 + B4.11), (A3 + B2.1 + B4.12),
(A3 + B2.1 + B4.13), (A3 + B2.1 + B4.14), (A3 + B2.1 + B4.15), (A3 + B2.1 + B4.16),
(A3 + B2.1 + B4.17), (A3 + B2.1 + B4.18), (A3 + B2.1 + B4.19),
(A3 + B2.1 + B5.1), (A3 + B2.1 + B5.2),
(A3 + B2.1 + B6.1), (A3 + B2.1 + B6.2), (A3 + B2.1 + B6.3), (A3 + B2.1 + B6.4),
(A3 + B2.1 + B7.1), (A3 + B2.1 + B7.2), (A3 + B2.1 + B7.3), (A3 + B2.1 + B7.4),
(A3 + B2.1 + B7.5), (A3 + B2.1 + B7.6), (A3 + B2.1 + B7.7), (A3 + B2.1 + B7.8),
(A3 + B2.1 + B8.1), (A3 + B2.1 + B9.1), (A3 + B2.1 + B10.1),
(A3 + B2.2 + B2.3), (A3 + B2.2 + B2.4),
(A3 + B2.2 + B3.1), (A3 + B2.2 + B3.2), (A3 + B2.2 + B3.3), (A3 + B2.2 + B3.4),
(A3 + B2.2 + B3.5), (A3 + B2.2 + B3.6),
(A3 + B2.2 + B4.1), (A3 + B2.2 + B4.2), (A3 + B2.2 + B4.3), (A3 + B2.2 + B4.4),
(A3 + B2.2 + B4.5), (A3 + B2.2 + B4.6), (A3 + B2.2 + B4.7), (A3 + B2.2 + B4.8),
(A3 + B2.2 + B4.9), (A3 + B2.2 + B4.10), (A3 + B2.2 + B4.11), (A3 + B2.2 + B4.12),
(A3 + B2.2 + B4.13), (A3 + B2.2 + B4.14), (A3 + B2.2 + B4.15), (A3 + B2.2 + B4.16),
(A3 + B2.2 + B4.17), (A3 + B2.2 + B4.18), (A3 + B2.2 + B4.19),
(A3 + B2.2 + B5.1), (A3 + B2.2 + B5.2),
(A3 + B2.2 + B6.1), (A3 + B2.2 + B6.2), (A3 + B2.2 + B6.3), (A3 + B2.2 + B6.4),
(A3 + B2.2 + B7.1), (A3 + B2.2 + B7.2), (A3 + B2.2 + B7.3), (A3 + B2.2 + B7.4),
(A3 + B2.2 + B7.5), (A3 + B2.2 + B7.6), (A3 + B2.2 + B7.7), (A3 + B2.2 + B7.8),
(A3 + B2.2 + B8.1), (A3 + B2.2 + B9.1), (A3 + B2.2 + B10.1),
(A3 + B2.3 + B2.4), (A3 + B2.3 + B3.1), (A3 + B2.3 + B3.2), (A3 + B2.3 + B3.3),
(A3 + B2.3 + B3.4), (A3 + B2.3 + B3.5), (A3 + B2.3 + B3.6), (A3 + B2.3 + B4.1),
(A3 + B2.3 + B4.2), (A3 + B2.3 + B4.3), (A3 + B2.3 + B4.4), (A3 + B2.3 + B4.5),
(A3 + B2.3 + B4.6), (A3 + B2.3 + B4.7), (A3 + B2.3 + B4.8), (A3 + B2.3 + B4.9),
(A3 + B2.3 + B4.10), (A3 + B2.3 + B4.11), (A3 + B2.3 + B4.12), (A3 + B2.3 + B4.13),
(A3 + B2.3 + B4.14), (A3 + B2.3 + B4.15), (A3 + B2.3 + B4.16), (A3 + B2.3 + B4.17),
(A3 + B2.3 + B4.18), (A3 + B2.3 + B4.19),
(A3 + B2.3 + B5.1), (A3 + B2.3 + B5.2),
(A3 + B2.3 + B6.1), (A3 + B2.3 + B6.2), (A3 + B2.3 + B6.3), (A3 + B2.3 + B6.4),
(A3 + B2.3 + B7.1), (A3 + B2.3 + B7.2), (A3 + B2.3 + B7.3), (A3 + B2.3 + B7.4),
(A3 + B2.3 + B7.5), (A3 + B2.3 + B7.6), (A3 + B2.3 + B7.7), (A3 + B2.3 + B7.8),
(A3 + B2.3 + B8.1), (A3 + B2.3 + B9.1), (A3 + B2.3 + B10.1),
(A3 + B2.4 + B3.1), (A3 + B2.4 + B3.2), (A3 + B2.4 + B3.3), (A3 + B2.4 + B3.4),
(A3 + B2.4 + B3.5), (A3 + B2.4 + B3.6),
(A3 + B2.4 + B4.1), (A3 + B2.4 + B4.2), (A3 + B2.4 + B4.3), (A3 + B2.4 + B4.4),
(A3 + B2.4 + B4.5), (A3 + B2.4 + B4.6), (A3 + B2.4 + B4.7), (A3 + B2.4 + B4.8),
(A3 + B2.4 + B4.9), (A3 + B2.4 + B4.10), (A3 + B2.4 + B4.11), (A3 + B2.4 + B4.12),
(A3 + B2.4 + B4.13), (A3 + B2.4 + B4.14), (A3 + B2.4 + B4.15), (A3 + B2.4 + B4.16),
(A3 + B2.4 + B4.17), (A3 + B2.4 + B4.18), (A3 + B2.4 + B4.19),
(A3 + B2.4 + B5.1), (A3 + B2.4 + B5.2),
(A3 + B2.4 + B6.1), (A3 + B2.4 + B6.2), (A3 + B2.4 + B6.3), (A3 + B2.4 + B6.4),
(A3 + B2.4 + B7.1), (A3 + B2.4 + B7.2), (A3 + B2.4 + B7.3), (A3 + B2.4 + B7.4),
(A3 + B2.4 + B7.5), (A3 + B2.4 + B7.6), (A3 + B2.4 + B7.7), (A3 + B2.4 + B7.8),
(A3 + B2.4 + B8.1), (A3 + B2.4 + B9.1), (A3 + B2.4 + B10.1),
(A3 + B3.1 + B3.2), (A3 + B3.1 + B3.3), (A3 + B3.1 + B3.4), (A3 + B3.1 + B3.5),
(A3 + B3.1 + B3.6),
(A3 + B3.1 + B4.1), (A3 + B3.1 + B4.2), (A3 + B3.1 + B4.3), (A3 + B3.1 + B4.4),
(A3 + B3.1 + B4.5), (A3 + B3.1 + B4.6), (A3 + B3.1 + B4.7), (A3 + B3.1 + B4.8),
(A3 + B3.1 + B4.9), (A3 + B3.1 + B4.10), (A3 + B3.1 + B4.11), (A3 + B3.1 + B4.12),
(A3 + B3.1 + B4.13), (A3 + B3.1 + B4.14), (A3 + B3.1 + B4.15), (A3 + B3.1 + B4.16),
(A3 + B3.1 + B4.17), (A3 + B3.1 + B4.18), (A3 + B3.1 + B4.19),
(A3 + B3.1 + B5.1), (A3 + B3.1 + B5.2), (A3 + B3.1 + B6.1), (A3 + B3.1 + B6.2),
(A3 + B3.1 + B6.3), (A3 + B3.1 + B6.4),
(A3 + B3.1 + B7.1), (A3 + B3.1 + B7.2), (A3 + B3.1 + B7.3), (A3 + B3.1 + B7.4),
(A3 + B3.1 + B7.5), (A3 + B3.1 + B7.6), (A3 + B3.1 + B7.7), (A3 + B3.1 + B7.8),
(A3 + B3.1 + B8.1), (A3 + B3.1 + B9.1), (A3 + B3.1 + B10.1),
(A3 + B3.2 + B3.3), (A3 + B3.2 + B3.4), (A3 + B3.2 + B3.5), (A3 + B3.2 + B3.6),
(A3 + B3.2 + B4.1), (A3 + B3.2 + B4.2), (A3 + B3.2 + B4.3), (A3 + B3.2 + B4.4),
(A3 + B3.2 + B4.5), (A3 + B3.2 + B4.6), (A3 + B3.2 + B4.7), (A3 + B3.2 + B4.8),
(A3 + B3.2 + B4.9), (A3 + B3.2 + B4.10), (A3 + B3.2 + B4.11), (A3 + B3.2 + B4.12),
(A3 + B3.2 + B4.13), (A3 + B3.2 + B4.14), (A3 + B3.2 + B4.15), (A3 + B3.2 + B4.16),
(A3 + B3.2 + B4.17), (A3 + B3.2 + B4.18), (A3 + B3.2 + B4.19),
(A3 + B3.2 + B5.1), (A3 + B3.2 + B5.2), (A3 + B3.2 + B6.1), (A3 + B3.2 + B6.2),
(A3 + B3.2 + B6.3), (A3 + B3.2 + B6.4), (A3 + B3.2 + B7.1), (A3 + B3.2 + B7.2),
(A3 + B3.2 + B7.3), (A3 + B3.2 + B7.4), (A3 + B3.2 + B7.5), (A3 + B3.2 + B7.6),
(A3 + B3.2 + B7.7), (A3 + B3.2 + B7.8),
(A3 + B3.2 + B8.1), (A3 + B3.2 + B9.1), (A3 + B3.2 + B10.1),
(A3 + B3.3 + B3.4), (A3 + B3.3 + B3.5), (A3 + B3.3 + B3.6),
(A3 + B3.3 + B4.1), (A3 + B3.3 + B4.2), (A3 + B3.3 + B4.3), (A3 + B3.3 + B4.4),
(A3 + B3.3 + B4.5), (A3 + B3.3 + B4.6), (A3 + B3.3 + B4.7), (A3 + B3.3 + B4.8),
(A3 + B3.3 + B4.9), (A3 + B3.3 + B4.10), (A3 + B3.3 + B4.11), (A3 + B3.3 + B4.12),
(A3 + B3.3 + B4.13), (A3 + B3.3 + B4.14), (A3 + B3.3 + B4.15), (A3 + B3.3 + B4.16),
(A3 + B3.3 + B4.17), (A3 + B3.3 + B4.18), (A3 + B3.3 + B4.19),
(A3 + B3.3 + B5.1), (A3 + B3.3 + B5.2),
(A3 + B3.3 + B6.1), (A3 + B3.3 + B6.2), (A3 + B3.3 + B6.3), (A3 + B3.3 + B6.4),
(A3 + B3.3 + B7.1), (A3 + B3.3 + B7.2), (A3 + B3.3 + B7.3), (A3 + B3.3 + B7.4),
(A3 + B3.3 + B7.5), (A3 + B3.3 + B7.6), (A3 + B3.3 + B7.7), (A3 + B3.3 + B7.8),
(A3 + B3.3 + B8.1), (A3 + B3.3 + B9.1), (A3 + B3.3 + B10.1),
(A3 + B3.4 + B3.5), (A3 + B3.4 + B3.6),
(A3 + B3.4 + B4.1), (A3 + B3.4 + B4.2), (A3 + B3.4 + B4.3), (A3 + B3.4 + B4.4),
(A3 + B3.4 + B4.5), (A3 + B3.4 + B4.6), (A3 + B3.4 + B4.7), (A3 + B3.4 + B4.8),
(A3 + B3.4 + B4.9), (A3 + B3.4 + B4.10), (A3 + B3.4 + B4.11), (A3 + B3.4 + B4.12),
(A3 + B3.4 + B4.13), (A3 + B3.4 + B4.14), (A3 + B3.4 + B4.15), (A3 + B3.4 + B4.16),
(A3 + B3.4 + B4.17), (A3 + B3.4 + B4.18), (A3 + B3.4 + B4.19),
(A3 + B3.4 + B5.1), (A3 + B3.4 + B5.2), (A3 + B3.4 + B6.1), (A3 + B3.4 + B6.2),
(A3 + B3.4 + B6.3), (A3 + B3.4 + B6.4),
(A3 + B3.4 + B7.1), (A3 + B3.4 + B7.2), (A3 + B3.4 + B7.3), (A3 + B3.4 + B7.4),
(A3 + B3.4 + B7.5), (A3 + B3.4 + B7.6), (A3 + B3.4 + B7.7), (A3 + B3.4 + B7.8),
(A3 + B3.4 + B8.1), (A3 + B3.4 + B9.1), (A3 + B3.4 + B10.1),
(A3 + B3.5 + B3.6), (A3 + B3.5 + B4.1), (A3 + B3.5 + B4.2), (A3 + B3.5 + B4.3),
(A3 + B3.5 + B4.4), (A3 + B3.5 + B4.5), (A3 + B3.5 + B4.6), (A3 + B3.5 + B4.7),
(A3 + B3.5 + B4.8), (A3 + B3.5 + B4.9), (A3 + B3.5 + B4.10), (A3 + B3.5 + B4.11),
(A3 + B3.5 + B4.12), (A3 + B3.5 + B4.13), (A3 + B3.5 + B4.14), (A3 + B3.5 + B4.15),
(A3 + B3.5 + B4.16), (A3 + B3.5 + B4.17), (A3 + B3.5 + B4.18), (A3 + B3.5 + B4.19),
(A3 + B3.5 + B5.1), (A3 + B3.5 + B5.2),
(A3 + B3.5 + B6.1), (A3 + B3.5 + B6.2), (A3 + B3.5 + B6.3), (A3 + B3.5 + B6.4),
(A3 + B3.5 + B7.1), (A3 + B3.5 + B7.2), (A3 + B3.5 + B7.3), (A3 + B3.5 + B7.4),
(A3 + B3.5 + B7.5), (A3 + B3.5 + B7.6), (A3 + B3.5 + B7.7), (A3 + B3.5 + B7.8),
(A3 + B3.5 + B8.1), (A3 + B3.5 + B9.1), (A3 + B3.5 + B10.1),
(A3 + B4.1 + B4.2), (A3 + B4.1 + B4.3), (A3 + B4.1 + B4.4), (A3 + B4.1 + B4.5),
(A3 + B4.1 + B4.6), (A3 + B4.1 + B4.7), (A3 + B4.1 + B4.8), (A3 + B4.1 + B4.9),
(A3 + B4.1 + B4.10), (A3 + B4.1 + B4.11), (A3 + B4.1 + B4.12), (A3 + B4.1 + B4.13),
(A3 + B4.1 + B4.14), (A3 + B4.1 + B4.15), (A3 + B4.1 + B4.16), (A3 + B4.1 + B4.17),
(A3 + B4.1 + B4.18), (A3 + B4.1 + B4.19),
(A3 + B4.1 + B5.1), (A3 + B4.1 + B5.2),
(A3 + B4.1 + B6.1), (A3 + B4.1 + B6.2), (A3 + B4.1 + B6.3), (A3 + B4.1 + B6.4),
(A3 + B4.1 + B7.1), (A3 + B4.1 + B7.2), (A3 + B4.1 + B7.3), (A3 + B4.1 + B7.4),
(A3 + B4.1 + B7.5), (A3 + B4.1 + B7.6), (A3 + B4.1 + B7.7), (A3 + B4.1 + B7.8),
(A3 + B4.1 + B8.1), (A3 + B4.1 + B9.1), (A3 + B4.1 + B10.1),
(A3 + B4.2 + B4.3), (A3 + B4.2 + B4.4), (A3 + B4.2 + B4.5), (A3 + B4.2 + B4.6),
(A3 + B4.2 + B4.7), (A3 + B4.2 + B4.8), (A3 + B4.2 + B4.9), (A3 + B4.2 + B4.10),
(A3 + B4.2 + B4.11), (A3 + B4.2 + B4.12), (A3 + B4.2 + B4.13), (A3 + B4.2 + B4.14),
(A3 + B4.2 + B4.15), (A3 + B4.2 + B4.16), (A3 + B4.2 + B4.17), (A3 + B4.2 + B4.18),
(A3 + B4.2 + B4.19),
(A3 + B4.2 + B5.1), (A3 + B4.2 + B5.2),
(A3 + B4.2 + B6.1), (A3 + B4.2 + B6.2), (A3 + B4.2 + B6.3), (A3 + B4.2 + B6.4),
(A3 + B4.2 + B7.1), (A3 + B4.2 + B7.2), (A3 + B4.2 + B7.3), (A3 + B4.2 + B7.4),
(A3 + B4.2 + B7.5), (A3 + B4.2 + B7.6), (A3 + B4.2 + B7.7), (A3 + B4.2 + B7.8),
(A3 + B4.2 + B8.1), (A3 + B4.2 + B9.1), (A3 + B4.2 + B10.1),
(A3 + B4.3 + B4.4), (A3 + B4.3 + B4.5), (A3 + B4.3 + B4.6), (A3 + B4.3 + B4.7),
(A3 + B4.3 + B4.8), (A3 + B4.3 + B4.9), (A3 + B4.3 + B4.10), (A3 + B4.3 + B4.11),
(A3 + B4.3 + B4.12), (A3 + B4.3 + B4.13), (A3 + B4.3 + B4.14), (A3 + B4.3 + B4.15),
(A3 + B4.3 + B4.16), (A3 + B4.3 + B4.17), (A3 + B4.3 + B4.18), (A3 + B4.3 + B4.19),
(A3 + B4.3 + B5.1), (A3 + B4.3 + B5.2),
(A3 + B4.3 + B6.1), (A3 + B4.3 + B6.2), (A3 + B4.3 + B6.3), (A3 + B4.3 + B6.4),
(A3 + B4.3 + B7.1), (A3 + B4.3 + B7.2), (A3 + B4.3 + B7.3), (A3 + B4.3 + B7.4),
(A3 + B4.3 + B7.5), (A3 + B4.3 + B7.6), (A3 + B4.3 + B7.7), (A3 + B4.3 + B7.8),
(A3 + B4.3 + B8.1), (A3 + B4.3 + B9.1), (A3 + B4.3 + B10.1),
(A3 + B4.4 + B4.5), (A3 + B4.4 + B4.6), (A3 + B4.4 + B4.7), (A3 + B4.4 + B4.8),
(A3 + B4.4 + B4.9), (A3 + B4.4 + B4.10), (A3 + B4.4 + B4.11), (A3 + B4.4 + B4.12),
(A3 + B4.4 + B4.13), (A3 + B4.4 + B4.14), (A3 + B4.4 + B4.15), (A3 + B4.4 + B4.16),
(A3 + B4.4 + B4.17), (A3 + B4.4 + B4.18), (A3 + B4.4 + B4.19),
(A3 + B4.4 + B5.1), (A3 + B4.4 + B5.2),
(A3 + B4.4 + B6.1), (A3 + B4.4 + B6.2), (A3 + B4.4 + B6.3), (A3 + B4.4 + B6.4),
(A3 + B4.4 + B7.1), (A3 + B4.4 + B7.2), (A3 + B4.4 + B7.3), (A3 + B4.4 + B7.4),
(A3 + B4.4 + B7.5), (A3 + B4.4 + B7.6), (A3 + B4.4 + B7.7), (A3 + B4.4 + B7.8),
(A3 + B4.4 + B8.1), (A3 + B4.4 + B9.1), (A3 + B4.4 + B10.1),
(A3 + B4.5 + B4.6), (A3 + B4.5 + B4.7), (A3 + B4.5 + B4.8), (A3 + B4.5 + B4.9),
(A3 + B4.5 + B4.10), (A3 + B4.5 + B4.11), (A3 + B4.5 + B4.12), (A3 + B4.5 + B4.13),
(A3 + B4.5 + B4.14), (A3 + B4.5 + B4.15), (A3 + B4.5 + B4.16), (A3 + B4.5 + B4.17),
(A3 + B4.5 + B4.18), (A3 + B4.5 + B4.19),
(A3 + B4.5 + B5.1), (A3 + B4.5 + B5.2),
(A3 + B4.5 + B6.1), (A3 + B4.5 + B6.2), (A3 + B4.5 + B6.3), (A3 + B4.5 + B6.4),
(A3 + B4.5 + B7.1), (A3 + B4.5 + B7.2), (A3 + B4.5 + B7.3), (A3 + B4.5 + B7.4),
(A3 + B4.5 + B7.5), (A3 + B4.5 + B7.6), (A3 + B4.5 + B7.7), (A3 + B4.5 + B7.8),
(A3 + B4.5 + B8.1), (A3 + B4.5 + B9.1), (A3 + B4.5 + B10.1),
(A3 + B4.6 + B4.7), (A3 + B4.6 + B4.8), (A3 + B4.6 + B4.9), (A3 + B4.6 + B4.10),
(A3 + B4.6 + B4.11), (A3 + B4.6 + B4.12), (A3 + B4.6 + B4.13), (A3 + B4.6 + B4.14),
(A3 + B4.6 + B4.15), (A3 + B4.6 + B4.16), (A3 + B4.6 + B4.17), (A3 + B4.6 + B4.18),
(A3 + B4.6 + B4.19),
(A3 + B4.6 + B5.1), (A3 + B4.6 + B5.2),
(A3 + B4.6 + B6.1), (A3 + B4.6 + B6.2), (A3 + B4.6 + B6.3), (A3 + B4.6 + B6.4),
(A3 + B4.6 + B7.1), (A3 + B4.6 + B7.2), (A3 + B4.6 + B7.3), (A3 + B4.6 + B7.4),
(A3 + B4.6 + B7.5), (A3 + B4.6 + B7.6), (A3 + B4.6 + B7.7), (A3 + B4.6 + B7.8),
(A3 + B4.6 + B8.1), (A3 + B4.6 + B9.1), (A3 + B4.6 + B10.1),
(A3 + B4.7 + B4.8), (A3 + B4.7 + B4.9), (A3 + B4.7 + B4.10), (A3 + B4.7 + B4.11),
(A3 + B4.7 + B4.12), (A3 + B4.7 + B4.13), (A3 + B4.7 + B4.14), (A3 + B4.7 + B4.15),
(A3 + B4.7 + B4.16), (A3 + B4.7 + B4.17), (A3 + B4.7 + B4.18), (A3 + B4.7 + B4.19),
(A3 + B4.7 + B5.1), (A3 + B4.7 + B5.2),
(A3 + B4.7 + B6.1), (A3 + B4.7 + B6.2), (A3 + B4.7 + B6.3), (A3 + B4.7 + B6.4),
(A3 + B4.7 + B7.1), (A3 + B4.7 + B7.2), (A3 + B4.7 + B7.3), (A3 + B4.7 + B7.4),
(A3 + B4.7 + B7.5), (A3 + B4.7 + B7.6), (A3 + B4.7 + B7.7), (A3 + B4.7 + B7.8),
(A3 + B4.7 + B8.1), (A3 + B4.7 + B9.1), (A3 + B4.7 + B10.1),
(A3 + B4.8 + B4.9), (A3 + B4.8 + B4.10), (A3 + B4.8 + B4.11), (A3 + B4.8 + B4.12),
(A3 + B4.8 + B4.13), (A3 + B4.8 + B4.14), (A3 + B4.8 + B4.15), (A3 + B4.8 + B4.16),
(A3 + B4.8 + B4.17), (A3 + B4.8 + B4.18), (A3 + B4.8 + B4.19), (A3 + B4.8 + B5.1),
(A3 + B4.8 + B5.2), (A3 + B4.8 + B6.1), (A3 + B4.8 + B6.2), (A3 + B4.8 + B6.3),
(A3 + B4.8 + B6.4), (A3 + B4.8 + B7.1), (A3 + B4.8 + B7.2), (A3 + B4.8 + B7.3),
(A3 + B4.8 + B7.4), (A3 + B4.8 + B7.5), (A3 + B4.8 + B7.6), (A3 + B4.8 + B7.7),
(A3 + B4.8 + B7.8), (A3 + B4.8 + B8.1), (A3 + B4.8 + B9.1), (A3 + B4.8 + B10.1),
(A3 + B4.9 + B4.10), (A3 + B4.9 + B4.11), (A3 + B4.9 + B4.12), (A3 + B4.9 + B4.13),
(A3 + B4.9 + B4.14), (A3 + B4.9 + B4.15), (A3 + B4.9 + B4.16), (A3 + B4.9 + B4.17),
(A3 + B4.9 + B4.18), (A3 + B4.9 + B4.19), (A3 + B4.9 + B5.1), (A3 + B4.9 + B5.2),
(A3 + B4.9 + B6.1), (A3 + B4.9 + B6.2), (A3 + B4.9 + B6.3), (A3 + B4.9 + B6.4),
(A3 + B4.9 + B7.1), (A3 + B4.9 + B7.2), (A3 + B4.9 + B7.3), (A3 + B4.9 + B7.4),
(A3 + B4.9 + B7.5), (A3 + B4.9 + B7.6), (A3 + B4.9 + B7.7), (A3 + B4.9 + B7.8),
(A3 + B4.9 + B8.1), (A3 + B4.9 + B9.1), (A3 + B4.9 + B10.1),
(A3 + B4.10 + B4.11), (A3 + B4.10 + B4.12), (A3 + B4.10 + B4.13), (A3 + B4.10 + B4.14),
(A3 + B4.10 + B4.15), (A3 + B4.10 + B4.16), (A3 + B4.10 + B4.17), (A3 + B4.10 + B4.18),
(A3 + B4.10 + B4.19), (A3 + B4.10 + B5.1), (A3 + B4.10 + B5.2), (A3 + B4.10 + B6.1),
(A3 + B4.10 + B6.2), (A3 + B4.10 + B6.3), (A3 + B4.10 + B6.4), (A3 + B4.10 + B7.1),
(A3 + B4.10 + B7.2), (A3 + B4.10 + B7.3), (A3 + B4.10 + B7.4), (A3 + B4.10 + B7.5),
(A3 + B4.10 + B7.6), (A3 + B4.10 + B7.7), (A3 + B4.10 + B7.8), (A3 + B4.10 + B8.1),
(A3 + B4.10 + B9.1), (A3 + B4.10 + B10.1),
(A3 + B4.11 + B4.12), (A3 + B4.11 + B4.13), (A3 + B4.11 + B4.14), (A3 + B4.11 + B4.15),
(A3 + B4.11 + B4.16), (A3 + B4.11 + B4.17), (A3 + B4.11 + B4.18), (A3 + B4.11 + B4.19),
(A3 + B4.11 + B5.1), (A3 + B4.11 + B5.2), (A3 + B4.11 + B6.1), (A3 + B4.11 + B6.2),
(A3 + B4.11 + B6.3), (A3 + B4.11 + B6.4), (A3 + B4.11 + B7.1), (A3 + B4.11 + B7.2),
(A3 + B4.11 + B7.3), (A3 + B4.11 + B7.4), (A3 + B4.11 + B7.5), (A3 + B4.11 + B7.6),
(A3 + B4.11 + B7.7), (A3 + B4.11 + B7.8), (A3 + B4.11 + B8.1), (A3 + B4.11 + B9.1),
(A3 + B4.11 + B10.1),
(A3 + B4.12 + B4.13), (A3 + B4.12 + B4.14), (A3 + B4.12 + B4.15), (A3 + B4.12 + B4.16),
(A3 + B4.12 + B4.17), (A3 + B4.12 + B4.18), (A3 + B4.12 + B4.19), (A3 + B4.12 + B5.1),
(A3 + B4.12 + B5.2), (A3 + B4.12 + B6.1), (A3 + B4.12 + B6.2), (A3 + B4.12 + B6.3),
(A3 + B4.12 + B6.4), (A3 + B4.12 + B7.1), (A3 + B4.12 + B7.2), (A3 + B4.12 + B7.3),
(A3 + B4.12 + B7.4), (A3 + B4.12 + B7.5), (A3 + B4.12 + B7.6), (A3 + B4.12 + B7.7),
(A3 + B4.12 + B7.8), (A3 + B4.12 + B8.1), (A3 + B4.12 + B9.1), (A3 + B4.12 + B10.1),
(A3 + B4.13 + B4.14), (A3 + B4.13 + B4.15), (A3 + B4.13 + B4.16), (A3 + B4.13 + B4.17),
(A3 + B4.13 + B4.18), (A3 + B4.13 + B4.19), (A3 + B4.13 + B5.1), (A3 + B4.13 + B5.2),
(A3 + B4.13 + B6.1), (A3 + B4.13 + B6.2), (A3 + B4.13 + B6.3), (A3 + B4.13 + B6.4),
(A3 + B4.13 + B7.1), (A3 + B4.13 + B7.2), (A3 + B4.13 + B7.3), (A3 + B4.13 + B7.4),
(A3 + B4.13 + B7.5), (A3 + B4.13 + B7.6), (A3 + B4.13 + B7.7), (A3 + B4.13 + B7.8),
(A3 + B4.13 + B8.1), (A3 + B4.13 + B9.1), (A3 + B4.13 + B10.1),
(A3 + B4.14 + B4.15), (A3 + B4.14 + B4.16), (A3 + B4.14 + B4.17), (A3 + B4.14 + B4.18),
(A3 + B4.14 + B4.19), (A3 + B4.14 + B5.1), (A3 + B4.14 + B5.2), (A3 + B4.14 + B6.1),
(A3 + B4.14 + B6.2), (A3 + B4.14 + B6.3), (A3 + B4.14 + B6.4), (A3 + B4.14 + B7.1),
(A3 + B4.14 + B7.2), (A3 + B4.14 + B7.3), (A3 + B4.14 + B7.4), (A3 + B4.14 + B7.5),
(A3 + B4.14 + B7.6), (A3 + B4.14 + B7.7), (A3 + B4.14 + B7.8), (A3 + B4.14 + B8.1),
(A3 + B4.14 + B9.1), (A3 + B4.14 + B10.1),
(A3 + B4.15 + B4.16), (A3 + B4.15 + B4.17), (A3 + B4.15 + B4.18), (A3 + B4.15 + B4.19),
(A3 + B4.15 + B5.1), (A3 + B4.15 + B5.2), (A3 + B4.15 + B6.1), (A3 + B4.15 + B6.2),
(A3 + B4.15 + B6.3), (A3 + B4.15 + B6.4), (A3 + B4.15 + B7.1), (A3 + B4.15 + B7.2),
(A3 + B4.15 + B7.3), (A3 + B4.15 + B7.4), (A3 + B4.15 + B7.5), (A3 + B4.15 + B7.6),
(A3 + B4.15 + B7.7), (A3 + B4.15 + B7.8), (A3 + B4.15 + B8.1), (A3 + B4.15 + B9.1),
(A3 + B4.15 + B10.1),
(A3 + B4.16 + B4.17), (A3 + B4.16 + B4.18), (A3 + B4.16 + B4.19), (A3 + B4.16 + B5.1),
(A3 + B4.16 + B5.2), (A3 + B4.16 + B6.1), (A3 + B4.16 + B6.2), (A3 + B4.16 + B6.3),
(A3 + B4.16 + B6.4), (A3 + B4.16 + B7.1), (A3 + B4.16 + B7.2), (A3 + B4.16 + B7.3),
(A3 + B4.16 + B7.4), (A3 + B4.16 + B7.5), (A3 + B4.16 + B7.6), (A3 + B4.16 + B7.7),
(A3 + B4.16 + B7.8), (A3 + B4.16 + B8.1), (A3 + B4.16 + B9.1), (A3 + B4.16 + B10.1),
(A3 + B4.17 + B4.18), (A3 + B4.17 + B4.19), (A3 + B4.17 + B5.1), (A3 + B4.17 + B5.2),
(A3 + B4.17 + B6.1), (A3 + B4.17 + B6.2), (A3 + B4.17 + B6.3), (A3 + B4.17 + B6.4),
(A3 + B4.17 + B7.1), (A3 + B4.17 + B7.2), (A3 + B4.17 + B7.3), (A3 + B4.17 + B7.4),
(A3 + B4.17 + B7.5), (A3 + B4.17 + B7.6), (A3 + B4.17 + B7.7), (A3 + B4.17 + B7.8),
(A3 + B4.17 + B8.1), (A3 + B4.17 + B9.1), (A3 + B4.17 + B10.1),
(A3 + B4.18 + B4.19), (A3 + B4.18 + B5.1), (A3 + B4.18 + B5.2), (A3 + B4.18 + B6.1),
(A3 + B4.18 + B6.2), (A3 + B4.18 + B6.3), (A3 + B4.18 + B6.4), (A3 + B4.18 + B7.1),
(A3 + B4.18 + B7.2), (A3 + B4.18 + B7.3), (A3 + B4.18 + B7.4), (A3 + B4.18 + B7.5),
(A3 + B4.18 + B7.6), (A3 + B4.18 + B7.7), (A3 + B4.18 + B7.8), (A3 + B4.18 + B8.1),
(A3 + B4.18 + B9.1), (A3 + B4.18 + B10.1),
(A3 + B4.19 + B5.1), (A3 + B4.19 + B5.2), (A3 + B4.19 + B6.1), (A3 + B4.19 + B6.2),
(A3 + B4.19 + B6.3), (A3 + B4.19 + B6.4), (A3 + B4.19 + B7.1), (A3 + B4.19 + B7.2),
(A3 + B4.19 + B7.3), (A3 + B4.19 + B7.4), (A3 + B4.19 + B7.5), (A3 + B4.19 + B7.6),
(A3 + B4.19 + B7.7), (A3 + B4.19 + B7.8), (A3 + B4.19 + B8.1), (A3 + B4.19 + B9.1),
(A3 + B4.19 + B10.1),
(A3 + B5.1 + B5.2), (A3 + B5.1 + B6.1), (A3 + B5.1 + B6.2), (A3 + B5.1 + B6.3),
(A3 + B5.1 + B6.4), (A3 + B5.1 + B7.1), (A3 + B5.1 + B7.2), (A3 + B5.1 + B7.3),
(A3 + B5.1 + B7.4), (A3 + B5.1 + B7.5), (A3 + B5.1 + B7.6), (A3 + B5.1 + B7.7),
(A3 + B5.1 + B7.8), (A3 + B5.1 + B8.1), (A3 + B5.1 + B9.1), (A3 + B5.1 + B10.1),
(A3 + B5.2 + B6.1), (A3 + B5.2 + B6.2), (A3 + B5.2 + B6.3), (A3 + B5.2 + B6.4),
(A3 + B5.2 + B7.1), (A3 + B5.2 + B7.2), (A3 + B5.2 + B7.3), (A3 + B5.2 + B7.4),
(A3 + B5.2 + B7.5), (A3 + B5.2 + B7.6), (A3 + B5.2 + B7.7), (A3 + B5.2 + B7.8),
(A3 + B5.2 + B8.1), (A3 + B5.2 + B9.1), (A3 + B5.2 + B10.1),
(A3 + B6.1 + B6.2), (A3 + B6.1 + B6.3), (A3 + B6.1 + B6.4), (A3 + B6.1 + B7.1),
(A3 + B6.1 + B7.2), (A3 + B6.1 + B7.3), (A3 + B6.1 + B7.4), (A3 + B6.1 + B7.5),
(A3 + B6.1 + B7.6), (A3 + B6.1 + B7.7), (A3 + B6.1 + B7.8), (A3 + B6.1 + B8.1),
(A3 + B6.1 + B9.1), (A3 + B6.1 + B10.1),
(A3 + B6.2 + B6.3), (A3 + B6.2 + B6.4), (A3 + B6.2 + B7.1), (A3 + B6.2 + B7.2),
(A3 + B6.2 + B7.3), (A3 + B6.2 + B7.4), (A3 + B6.2 + B7.5), (A3 + B6.2 + B7.6),
(A3 + B6.2 + B7.7), (A3 + B6.2 + B7.8), (A3 + B6.2 + B8.1), (A3 + B6.2 + B9.1),
(A3 + B6.2 + B10.1),
(A3 + B6.3 + B6.4), (A3 + B6.3 + B7.1), (A3 + B6.3 + B7.2), (A3 + B6.3 + B7.3),
(A3 + B6.3 + B7.4), (A3 + B6.3 + B7.5), (A3 + B6.3 + B7.6), (A3 + B6.3 + B7.7),
(A3 + B6.3 + B7.8), (A3 + B6.3 + B8.1), (A3 + B6.3 + B9.1), (A3 + B6.3 + B10.1),
(A3 + B6.4 + B7.1), (A3 + B6.4 + B7.2), (A3 + B6.4 + B7.3), (A3 + B6.4 + B7.4),
(A3 + B6.4 + B7.5), (A3 + B6.4 + B7.6), (A3 + B6.4 + B7.7), (A3 + B6.4 + B7.8),
(A3 + B6.4 + B8.1), (A3 + B6.4 + B9.1), (A3 + B6.4 + B10.1),
(A3 + B7.1 + B7.2), (A3 + B7.1 + B7.3), (A3 + B7.1 + B7.4), (A3 + B7.1 + B7.5),
(A3 + B7.1 + B7.6), (A3 + B7.1 + B7.7), (A3 + B7.1 + B7.8), (A3 + B7.1 + B8.1),
(A3 + B7.1 + B9.1), (A3 + B7.1 + B10.1),
(A3 + B7.2 + B7.3), (A3 + B7.2 + B7.4), (A3 + B7.2 + B7.5), (A3 + B7.2 + B7.6),
(A3 + B7.2 + B7.7), (A3 + B7.2 + B7.8), (A3 + B7.2 + B8.1), (A3 + B7.2 + B9.1),
(A3 + B7.2 + B10.1),
(A3 + B7.3 + B7.4), (A3 + B7.3 + B7.5), (A3 + B7.3 + B7.6), (A3 + B7.3 + B7.7),
(A3 + B7.3 + B7.8), (A3 + B7.3 + B8.1), (A3 + B7.3 + B9.1), (A3 + B7.3 + B10.1),
(A3 + B7.4 + B7.5), (A3 + B7.4 + B7.6), (A3 + B7.4 + B7.7), (A3 + B7.4 + B7.8),
(A3 + B7.4 + B8.1), (A3 + B7.4 + B9.1), (A3 + B7.4 + B10.1),
(A3 + B7.5 + B7.6), (A3 + B7.5 + B7.7), (A3 + B7.5 + B7.8), (A3 + B7.5 + B8.1),
(A3 + B7.5 + B9.1), (A3 + B7.5 + B10.1),
(A3 + B7.6 + B7.7), (A3 + B7.6 + B7.8), (A3 + B7.6 + B8.1), ), (A3 + B7.6 + B9.1),
(A3 + B7.6 + B10.1),
(A3 + B7.7 + B7.8), (A3 + B7.7 + B8.1), (A3 + B7.7 + B9.1), (A3 + B7.7 + B10.1),
(A3 + B7.8 + B8.1), (A3 + B7.8 + B9.1), (A3 + B7.8 + B10.1),
(A3 + B8.1. + B9.1), (A3 + B8.1 + B10.1),
(A3 + B9.1. + B10.1).

For the herbicidal compositions according to the invention, the application rates required are generally in the range from 1 to 1000 g, preferably from 1 to 500 g, particularly preferably. from 5 to 250 g, of component A and from 1 to 2000 g, preferably from 1 to 1000 g, particularly preferably from 5 to 500g, of component B. The person skilled in the art can find the application rate of component B in the known recommendations of the manufacturers on the packaging units.

The weight ratios of components A to B can be varied within wide limits and depend, inter alia, on the herbicide used, the harmful plants to be controlled and the crop of useful plants in which the composition according to the invention is to be employed. The ratio of components A to B is preferably in the range from 1:100 to 100: 1, particularly preferably in the range from 1:50 to 50:1, especially in the range from 1:20 to 20:1. Optimum weight ratios may depend on the particular field of application, on the weed spectrum and on the active compound combination used and can be determined in preliminary experiments.

The safeners used according to the invention are also highly suitable for pretreating the seed of crop plants (seed dressing). It is also possible to introduce the safeners before sowing into the seed furrows or to apply them together with the herbicide before or after emergence of the plants. Pre-emergence treatment embraces both the treatment of the area under cultivation prior to sowing, and also the treatment of the sown soil which does not yet sustain vegetation. Preferred in addition to seed treatment is the application together with the herbicide. Tank mixes or ready mixes may be employed for this purpose.

In a particular embodiment, the seed of the crop plant is dressed with a safener A and one or more fungicides and/or insecticides of a group C comprising the compounds N-[2-(1,3-dimethylbutyl)phenyl]-5-fluoro-1,3-dimethyl-1H-pyrazole4-carboxamide (C1), carbendazim (C2), fluoxastrobin (C3), fluquinconazole (C4), iprodione (C5), prothioconazole (C6), tebuconazole (C7), triadimenol (C8), trifloxystrobin (C9), triticonazole (C10), fludioxinil (C11), metalaxyl (C12), mefenoxam (C13), captan (C14), TMTD (C15), beta-cyfluthrin (C16), clothianidin (C17), ethiprole (C18), fipronil (C19), imidacloprid (C20), methiocarb (C21), thiodicarb (C22), thiamethoxam (C23), azoxystrobin (C24) and ipconazole (C25). The additional dressing of the seed with fungicides and/or insecticides protects. both the seed during storage and, later, the germinating plant in the first growth phase against attack by fungi and insects. Treatment with the herbicide B is then carried out after sowing of the dressed seed, by the pre- or post-emergence method.

N-[2-(1,3-Dimethylbutyl)phenyl]-5-fluoro-1,3-dimethyl-1H-pyrazole4-carboxamide is known, for example, from WO 03/010149 and WO 04/005242. The chemical structures of the other fungicides and insecticides referred to above by their common names are known, for example, from “The Pesticide Manual” 13th edition, 2003, British Crop Protection Council, and from the Website http://www.hclrss.demon.co.uk.

For dressing the seed and for later application with a herbicide, the combinations according to the invention, mentioned in Table 5, of safener A, herbicide B and fungicide C or insecticide C are particularly suitable.

TABLE 5
(A1 + B1.1 + C1), (A1 + B1.2 + C1), (A1 + B1.3 + C1), (A1 + B1.4 + C1), (A1 + B1.5 + C1),
(A1 + B1.6 + C1), (A1 + B1.7 + C1), (A1 + B1.8 + C1), (A1 + B1.9 + C1), (A1 + B1.10 + C1),
(A1 + B2.1 + C1), (A1 + B2.2 + C1), (A1 + B2.3 + C1), (A1 + B2.4 + C1), (A1 + B5.1 + C1),
(A1 + B5.2 + C1), (A1 + B7.1 + C1), (A1 + B8.1 + C1), (A1 + B9.1 + C1), (A1 + B10.1 + C1),
(A2 + B1.1 + C1), (A2 + B1.2 + C1), (A2 + B1.3 + C1), (A2 + B1.4 + C1), (A2 + B1.5 + C1),
(A2 + B1.6 + C1), (A2 + B1.7 + C1), (A2 + B1.8 + C1), (A2 + B1.9 + C1), (A2 + B1.10 + C1),
(A2 + B2.1 + C1), (A2 + B2.2 + C1), (A2 + B2.3 + C1), (A2 + B2.4 + C1), (A2 + B5.1 + C1),
(A2 + B5.2 + C1), (A2 + B7.1 + C1), (A2 + B8.1 + C1), (A2 + B9.1 + C1), (A2 + B10.1 + C1),
(A3 + B1.1 + C1), (A3 + B1.2 + C1), (A3 + B1.3 + C1), (A3 + B1.4 + C1), (A3 + B1.5 + C1),
(A3 + B1.6 + C1), (A3 + B1.7 + C1), (A3 + B1.8 + C1), (A3 + B1.9 + C1), (A3 + B1.10 + C1),
(A3 + B2.1 + C1), (A3 + B2.2 + C1), (A3 + B2.3 + C1), (A3 + B2.4 + C1), (A3 + B5.1 + C1),
(A3 + B5.2 + C1), (A3 + B7.1 + C1), (A3 + B8.1 + C1), (A3 + B9.1 + C1), (A3 + B10.1 + C1),
(A4 + B1.1 + C1), (A4 + B1.2 + C1), (A4 + B1.3 + C1), (A4 + B1.4 + C1), (A4 + B1.5 + C1),
(A4 + B1.6 + C1), (A4 + B1.7 + C1), (A4 + B1.8 + C1), (A4 + B1.9 + C1), (A4 + B1.10 + C1),
(A4 + B2.1 + C1), (A4 + B2.2 + C1), (A4 + B2.3 + C1), (A4 + B2.4 + C1), (A4 + B5.1 + C1),
(A4 + B5.2 + C1), (A4 + B7.1 + C1), (A4 + B8.1 + C1), (A4 + B9.1 + C1), (A4 + B10.1 + C1),
(A1 + B1.1 + C2), (A1 + B1.2 + C2), (A1 + B1.3 + C2), (A1 + B1.4 + C2), (A1 + B1.5 + C2),
(A1 + B1.6 + C2), (A1 + B1.7 + C2), (A1 + B1.8 + C2), (A1 + B1.9 + C2), (A1 + B1.10 + C2),
(A1 + B2.1 + C2), (A1 + B2.2 + C2), (A1 + B2.3 + C2), (A1 + B2.4 + C2), (A1 + B5.1 + C2),
(A1 + B5.2 + C2), (A1 + B7.1 + C2), (A1 + B8.1 + C2), (A1 + B9.1 + C2), (A1 + B10.1 + C2),
(A2 + B1.1 + C2), (A2 + B1.2 + C2), (A2 + B1.3 + C2), (A2 + B1.4 + C2), (A2 + B1.5 + C2),
(A2 + B1.6 + C2), (A2 + B1.7 + C2), (A2 + B1.8 + C2), (A2 + B1.9 + C2), (A2 + B1.10 + C2),
(A2 + B2.1 + C2), (A2 + B2.2 + C2), (A2 + B2.3 + C2), (A2 + B2.4 + C2), (A2 + B5.1 + C2),
(A2 + B5.2 + C2), (A2 + B7.1 + C2), (A2 + B8.1 + C2), (A2 + B9.1 + C2), (A2 + B10.1 + C2),
(A3 + B1.1 + C2), (A3 + B1.2 + C2), (A3 + B1.3 + C2), (A3 + B1.4 + C2), (A3 + B1.5 + C2),
(A3 + B1.6 + C2), (A3 + B1.7 + C2), (A3 + B1.8 + C2), (A3 + B1.9 + C2), (A3 + B1.10 + C2),
(A3 + B2.1 + C2), (A3 + B2.2 + C2), (A3 + B2.3 + C2), (A3 + B2.4 + C2), (A3 + B5.1 + C2),
(A3 + B5.2 + C2), (A3 + B7.1 + C2), (A3 + B8.1 + C2), (A3 + B9.1 + C2), (A3 + B10.1 + C2),
(A4 + B1.1 + C2), (A4 + B1.2 + C2), (A4 + B1.3 + C2), (A4 + B1.4 + C2), (A4 + B1.5 + C2),
(A4 + B1.6 + C2), (A4 + B1.7 + C2), (A4 + B1.8 + C2), (A4 + B1.9 + C2), (A4 + B1.10 + C2),
(A4 + B2.1 + C2), (A4 + B2.2 + C2), (A4 + B2.3 + C2), (A4 + B2.4 + C2), (A4 + B5.1 + C2),
(A4 + B5.2 + C2), (A4 + B7.1 + C2), (A4 + B8.1 + C2), (A4 + B9.1 + C2), (A4 + B10.1 + C2),
(A1 + B1.1 + C3), (A1 + B1.2 + C3), (A1 + B1.3 + C3), (A1 + B1.4 + C3), (A1 + B1.5 + C3),
(A1 + B1.6 + C3), (A1 + B1.7 + C3), (A1 + B1.8 + C3), (A1 + B1.9 + C3), (A1 + B1.10 + C3),
(A1 + B2.1 + C3), (A1 + B2.2 + C3), (A1 + B2.3 + C3), (A1 + B2.4 + C3), (A1 + B5.1 + C3),
(A1 + B5.2 + C3), (A1 + B7.1 + C3), (A1 + B8.1 + C3), (A1 + B9.1 + C3), (A1 + B10.1 + C3),
(A2 + B1.1 + C3), (A2 + B1.2 + C3), (A2 + B1.3 + C3), (A2 + B1.4 + C3), (A2 + B1.5 + C3),
(A2 + B1.6 + C3), (A2 + B1.7 + C3), (A2 + B1.8 + C3), (A2 + B1.9 + C3), (A2 + B1.10 + C3),
(A2 + B2.1 + C3), (A2 + B2.2 + C3), (A2 + B2.3 + C3), (A2 + B2.4 + C3), (A2 + B5.1 + C3),
(A2 + B5.2 + C3), (A2 + B7.1 + C3), (A2 + B8.1 + C3), (A2 + B9.1 + C3), (A2 + B10.1 + C3),
(A3 + B1.1 + C3), (A3 + B1.2 + C3), (A3 + B1.3 + C3), (A3 + B1.4 + C3), (A3 + B1.5 + C3),
(A3 + B1.6 + C3), (A3 + B1.7 + C3), (A3 + B1.8 + C3), (A3 + B1.9 + C3), (A3 + B1.10 + C3),
(A3 + B2.1 + C3), (A3 + B2.2 + C3), (A3 + B2.3 + C3), (A3 + B2.4 + C3), (A3 + B5.1 + C3),
(A3 + B5.2 + C3), (A3 + B7.1 + C3), (A3 + B8.1 + C3), (A3 + B9.1 + C3), (A3 + B10.1 + C3),
(A4 + B1.1 + C3), (A4 + B1.2 + C3), (A4 + B1.3 + C3), (A4 + B1.4 + C3), (A4 + B1.5 + C3),
(A4 + B1.6 + C3), (A4 + B1.7 + C3), (A4 + B1.8 + C3), (A4 + B1.9 + C3), (A4 + B1.10 + C3),
(A4 + B2.1 + C3), (A4 + B2.2 + C3), (A4 + B2.3 + C3), (A4 + B2.4 + C3), (A4 + B5.1 + C3),
(A4 + B5.2 + C3), (A4 + B7.1 + C3), (A4 + B8.1 + C3), (A4 + B9.1 + C3), (A4 + B10.1 + C3),
(A1 + B1.1 + C4), (A1 + B1.2 + C4), (A1 + B1.3 + C4), (A1 + B1.4 + C4), (A1 + B1.5 + C4),
(A1 + B1.6 + C4), (A1 + B1.7 + C4), (A1 + B1.8 + C4), (A1 + B1.9 + C4), (A1 + B1.10 + C4),
(A1 + B2.1 + C4), (A1 + B2.2 + C4), (A1 + B2.3 + C4), (A1 + B2.4 + C4), (A1 + B5.1 + C4),
(A1 + B5.2 + C4), (A1 + B7.1 + C4), (A1 + B8.1 + C4), (A1 + B9.1 + C4), (A1 + B10.1 + C4),
(A2 + B1.1 + C4), (A2 + B1.2 + C4), (A2 + B1.3 + C4), (A2 + B1.4 + C4), (A2 + B1.5 + C4),
(A2 + B1.6 + C4), (A2 + B1.7 + C4), (A2 + B1.8 + C4), (A2 + B1.9 + C4), (A2 + B1.10 + C4),
(A2 + B2.1 + C4), (A2 + B2.2 + C4), (A2 + B2.3 + C4), (A2 + B2.4 + C4), (A2 + B5.1 + C4),
(A2 + B5.2 + C4), (A2 + B7.1 + C4), (A2 + B8.1 + C4), (A2 + B9.1 + C4), (A2 + B10.1 + C4),
(A3 + B1.1 + C4), (A3 + B1.2 + C4), (A3 + B1.3 + C4), (A3 + B1.4 + C4), (A3 + B1.5 + C4),
(A3 + B1.6 + C4), (A3 + B1.7 + C4), (A3 + B1.8 + C4), (A3 + B1.9 + C4), (A3 + B1.10 + C4),
(A3 + B2.1 + C4), (A3 + B2.2 + C4), (A3 + B2.3 + C4), (A3 + B2.4 + C4), (A3 + B5.1 + C4),
(A3 + B5.2 + C4), (A3 + B7.1 + C4), (A3 + B8.1 + C4), (A3 + B9.1 + C4), (A3 + B10.1 + C4),
(A4 + B1.1 + C4), (A4 + B1.2 + C4), (A4 + B1.3 + C4), (A4 + B1.4 + C4), (A4 + B1.5 + C4),
(A4 + B1.6 + C4), (A4 + B1.7 + C4), (A4 + B1.8 + C4), (A4 + B1.9 + C4), (A4 + B1.10 + C4),
(A4 + B2.1 + C4), (A4 + B2.2 + C4), (A4 + B2.3 + C4), (A4 + B2.4 + C4), (A4 + B5.1 + C4),
(A4 + B5.2 + C4), (A4 + B7.1 + C4), (A4 + B8.1 + C4), (A4 + B9.1 + C4), (A4 + B10.1 + C4),
(A1 + B1.1 + C5), (A1 + B1.2 + C5), (A1 + B1.3 + C5), (A1 + B1.4 + C5), (A1 + B1.5 + C5),
(A1 + B1.6 + C5), (A1 + B1.7 + C5), (A1 + B1.8 + C5), (A1 + B1.9 + C5), (A1 + B1.10 + C5),
(A1 + B2.1 + C5), (A1 + B2.2 + C5), (A1 + B2.3 + C5), (A1 + B2.4 + C5), (A1 + B5.1 + C5),
(A1 + B5.2 + C5), (A1 + B7.1 + C5), (A1 + B8.1 + C5), (A1 + B9.1 + C5), (A1 + B10.1 + C5),
(A2 + B1.1 + C5), (A2 + B1.2 + C5), (A2 + B1.3 + C5), (A2 + B1.4 + C5), (A2 + B1.5 + C5),
(A2 + B1.6 + C5), (A2 + B1.7 + C5), (A2 + B1.8 + C5), (A2 + B1.9 + C5), (A2 + B1.10 + C5),
(A2 + B2.1 + C5), (A2 + B2.2 + C5), (A2 + B2.3 + C5), (A2 + B2.4 + C5), (A2 + B5.1 + C5),
(A2 + B5.2 + C5), (A2 + B7.1 + C5), (A2 + B8.1 + C5), (A2 + B9.1 + C5), (A2 + B10.1 + C5),
(A3 + B1.1 + C5), (A3 + B1.2 + C5), (A3 + B1.3 + C5), (A3 + B1.4 + C5), (A3 + B1.5 + C5),
(A3 + B1.6 + C5), (A3 + B1.7 + C5), (A3 + B1.8 + C5), (A3 + B1.9 + C5), (A3 + B1.10 + C5),
(A3 + B2.1 + C5), (A3 + B2.2 + C5), (A3 + B2.3 + C5), (A3 + B2.4 + C5), (A3 + B5.1 + C5),
(A3 + B5.2 + C5), (A3 + B7.1 + C5), (A3 + B8.1 + C5), (A3 + B9.1 + C5), (A3 + B10.1 + C5),
(A4 + B1.1 + C5), (A4 + B1.2 + C5), (A4 + B1.3 + C5), (A4 + B1.4 + C5), (A4 + B1.5 + C5),
(A4 + B1.6 + C5), (A4 + B1.7 + C5), (A4 + B1.8 + C5), (A4 + B1.9 + C5), (A4 + B1.10 + C5),
(A4 + B2.1 + C5), (A4 + B2.2 + C5), (A4 + B2.3 + C5), (A4 + B2.4 + C5), (A4 + B5.1 + C5),
(A4 + B5.2 + C5), (A4 + B7.1 + C5), (A4 + B8.1 + C5), (A4 + B9.1 + C5), (A4 + B10.1 + C5),
(A1 + B1.1 + C6), (A1 + B1.2 + C6), (A1 + B1.3 + C6), (A1 + B1.4 + C6), (A1 + B1.5 + C6),
(A1 + B1.6 + C6), (A1 + B1.7 + C6), (A1 + B1.8 + C6), (A1 + B1.9 + C6), (A1 + B1.10 + C6),
(A1 + B2.1 + C6), (A1 + B2.2 + C6), (A1 + B2.3 + C6), (A1 + B2.4 + C6), (A1 + B5.1 + C6),
(A1 + B5.2 + C6), (A1 + B7.1 + C6), (A1 + B8.1 + C6), (A1 + B9.1 + C6), (A1 + B10.1 + C6),
(A2 + B1.1 + C6), (A2 + B1.2 + C6), (A2 + B1.3 + C6), (A2 + B1.4 + C6), (A2 + B1.5 + C6),
(A2 + B1.6 + C6), (A2 + B1.7 + C6), (A2 + B1.8 + C6), (A2 + B1.9 + C6), (A2 + B1.10 + C6),
(A2 + B2.1 + C6), (A2 + B2.2 + C6), (A2 + B2.3 + C6), (A2 + B2.4 + C6), (A2 + B5.1 + C6),
(A2 + B5.2 + C6), (A2 + B7.1 + C6), (A2 + B8.1 + C6), (A2 + B9.1 + C6), (A2 + B10.1 + C6),
(A3 + B1.1 + C6), (A3 + B1.2 + C6), (A3 + B1.3 + C6), (A3 + B1.4 + C6), (A3 + B1.5 + C6),
(A3 + B1.6 + C6), (A3 + B1.7 + C6), (A3 + B1.8 + C6), (A3 + B1.9 + C6), (A3 + B1.10 + C6),
(A3 + B2.1 + C6), (A3 + B2.2 + C6), (A3 + B2.3 + C6), (A3 + B2.4 + C6), (A3 + B5.1 + C6),
(A3 + B5.2 + C6), (A3 + B7.1 + C6), (A3 + B8.1 + C6), (A3 + B9.1 + C6), (A3 + B10.1 + C6),
(A4 + B1.1 + C6), (A4 + B1.2 + C6), (A4 + B1.3 + C6), (A4 + B1.4 + C6), (A4 + B1.5 + C6),
(A4 + B1.6 + C6), (A4 + B1.7 + C6), (A4 + B1.8 + C6), (A4 + B1.9 + C6), (A4 + B1.10 + C6),
(A4 + B2.1 + C6), (A4 + B2.2 + C6), (A4 + B2.3 + C6), (A4 + B2.4 + C6), (A4 + B5.1 + C6),
(A4 + B5.2 + C6), (A4 + B7.1 + C6), (A4 + B8.1 + C6), (A4 + B9.1 + C6), (A4 + B10.1 + C6),
(A1 + B1.1 + C7), (A1 + B1.2 + C7), (A1 + B1.3 + C7), (A1 + B1.4 + C7), (A1 + B1.5 + C7),
(A1 + B1.6 + C7), (A1 + B1.7 + C7), (A1 + B1.8 + C7), (A1 + B1.9 + C7), (A1 + B1.10 + C7),
(A1 + B2.1 + C7), (A1 + B2.2 + C7), (A1 + B2.3 + C7), (A1 + B2.4 + C7), (A1 + B5.1 + C7),
(A1 + B5.2 + C7), (A1 + B7.1 + C7), (A1 + B8.1 + C7), (A1 + B9.1 + C7), (A1 + B10.1 + C7),
(A2 + B1.1 + C7), (A2 + B1.2 + C7), (A2 + B1.3 + C7), (A2 + B1.4 + C7), (A2 + B1.5 + C7),
(A2 + B1.6 + C7), (A2 + B1.7 + C7), (A2 + B1.8 + C7), (A2 + B1.9 + C7), (A2 + B1.10 + C7),
(A2 + B2.1 + C7), (A2 + B2.2 + C7), (A2 + B2.3 + C7), (A2 + B2.4 + C7), (A2 + B5.1 + C7),
(A2 + B5.2 + C7), (A2 + B7.1 + C7), (A2 + B8.1 + C7), (A2 + B9.1 + C7), (A2 + B10.1 + C7),
(A3 + B1.1 + C7), (A3 + B1.2 + C7), (A3 + B1.3 + C7), (A3 + B1.4 + C7), (A3 + B1.5 + C7),
(A3 + B1.6 + C7), (A3 + B1.7 + C7), (A3 + B1.8 + C7), (A3 + B1.9 + C7), (A3 + B1.10 + C7),
(A3 + B2.1 + C7), (A3 + B2.2 + C7), (A3 + B2.3 + C7), (A3 + B2.4 + C7), (A3 + B5.1 + C7),
(A3 + B5.2 + C7), (A3 + B7.1 + C7), (A3 + B8.1 + C7), (A3 + B9.1 + C7), (A3 + B10.1 + C7),
(A4 + B1.1 + C7), (A4 + B1.2 + C7), (A4 + B1.3 + C7), (A4 + B1.4 + C7), (A4 + B1.5 + C7),
(A4 + B1.6 + C7), (A4 + B1.7 + C7), (A4 + B1.8 + C7), (A4 + B1.9 + C7), (A4 + B1.10 + C7),
(A4 + B2.1 + C7), (A4 + B2.2 + C7), (A4 + B2.3 + C7), (A4 + B2.4 + C7), (A4 + B5.1 + C7),
(A4 + B5.2 + C7), (A4 + B7.1 + C7), (A4 + B8.1 + C7), (A4 + B9.1 + C7), (A4 + B10.1 + C7),
(A1 + B1.1 + C8), (A1 + B1.2 + C8), (A1 + B1.3 + C8), (A1 + B1.4 + C8), (A1 + B1.5 + C8),
(A1 + B1.6 + C8), (A1 + B1.7 + C8), (A1 + B1.8 + C8), (A1 + B1.9 + C8), (A1 + B1.10 + C8),
(A1 + B2.1 + C8), (A1 + B2.2 + C8), (A1 + B2.3 + C8), (A1 + B2.4 + C8), (A1 + B5.1 + C8),
(A1 + B5.2 + C8), (A1 + B7.1 + C8), (A1 + B8.1 + C8), (A1 + B9.1 + C8), (A1 + B10.1 + C8),
(A2 + B1.1 + C8), (A2 + B1.2 + C8), (A2 + B1.3 + C8), (A2 + B1.4 + C8), (A2 + B1.5 + C8),
(A2 + B1.6 + C8), (A2 + B1.7 + C8), (A2 + B1.8 + C8), (A2 + B1.9 + C8), (A2 + B1.10 + C8),
(A2 + B2.1 + C8), (A2 + B2.2 + C8), (A2 + B2.3 + C8), (A2 + B2.4 + C8), (A2 + B5.1 + C8),
(A2 + B5.2 + C8), (A2 + B7.1 + C8), (A2 + B8.1 + C8), (A2 + B9.1 + C8), (A2 + B10.1 + C8),
(A3 + B1.1 + C8), (A3 + B1.2 + C8), (A3 + B1.3 + C8), (A3 + B1.4 + C8), (A3 + B1.5 + C8),
(A3 + B1.6 + C8), (A3 + B1.7 + C8), (A3 + B1.8 + C8), (A3 + B1.9 + C8), (A3 + B1.10 + C8),
(A3 + B2.1 + C8), (A3 + B2.2 + C8), (A3 + B2.3 + C8), (A3 + B2.4 + C8), (A3 + B5.1 + C8),
(A3 + B5.2 + C8), (A3 + B7.1 + C8), (A3 + B8.1 + C8), (A3 + B9.1 + C8), (A3 + B10.1 + C8),
(A4 + B1.1 + C8), (A4 + B1.2 + C8), (A4 + B1.3 + C8), (A4 + B1.4 + C8), (A4 + B1.5 + C8),
(A4 + B1.6 + C8), (A4 + B1.7 + C8), (A4 + B1.8 + C8), (A4 + B1.9 + C8), (A4 + B1.10 + C8),
(A4 + B2.1 + C8), (A4 + B2.2 + C8), (A4 + B2.3 + C8), (A4 + B2.4 + C8), (A4 + B5.1 + C8),
(A4 + B5.2 + C8), (A4 + B7.1 + C8), (A4 + B8.1 + C8), (A4 + B9.1 + C8), (A4 + B10.1 + C8),
(A1 + B1.1 + C9), (A1 + B1.2 + C9), (A1 + B1.3 + C9), (A1 + B1.4 + C9), (A1 + B1.5 + C9),
(A1 + B1.6 + C9), (A1 + B1.7 + C9), (A1 + B1.8 + C9), (A1 + B1.9 + C9), (A1 + B1.10 + C9),
(A1 + B2.1 + C9), (A1 + B2.2 + C9), (A1 + B2.3 + C9), (A1 + B2.4 + C9), (A1 + B5.1 + C9),
(A1 + B5.2 + C9), (A1 + B7.1 + C9), (A1 + B8.1 + C9), (A1 + B9.1 + C9), (A1 + B10.1 + C9),
(A2 + B1.1 + C9), (A2 + B1.2 + C9), (A2 + B1.3 + C9), (A2 + B1.4 + C9), (A2 + B1.5 + C9),
(A2 + B1.6 + C9), (A2 + B1.7 + C9), (A2 + B1.8 + C9), (A2 + B1.9 + C9), (A2 + B1.10 + C9),
(A2 + B2.1 + C9), (A2 + B2.2 + C9), (A2 + B2.3 + C9), (A2 + B2.4 + C9), (A2 + B5.1 + C9),
(A2 + B5.2 + C9), (A2 + B7.1 + C9), (A2 + B8.1 + C9), (A2 + B9.1 + C9), (A2 + B10.1 + C9),
(A3 + B1.1 + C9), (A3 + B1.2 + C9), (A3 + B1.3 + C9), (A3 + B1.4 + C9), (A3 + B1.5 + C9),
(A3 + B1.6 + C9), (A3 + B1.7 + C9), (A3 + B1.8 + C9), (A3 + B1.9 + C9), (A3 + B1.10 + C9),
(A3 + B2.1 + C9), (A3 + B2.2 + C9), (A3 + B2.3 + C9), (A3 + B2.4 + C9), (A3 + B5.1 + C9),
(A3 + B5.2 + C9), (A3 + B7.1 + C9), (A3 + B8.1 + C9), (A3 + B9.1 + C9), (A3 + B10.1 + C9),
(A4 + B1.1 + C9), (A4 + B1.2 + C9), (A4 + B1.3 + C9), (A4 + B1.4 + C9), (A4 + B1.5 + C9),
(A4 + B1.6 + C9), (A4 + B1.7 + C9), (A4 + B1.8 + C9), (A4 + B1.9 + C9), (A4 + B1.10 + C9),
(A4 + B2.1 + C9), (A4 + B2.2 + C9), (A4 + B2.3 + C9), (A4 + B2.4 + C9), (A4 + B5.1 + C9),
(A4 + B5.2 + C9), (A4 + B7.1 + C9), (A4 + B8.1 + C9), (A4 + B9.1 + C9), (A4 + B10.1 + C9),
(A1 + B1.1 + C10), (A1 + B1.2 + C10), (A1 + B1.3 + C10), (A1 + B1.4 + C10), (A1 + B1.5 + C10),
(A1 + B1.6 + C10), (A1 + B1.7 + C10), (A1 + B1.8 + C10), (A1 + B1.9 + C10),
(A1 + B1.10 + C10),
(A1 + B2.1 + C10), (A1 + B2.2 + C10), (A1 + B2.3 + C10), (A1 + B2.4 + C10), (A1 + B5.1 + C10),
(A1 + B5.2 + C10), (A1 + B7.1 + C10), (A1 + B8.1 + C10), (A1 + B9.1 + C10),
(A1 + B10.1 + C10), (A2 + B1.1 + C10), (A2 + B1.2 + C10), (A2 + B1.3 + C10),
(A2 + B1.4 + C10), (A2 + B1.5 + C10), (A2 + B1.6 + C10), (A2 + B1.7 + C10), (A2 + B1.8 + C10),
(A2 + B1.9 + C10), (A2 + B1.10 + C10), (A2 + B2.1 + C10), (A2 + B2.2 + C10),
(A2 + B2.3 + C10), (A2 + B2.4 + C10), (A2 + B5.1 + C10), (A2 + B5.2 + C10), (A2 + B7.1 + C10),
(A2 + B8.1 + C10), (A2 + B9.1 + C10), (A2 + B10.1 + C10), (A3 + B1.1 + C10),
(A3 + B1.2 + C10), (A3 + B1.3 + C10), (A3 + B1.4 + C10), (A3 + B1.5 + C10), (A3 + B1.6 + C10),
(A3 + B1.7 + C10), (A3 + B1.8 + C10), (A3 + B1.9 + C10), (A3 + B1.10 + C10),
(A3 + B2.1 + C10), (A3 + B2.2 + C10), (A3 + B2.3 + C10), (A3 + B2.4 + C10), (A3 + B5.1 + C10),
(A3 + B5.2 + C10), (A3 + B7.1 + C10), (A3 + B8.1 + C10), (A3 + B9.1 + C10),
(A3 + B10.1 + C10), (A4 + B1.1 + C10), (A4 + B1.2 + C10), (A4 + B1.3 + C10),
(A4 + B1.4 + C10), (A4 + B1.5 + C10), (A4 + B1.6 + C10), (A4 + B1.7 + C10), (A4 + B1.8 + C10),
(A4 + B1.9 + C10), (A4 + B1.10 + C10), (A4 + B2.1 + C10), (A4 + B2.2 + C10),
(A4 + B2.3 + C10), (A4 + B2.4 + C10), (A4 + B5.1 + C10), (A4 + B5.2 + C10), (A4 + B7.1 + C10),
(A4 + B8.1 + C10), (A4 + B9.1 + C10), (A3 + B10.1 + C10), (A1 + B1.1 + C11),
(A1 + B1.2 + C11), (A1 + B1.3 + C11), (A1 + B1.4 + C11), (A1 + B1.5 + C11), (A1 + B1.6 + C11),
(A1 + B1.7 + C11), (A1 + B1.8 + C11), (A1 + B1.9 + C11), (A1 + B1.10 + C11),
(A1 + B2.1 + C11), (A1 + B2.2 + C11), (A1 + B2.3 + C11), (A1 + B2.4 + C11), (A1 + B5.1 + C11),
(A1 + B5.2 + C11), (A1 + B7.1 + C11), (A1 + B8.1 + C11), (A1 + B9.1 + C11),
(A1 + B10.1 + C11), (A2 + B1.1 + C11), (A2 + B1.2 + C11), (A2 + B1.3 + C11),
(A2 + B1.4 + C11), (A2 + B1.5 + C11), (A2 + B1.6 + C11), (A2 + B1.7 + C11), (A2 + B1.8 + C11),
(A2 + B1.9 + C11), (A2 + B1.10 + C11), (A2 + B2.1 + C11), (A2 + B2.2 + C11),
(A2 + B2.3 + C11), (A2 + B2.4 + C11), (A2 + B5.1 + C11), (A2 + B5.2 + C11), (A2 + B7.1 + C11),
(A2 + B8.1 + C11), (A2 + B9.1 + C11), (A2 + B10.1 + C11), (A3 + B1.1 + C11),
(A3 + B1.2 + C11), (A3 + B1.3 + C11), (A3 + B1.4 + C11), (A3 + B1.5 + C11), (A3 + B1.6 + C11),
(A3 + B1.7 + C11), (A3 + B1.8 + C11), (A3 + B1.9 + C11), (A3 + B1.10 + C11),
(A3 + B2.1 + C11), (A3 + B2.2 + C11), (A3 + B2.3 + C11), (A3 + B2.4 + C11), (A3 + B5.1 + C11),
(A3 + B5.2 + C11), (A3 + B7.1 + C11), (A3 + B8.1 + C11), (A3 + B9.1 + C11),
(A3 + B10.1 + C11), (A4 + B1.1 + C11), (A4 + B1.2 + C11), (A4 + B1.3 + C11),
(A4 + B1.4 + C11), (A4 + B1.5 + C11), (A4 + B1.6 + C11), (A4 + B1.7 + C11), (A4 + B1.8 + C11),
(A4 + B1.9 + C11), (A4 + B1.10 + C11),
(A4 + B2.1 + C11), (A4 + B2.2 + C11), (A4 + B2.3 + C11), (A4 + B2.4 + C11), (A4 + B5.1 + C11),
(A4 + B5.2 + C11), (A4 + B7.1 + C11), (A4 + B8.1 + C11), (A4 + B9.1 + C11),
(A4 + B10.1 + C11), (A1 + B1.1 + C12), (A1 + B1.2 + C12), (A1 + B1.3 + C12),
(A1 + B1.4 + C12), (A1 + B1.5 + C12), (A1 + B1.6 + C12), (A1 + B1.7 + C12), (A1 + B1.8 + C12),
(A1 + B1.9 + C12), (A1 + B1.10 + C12), (A1 + B2.1 + C12), (A1 + B2.2 + C12),
(A1 + B2.3 + C12), (A1 + B2.4 + C12), (A1 + B5.1 + C12), (A1 + B5.2 + C12), (A1 + B7.1 + C12),
(A1 + B8.1 + C12), (A1 + B9.1 + C12), (A1 + B10.1 + C12), (A2 + B1.1 + C12),
(A2 + B1.2 + C12), (A2 + B1.3 + C12), (A2 + B1.4 + C12), (A2 + B1.5 + C12), (A2 + B1.6 + C12),
(A2 + B1.7 + C12), (A2 + B1.8 + C12), (A2 + B1.9 + C12), (A2 + B1.10 + C12),
(A2 + B2.1 + C12), (A2 + B2.2 + C12), (A2 + B2.3 + C12), (A2 + B2.4 + C12), (A2 + B5.1 + C12),
(A2 + B5.2 + C12), (A2 + B7.1 + C12), (A2 + B8.1 + C12), (A2 + B9.1 + C12),
(A2 + B10.1 + C12), (A3 + B1.1 + C12), (A3 + B1.2 + C12), (A3 + B1.3 + C12),
(A3 + B1.4 + C12), (A3 + B1.5 + C12), (A3 + B1.6 + C12), (A3 + B1.7 + C12), (A3 + B1.8 + C12),
(A3 + B1.9 + C12), (A3 + B1.10 + C12),
(A3 + B2.1 + C12), (A3 + B2.2 + C12), (A3 + B2.3 + C12), (A3 + B2.4 + C12), (A3 + B5.1 + C12),
(A3 + B5.2 + C12), (A3 + B7.1 + C12), (A3 + B8.1 + C12), (A3 + B9.1 + C12),
(A3 + B10.1 + C12), (A4 + B1.1 + C12), (A4 + B1.2 + C12), (A4 + B1.3 + C12),
(A4 + B1.4 + C12), (A4 + B1.5 + C12), (A4 + B1.6 + C12), (A4 + B1.7 + C12), (A4 + B1.8 + C12),
(A4 + B1.9 + C12), (A4 + B1.10 + C12), (A4 + B2.1 + C12), (A4 + B2.2 + C12),
(A4 + B2.3 + C12), (A4 + B2.4 + C12), (A4 + B5.1 + C12), (A4 + B5.2 + C12), (A4 + B7.1 + C12),
(A4 + B8.1 + C12), (A4 + B9.1 + C12), (A4 + B10.1 + C12),
(A1 + B1.1 + C13), (A1 + B1.2 + C13), (A1 + B1.3 + C13), (A1 + B1.4 + C13), (A1 + B1.5 + C13),
(A1 + B1.6 + C13), (A1 + B1.7 + C13), (A1 + B1.8 + C13), (A1 + B1.9 + C13),
(A1 + B1.10 + C13), (A1 + B2.1 + C13), (A1 + B2.2 + C13), (A1 + B2.3 + C13),
(A1 + B2.4 + C13), (A1 + B5.1 + C13), (A1 + B5.2 + C13), (A1 + B7.1 + C13), (A1 + B8.1 + C13),
(A1 + B9.1 + C13), (A1 + B10.1 + C13), (A2 + B1.1 + C13), (A2 + B1.2 + C13),
(A2 + B1.3 + C13), (A2 + B1.4 + C13), (A2 + B1.5 + C13), (A2 + B1.6 + C13), (A2 + B1.7 + C13),
(A2 + B1.8 + C13), (A2 + B1.9 + C13), (A2 + B1.10 + C13), (A2 + B2.1 + C13),
(A2 + B2.2 + C13), (A2 + B2.3 + C13), (A2 + B2.4 + C13), (A2 + B5.1 + C13), (A2 + B5.2 + C13),
(A2 + B7.1 + C13), (A2 + B8.1 + C13), (A2 + B9.1 + C13), (A2 + B10.1 + C13),
(A3 + B1.1 + C13), (A3 + B1.2 + C13), (A3 + B1.3 + C13), (A3 + B1.4 + C13), (A3 + B1.5 + C13),
(A3 + B1.6 + C13), (A3 + B1.7 + C13), (A3 + B1.8 + C13), (A3 + B1.9 + C13),
(A3 + B1.10 + C13), (A3 + B2.1 + C13), (A3 + B2.2 + C13), (A3 + B2.3 + C13),
(A3 + B2.4 + C13), (A3 + B5.1 + C13), (A3 + B5.2 + C13), (A3 + B7.1 + C13), (A3 + B8.1 + C13),
(A3 + B9.1 + C13), (A3 + B10.1 + C13), (A4 + B1.1 + C13), (A4 + B1.2 + C13),
(A4 + B1.3 + C13), (A4 + B1.4 + C13), (A4 + B1.5 + C13), (A4 + B1.6 + C13), (A4 + B1.7 + C13),
(A4 + B1.8 + C13), (A4 + B1.9 + C13), (A4 + B1.10 + C13), (A4 + B2.1 + C13),
(A4 + B2.2 + C13), (A4 + B2.3 + C13), (A4 + B2.4 + C13), (A4 + B5.1 + C13), (A4 + B5.2 + C13),
(A4 + B7.1 + C13), (A4 + B8.1 + C13), (A4 + B9.1 + C13), (A4 + B10.1 + C13),
(A1 + B1.1 + C14), (A1 + B1.2 + C14), (A1 + B1.3 + C14), (A1 + B1.4 + C14), (A1 + B1.5 + C14),
(A1 + B1.6 + C14), (A1 + B1.7 + C14), (A1 + B1.8 + C14), (A1 + B1.9 + C14),
(A1 + B1.10 + C14),
(A1 + B2.1 + C14), (A1 + B2.2 + C14), (A1 + B2.3 + C14), (A1 + B2.4 + C14), (A1 + B5.1 + C14),
(A1 + B5.2 + C14), (A1 + B7.1 + C14), (A1 + B8.1 + C14), (A1 + B9.1 + C14),
(A1 + B10.1 + C14), (A2 + B1.1 + C14), (A2 + B1.2 + C14), (A2 + B1.3 + C14),
(A2 + B1.4 + C14), (A2 + B1.5 + C14), (A2 + B1.6 + C14), (A2 + B1.7 + C14), (A2 + B1.8 + C14),
(A2 + B1.9 + C14), (A2 + B1.10 + C14), (A2 + B2.1 + C14), (A2 + B2.2 + C14),
(A2 + B2.3 + C14), (A2 + B2.4 + C14), (A2 + B5.1 + C14), (A2 + B5.2 + C14), (A2 + B7.1 + C14),
(A2 + B8.1 + C14), (A2 + B9.1 + C14), (A2 + B10.1 + C14), (A3 + B1.1 + C14),
(A3 + B1.2 + C14), (A3 + B1.3 + C14), (A3 + B1.4 + C14), (A3 + B1.5 + C14), (A3 + B1.6 + C14),
(A3 + B1.7 + C14), (A3 + B1.8 + C14), (A3 + B1.9 + C14), (A3 + B1.10 + C14),
(A3 + B2.1 + C14), (A3 + B2.2 + C14), (A3 + B2.3 + C14), (A3 + B2.4 + C14), (A3 + B5.1 + C14),
(A3 + B5.2 + C14), (A3 + B7.1 + C14), (A3 + B8.1 + C14), (A3 + B9.1 + C14),
(A3 + B10.1 + C14), (A4 + B1.1 + C14), (A4 + B1.2 + C14), (A4 + B1.3 + C14),
(A4 + B1.4 + C14), (A4 + B1.5 + C14), (A4 + B1.6 + C14), (A4 + B1.7 + C14), (A4 + B1.8 + C14),
(A4 + B1.9 + C14), (A4 + B1.10 + C14), (A4 + B2.1 + C14), (A4 + B2.2 + C14),
(A4 + B2.3 + C14), (A4 + B2.4 + C14), (A4 + B5.1 + C14), (A4 + B5.2 + C14), (A4 + B7.1 + C14),
(A4 + B8.1 + C14), (A4 + B9.1 + C14), (A4 + B10.1 + C14), (A1 + B1.1 + C15),
(A1 + B1.2 + C15), (A1 + B1.3 + C15), (A1 + B1.4 + C15), (A1 + B1.5 + C15), (A1 + B1.6 + C15),
(A1 + B1.7 + C15), (A1 + B1.8 + C15), (A1 + B1.9 + C15), (A1 + B1.10 + C15),
(A1 + B2.1 + C15), (A1 + B2.2 + C15), (A1 + B2.3 + C15), (A1 + B2.4 + C15), (A1 + B5.1 + C15),
(A1 + B5.2 + C15), (A1 + B7.1 + C15), (A1 + B8.1 + C15), (A1 + B9.1 + C15),
(A1 + B10.1 + C15), (A2 + B1.1 + C15), (A2 + B1.2 + C15), (A2 + B1.3 + C15),
(A2 + B1.4 + C15), (A2 + B1.5 + C15), (A2 + B1.6 + C15), (A2 + B1.7 + C15), (A2 + B1.8 + C15),
(A2 + B1.9 + C15), (A2 + B1.10 + C15), (A2 + B2.1 + C15), (A2 + B2.2 + C15),
(A2 + B2.3 + C15), (A2 + B2.4 + C15), (A2 + B5.1 + C15), (A2 + B5.2 + C15), (A2 + B7.1 + C15),
(A2 + B8.1 + C15), (A2 + B9.1 + C15), (A2 + B10.1 + C15), (A3 + B1.1 + C15),
(A3 + B1.2 + C15), (A3 + B1.3 + C15), (A3 + B1.4 + C15), (A3 + B1.5 + C15), (A3 + B1.6 + C15),
(A3 + B1.7 + C15), (A3 + B1.8 + C15), (A3 + B1.9 + C15), (A3 + B1.10 + C15),
(A3 + B2.1 + C15), (A3 + B2.2 + C15), (A3 + B2.3 + C15), (A3 + B2.4 + C15), (A3 + B5.1 + C15),
(A3 + B5.2 + C15), (A3 + B7.1 + C15), (A3 + B8.1 + C15), (A3 + B9.1 + C15),
(A3 + B10.1 + C15), (A4 + B1.1 + C15), (A4 + B1.2 + C15), (A4 + B1.3 + C15),
(A4 + B1.4 + C15), (A4 + B1.5 + C15), (A4 + B1.6 + C15), (A4 + B1.7 + C15), (A4 + B1.8 + C15),
(A4 + B1.9 + C15), (A4 + B1.10 + C15), (A4 + B2.1 + C15), (A4 + B2.2 + C15),
(A4 + B2.3 + C15), (A4 + B2.4 + C15), (A4 + B5.1 + C15), (A4 + B5.2 + C15), (A4 + B7.1 + C15),
(A4 + B8.1 + C15), (A4 + B9.1 + C15), (A4 + B10.1 + C15), (A1 + B1.1 + C16),
(A1 + B1.2 + C16), (A1 + B1.3 + C16), (A1 + B1.4 + C16), (A1 + B1.5 + C16), (A1 + B1.6 + C16),
(A1 + B1.7 + C16), (A1 + B1.8 + C16), (A1 + B1.9 + C16), (A1 + B1.10 + C16),
(A1 + B2.1 + C16), (A1 + B2.2 + C16), (A1 + B2.3 + C16), (A1 + B2.4 + C16), (A1 + B5.1 + C16),
(A1 + B5.2 + C16), (A1 + B7.1 + C16), (A1 + B8.1 + C16), (A1 + B9.1 + C16),
(A1 + B10.1 + C16), (A2 + B1.1 + C16), (A2 + B1.2 + C16), (A2 + B1.3 + C16),
(A2 + B1.4 + C16), (A2 + B1.5 + C16), (A2 + B1.6 + C16), (A2 + B1.7 + C16), (A2 + B1.8 + C16),
(A2 + B1.9 + C16), (A2 + B1.10 + C16), (A2 + B2.1 + C16), (A2 + B2.2 + C16),
(A2 + B2.3 + C16), (A2 + B2.4 + C16), (A2 + B5.1 + C16), (A2 + B5.2 + C16), (A2 + B7.1 + C16),
(A2 + B8.1 + C16), (A2 + B9.1 + C16), (A2 + B10.1 + C16), (A3 + B1.1 + C16),
(A3 + B1.2 + C16), (A3 + B1.3 + C16), (A3 + B1.4 + C16), (A3 + B1.5 + C16), (A3 + B1.6 + C16),
(A3 + B1.7 + C16), (A3 + B1.8 + C16), (A3 + B1.9 + C16), (A3 + B1.10 + C16),
(A3 + B2.1 + C16), (A3 + B2.2 + C16), (A3 + B2.3 + C16), (A3 + B2.4 + C16), (A3 + B5.1 + C16),
(A3 + B5.2 + C16), (A3 + B7.1 + C16), (A3 + B8.1 + C16), (A3 + B9.1 + C16),
(A3 + B10.1 + C16), (A4 + B1.1 + C16), (A4 + B1.2 + C16), (A4 + B1.3 + C16),
(A4 + B1.4 + C16), (A4 + B1.5 + C16), (A4 + B1.6 + C16), (A4 + B1.7 + C16), (A4 + B1.8 + C16),
(A4 + B1.9 + C16), (A4 + B1.10 + C16), (A4 + B2.1 + C16), (A4 + B2.2 + C16),
(A4 + B2.3 + C16), (A4 + B2.4 + C16), (A4 + B5.1 + C16), (A4 + B5.2 + C16), (A4 + B7.1 + C16),
(A4 + B8.1 + C16), (A4 + B9.1 + C16), (A4 + B10.1 + C16), (A1 + B1.1 + C17),
(A1 + B1.2 + C17), (A1 + B1.3 + C17), (A1 + B1.4 + C17), (A1 + B1.5 + C17), (A1 + B1.6 + C17),
(A1 + B1.7 + C17), (A1 + B1.8 + C17), (A1 + B1.9 + C17), (A1 + B1.10 + C17),
(A1 + B2.1 + C17), (A1 + B2.2 + C17), (A1 + B2.3 + C17), (A1 + B2.4 + C17), (A1 + B5.1 + C17),
(A1 + B5.2 + C17), (A1 + B7.1 + C17), (A1 + B8.1 + C17), (A1 + B9.1 + C17),
(A1 + B10.1 + C17), (A2 + B1.1 + C17), (A2 + B1.2 + C17), (A2 + B1.3 + C17),
(A2 + B1.4 + C17), (A2 + B1.5 + C17), (A2 + B1.6 + C17), (A2 + B1.7 + C17), (A2 + B1.8 + C17),
(A2 + B1.9 + C17), (A2 + B1.10 + C17), (A2 + B2.1 + C17), (A2 + B2.2 + C17), (A2 + B2.3 + C17),
(A2 + B2.4 + C17), (A2 + B5.1 + C17), (A2 + B5.2 + C17), (A2 + B7.1 + C17), (A2 + B8.1 + C17),
(A2 + B9.1 + C17), (A2 + B10.1 + C17), (A3 + B1.1 + C17), (A3 + B1.2 + C17),
(A3 + B1.3 + C17), (A3 + B1.4 + C17), (A3 + B1.5 + C17), (A3 + B1.6 + C17), (A3 + B1.7 + C17),
(A3 + B1.8 + C17), (A3 + B1.9 + C17), (A3 + B1.10 + C17), (A3 + B2.1 + C17),
(A3 + B2.2 + C17), (A3 + B2.3 + C17), (A3 + B2.4 + C17), (A3 + B5.1 + C17), (A3 + B5.2 + C17),
(A3 + B7.1 + C17), (A3 + B8.1 + C17), (A3 + B9.1 + C17), (A3 + B10.1 + C17),
(A4 + B1.1 + C17), (A4 + B1.2 + C17), (A4 + B1.3 + C17), (A4 + B1.4 + C17), (A4 + B1.5 + C17),
(A4 + B1.6 + C17), (A4 + B1.7 + C17), (A4 + B1.8 + C17), (A4 + B1.9 + C17),
(A4 + B1.10 + C17),
(A4 + B2.1 + C17), (A4 + B2.2 + C17), (A4 + B2.3 + C17), (A4 + B2.4 + C17), (A4 + B5.1 + C17),
(A4 + B5.2 + C17), (A4 + B7.1 + C17), (A4 + B8.1 + C17), (A4 + B9.1 + C17),
(A4 + B10.1 + C17),
(A1 + B1.1 + C18), (A1 + B1.2 + C18), (A1 + B1.3 + C18), (A1 + B1.4 + C18), (A1 + B1.5 + C18),
(A1 + B1.6 + C18), (A1 + B1.7 + C18), (A1 + B1.8 + C18), (A1 + B1.9 + C18),
(A1 + B1.10 + C18),
(A1 + B2.1 + C18), (A1 + B2.2 + C18), (A1 + B2.3 + C18), (A1 + B2.4 + C18), (A1 + B5.1 + C18),
(A1 + B5.2 + C18), (A1 + B7.1 + C18), (A1 + B8.1 + C18), (A1 + B9.1 + C18),
(A1 + B10.1 + C18), (A2 + B1.1 + C18), (A2 + B1.2 + C18), (A2 + B1.3 + C18),
(A2 + B1.4 + C18), (A2 + B1.5 + C18), (A2 + B1.6 + C18), (A2 + B1.7 + C18), (A2 + B1.8 + C18),
(A2 + B1.9 + C18), (A2 + B1.10 + C18), (A2 + B2.1 + C18), (A2 + B2.2 + C18),
(A2 + B2.3 + C18), (A2 + B2.4 + C18), (A2 + B5.1 + C18), (A2 + B5.2 + C18), (A2 + B7.1 + C18),
(A2 + B8.1 + C18), (A2 + B9.1 + C18), (A2 + B10.1 + C18), (A3 + B1.1 + C18),
(A3 + B1.2 + C18), (A3 + B1.3 + C18), (A3 + B1.4 + C18), (A3 + B1.5 + C18), (A3 + B1.6 + C18),
(A3 + B1.7 + C18), (A3 + B1.8 + C18), (A3 + B1.9 + C18), (A3 + B1.10 + C18),
(A3 + B2.1 + C18), (A3 + B2.2 + C18), (A3 + B2.3 + C18), (A3 + B2.4 + C18), (A3 + B5.1 + C18),
(A3 + B5.2 + C18), (A3 + B7.1 + C18), (A3 + B8.1 + C18), (A3 + B9.1 + C18),
(A3 + B10.1 + C18), (A4 + B1.1 + C18), (A4 + B1.2 + C18), (A4 + B1.3 + C18),
(A4 + B1.4 + C18), (A4 + B1.5 + C18), (A4 + B1.6 + C18), (A4 + B1.7 + C18), (A4 + B1.8 + C18),
(A4 + B1.9 + C18), (A4 + B1.10 + C18),
(A4 + B2.1 + C18), (A4 + B2.2 + C18), (A4 + B2.3 + C18), (A4 + B2.4 + C18), (A4 + B5.1 + C18),
(A4 + B5.2 + C18), (A4 + B7.1 + C18), (A4 + B8.1 + C18), (A4 + B9.1 + C18),
(A4 + B10.1 + C18), (A1 + B1.1 + C19), (A1 + B1.2 + C19), (A1 + B1.3 + C19),
(A1 + B1.4 + C19), (A1 + B1.5 + C19), (A1 + B1.6 + C19), (A1 + B1.7 + C19), (A1 + B1.8 + C19),
(A1 + B1.9 + C19), (A1 + B1.10 + C19), (A1 + B2.1 + C19), (A1 + B2.2 + C19),
(A1 + B2.3 + C19), (A1 + B2.4 + C19), (A1 + B5.1 + C19), (A1 + B5.2 + C19), (A1 + B7.1 + C19),
(A1 + B8.1 + C19), (A1 + B9.1 + C19), (A1 + B10.1 + C19), (A2 + B1.1 + C19),
(A2 + B1.2 + C19), (A2 + B1.3 + C19), (A2 + B1.4 + C19), (A2 + B1.5 + C19), (A2 + B1.6 + C19),
(A2 + B1.7 + C19), (A2 + B1.8 + C19), (A2 + B1.9 + C19), (A2 + B1.10 + C19),
(A2 + B2.1 + C19), (A2 + B2.2 + C19), (A2 + B2.3 + C19), (A2 + B2.4 + C19), (A2 + B5.1 + C19),
(A2 + B5.2 + C19), (A2 + B7.1 + C19), (A2 + B8.1 + C19), (A2 + B9.1 + C19),
(A2 + B10.1 + C19), (A3 + B1.1 + C19), (A3 + B1.2 + C19), (A3 + B1.3 + C19),
(A3 + B1.4 + C19), (A3 + B1.5 + C19), (A3 + B1.6 + C19), (A3 + B1.7 + C19), (A3 + B1.8 + C19),
(A3 + B1.9 + C19), (A3 + B1.10 + C19),
(A3 + B2.1 + C19), (A3 + B2.2 + C19), (A3 + B2.3 + C19), (A3 + B2.4 + C19), (A3 + B5.1 + C19),
(A3 + B5.2 + C19), (A3 + B7.1 + C19), (A3 + B8.1 + C19), (A3 + B9.1 + C19),
(A3 + B10.1 + C19), (A4 + B1.1 + C19), (A4 + B1.2 + C19), (A4 + B1.3 + C19),
(A4 + B1.4 + C19), (A4 + B1.5 + C19), (A4 + B1.6 + C19), (A4 + B1.7 + C19), (A4 + B1.8 + C19),
(A4 + B1.9 + C19), (A4 + B1.10 + C19), (A4 + B2.1 + C19), (A4 + B2.2 + C19),
(A4 + B2.3 + C19), (A4 + B2.4 + C19), (A4 + B5.1 + C19), (A4 + B5.2 + C19), (A4 + B7.1 + C19),
(A4 + B8.1 + C19), (A4 + B9.1 + C19), (A4 + B10.1 + C19), (A1 + B1.1 + C20),
(A1 + B1.2 + C20), (A1 + B1.3 + C20), (A1 + B1.4 + C20), (A1 + B1.5 + C20), (A1 + B1.6 + C20),
(A1 + B1.7 + C20), (A1 + B1.8 + C20), (A1 + B1.9 + C20), (A1 + B1.10 + C20),
(A1 + B2.1 + C20), (A1 + B2.2 + C20), (A1 + B2.3 + C20), (A1 + B2.4 + C20), (A1 + B5.1 + C20),
(A1 + B5.2 + C20), (A1 + B7.1 + C20), (A1 + B8.1 + C20), (A1 + B9.1 + C20),
(A1 + B10.1 + C20), (A2 + B1.1 + C20), (A2 + B1.2 + C20), (A2 + B1.3 + C20),
(A2 + B1.4 + C20), (A2 + B1.5 + C20), (A2 + B1.6 + C20), (A2 + B1.7 + C20), (A2 + B1.8 + C20),
(A2 + B1.9 + C20), (A2 + B1.10 + C20),
(A2 + B2.1 + C20), (A2 + B2.2 + C20), (A2 + B2.3 + C20), (A2 + B2.4 + C20), (A2 + B5.1 + C20),
(A2 + B5.2 + C20), (A2 + B7.1 + C20), (A2 + B8.1 + C20), (A2 + B9.1 + C20),
(A2 + B10.1 + C20), (A3 + B1.1 + C20), (A3 + B1.2 + C20), (A3 + B1.3 + C20),
(A3 + B1.4 + C20), (A3 + B1.5 + C20), (A3 + B1.6 + C20), (A3 + B1.7 + C20), (A3 + B1.8 + C20),
(A3 + B1.9 + C20), (A3 + B1.10 + C20), (A3 + B2.1 + C20), (A3 + B2.2 + C20), (A3 + B2.3 + C20),
(A3 + B2.4 + C20), (A3 + B5.1 + C20), (A3 + B5.2 + C20), (A3 + B7.1 + C20), (A3 + B8.1 + C20),
(A3 + B9.1 + C20), (A3 + B10.1 + C20), (A4 + B1.1 + C20), (A4 + B1.2 + C20),
(A4 + B1.3 + C20), (A4 + B1.4 + C20), (A4 + B1.5 + C20), (A4 + B1.6 + C20), (A4 + B1.7 + C20),
(A4 + B1.8 + C20), (A4 + B1.9 + C20), (A4 + B1.10 + C20), (A4 + B2.1 + C20),
(A4 + B2.2 + C20), (A4 + B2.3 + C20), (A4 + B2.4 + C20), (A4 + B5.1 + C20), (A4 + B5.2 + C20),
(A4 + B7.1 + C20), (A4 + B8.1 + C20), (A4 + B9.1 + C20), (A4 + B10.1 + C20),
(A1 + B1.1 + C21), (A1 + B1.2 + C21), (A1 + B1.3 + C21), (A1 + B1.4 + C21), (A1 + B1.5 + C21),
(A1 + B1.6 + C21), (A1 + B1.7 + C21), (A1 + B1.8 + C21), (A1 + B1.9 + C21),
(A1 + B1.10 + C21),
(A1 + B2.1 + C21), (A1 + B2.2 + C21), (A1 + B2.3 + C21), (A1 + B2.4 + C21), (A1 + B5.1 + C21),
(A1 + B5.2 + C21), (A1 + B7.1 + C21), (A1 + B8.1 + C21), (A1 + B9.1 + C21),
(A1 + B10.1 + C21), (A2 + B1.1 + C21), (A2 + B1.2 + C21), (A2 + B1.3 + C21),
(A2 + B1.4 + C21), (A2 + B1.5 + C21), (A2 + B1.6 + C21), (A2 + B1.7 + C21), (A2 + B1.8 + C21),
(A2 + B1.9 + C21), (A2 + B1.10 + C21), (A2 + B2.1 + C21), (A2 + B2.2 + C21),
(A2 + B2.3 + C21), (A2 + B2.4 + C21), (A2 + B5.1 + C21), (A2 + B5.2 + C21), (A2 + B7.1 + C21),
(A2 + B8.1 + C21), (A2 + B9.1 + C21), (A2 + B10.1 + C21), (A3 + B1.1 + C21),
(A3 + B1.2 + C21), (A3 + B1.3 + C21), (A3 + B1.4 + C21), (A3 + B1.5 + C21), (A3 + B1.6 + C21),
(A3 + B1.7 + C21), (A3 + B1.8 + C21), (A3 + B1.9 + C21), (A3 + B1.10 + C21),
(A3 + B2.1 + C21), (A3 + B2.2 + C21), (A3 + B2.3 + C21), (A3 + B2.4 + C21), (A3 + B5.1 + C21),
(A3 + B5.2 + C21), (A3 + B7.1 + C21), (A3 + B8.1 + C21), (A3 + B9.1 + C21),
(A3 + B10.1 + C21), (A4 + B1.1 + C21), (A4 + B1.2 + C21), (A4 + B1.3 + C21),
(A4 + B1.4 + C21), (A4 + B1.5 + C21), (A4 + B1.6 + C21), (A4 + B1.7 + C21), (A4 + B1.8 + C21),
(A4 + B1.9 + C21), (A4 + B1.10 + C21),
(A4 + B2.1 + C21), (A4 + B2.2 + C21), (A4 + B2.3 + C21), (A4 + B2.4 + C21), (A4 + B5.1 + C21),
(A4 + B5.2 + C21), (A4 + B7.1 + C21), (A4 + B8.1 + C21), (A4 + B9.1 + C21),
(A4 + B10.1 + C21), (A1 + B1.1 + C22), (A1 + B1.2 + C22), (A1 + B1.3 + C22),
(A1 + B1.4 + C22), (A1 + B1.5 + C22), (A1 + B1.6 + C22), (A1 + B1.7 + C22), (A1 + B1.8 + C22),
(A1 + B1.9 + C22), (A1 + B1.10 + C22), (A1 + B2.1 + C22), (A1 + B2.2 + C22),
(A1 + B2.3 + C22), (A1 + B2.4 + C22), (A1 + B5.1 + C22), (A1 + B5.2 + C22), (A1 + B7.1 + C22),
(A1 + B8.1 + C22), (A1 + B9.1 + C22), (A1 + B10.1 + C22), (A2 + B1.1 + C22),
(A2 + B1.2 + C22), (A2 + B1.3 + C22), (A2 + B1.4 + C22), (A2 + B1.5 + C22), (A2 + B1.6 + C22),
(A2 + B1.7 + C22), (A2 + B1.8 + C22), (A2 + B1.9 + C22), (A2 + B1.10 + C22),
(A2 + B2.1 + C22), (A2 + B2.2 + C22), (A2 + B2.3 + C22), (A2 + B2.4 + C22), (A2 + B5.1 + C22),
(A2 + B5.2 + C22), (A2 + B7.1 + C22), (A2 + B8.1 + C22), (A2 + B9.1 + C22),
(A2 + B10.1 + C22), (A3 + B1.1 + C22), (A3 + B1.2 + C22), (A3 + B1.3 + C22),
(A3 + B1.4 + C22), (A3 + B1.5 + C22), (A3 + B1.6 + C22), (A3 + B1.7 + C22), (A3 + B1.8 + C22),
(A3 + B1.9 + C22), (A3 + B1.10 + C22),
(A3 + B2.1 + C22), (A3 + B2.2 + C22), (A3 + B2.3 + C22), (A3 + B2.4 + C22), (A3 + B5.1 + C22),
(A3 + B5.2 + C22), (A3 + B7.1 + C22), (A3 + B8.1 + C22), (A3 + B9.1 + C22),
(A3 + B10.1 + C22), (A4 + B1.1 + C22), (A4 + B1.2 + C22), (A4 + B1.3 + C22),
(A4 + B1.4 + C22), (A4 + B1.5 + C22), (A4 + B1.6 + C22), (A4 + B1.7 + C22), (A4 + B1.8 + C22),
(A4 + B1.9 + C22), (A4 + B1.10 + C22), (A4 + B2.1 + C22), (A4 + B2.2 + C22),
(A4 + B2.3 + C22), (A4 + B2.4 + C22), (A4 + B5.1 + C22), (A4 + B5.2 + C22), (A4 + B7.1 + C22),
(A4 + B8.1 + C22), (A4 + B9.1 + C22), (A4 + B10.1 + C22), (A1 + B1.1 + C23),
(A1 + B1.2 + C23), (A1 + B1.3 + C23), (A1 + B1.4 + C23), (A1 + B1.5 + C23), (A1 + B1.6 + C23),
(A1 + B1.7 + C23), (A1 + B1.8 + C23), (A1 + B1.9 + C23), (A1 + B1.10 + C23),
(A1 + B2.1 + C23), (A1 + B2.2 + C23), (A1 + B2.3 + C23), (A1 + B2.4 + C23), (A1 + B5.1 + C23),
(A1 + B5.2 + C23), (A1 + B7.1 + C23), (A1 + B8.1 + C23), (A1 + B9.1 + C23),
(A1 + B10.1 + C23), (A2 + B1.1 + C23), (A2 + B1.2 + C23), (A2 + B1.3 + C23),
(A2 + B1.4 + C23), (A2 + B1.5 + C23), (A2 + B1.6 + C23), (A2 + B1.7 + C23), (A2 + B1.8 + C23),
(A2 + B1.9 + C23), (A2 + B1.10 + C23),
(A2 + B2.1 + C23), (A2 + B2.2 + C23), (A2 + B2.3 + C23), (A2 + B2.4 + C23), (A2 + B5.1 + C23),
(A2 + B5.2 + C23), (A2 + B7.1 + C23), (A2 + B8.1 + C23), (A2 + B9.1 + C23),
(A2 + B10.1 + C23), (A3 + B1.1 + C23), (A3 + B1.2 + C23), (A3 + B1.3 + C23),
(A3 + B1.4 + C23), (A3 + B1.5 + C23), (A3 + B1.6 + C23), (A3 + B1.7 + C23), (A3 + B1.8 + C23),
(A3 + B1.9 + C23), (A3 + B1.10 + C23), (A3 + B2.1 + C23), (A3 + B2.2 + C23),
(A3 + B2.3 + C23), (A3 + B2.4 + C23), (A3 + B5.1 + C23), (A3 + B5.2 + C23), (A3 + B7.1 + C23),
(A3 + B8.1 + C23), (A3 + B9.1 + C23), (A3 + B10.1 + C23), (A4 + B1.1 + C23),
(A4 + B1.2 + C23), (A4 + B1.3 + C23), (A4 + B1.4 + C23), (A4 + B1.5 + C23), (A4 + B1.6 + C23),
(A4 + B1.7 + C23), (A4 + B1.8 + C23), (A4 + B1.9 + C23), (A4 + B1.10 + C23),
(A4 + B2.1 + C23), (A4 + B2.2 + C23), (A4 + B2.3 + C23), (A4 + B2.4 + C23), (A4 + B5.1 + C23),
(A4 + B5.2 + C23), (A4 + B7.1 + C23), (A4 + B8.1 + C23), (A4 + B9.1 + C23),
(A4 + B10.1 + C23),
(A1 + B1.1 + C24), (A1 + B1.2 + C24), (A1 + B1.3 + C24), (A1 + B1.4 + C24), (A1 + B1.5 + C24),
(A1 + B1.6 + C24), (A1 + B1.7 + C24), (A1 + B1.8 + C24), (A1 + B1.9 + C24),
(A1 + B1.10 + C24),
(A1 + B2.1 + C24), (A1 + B2.2 + C24), (A1 + B2.3 + C24), (A1 + B2.4 + C24), (A1 + B5.1 + C24),
(A1 + B5.2 + C24), (A1 + B7.1 + C24), (A1 + B8.1 + C24), (A1 + B9.1 + C24),
(A1 + B10.1 + C24), (A2 + B1.1 + C24), (A2 + B1.2 + C24), (A2 + B1.3 + C24),
(A2 + B1.4 + C24), (A2 + B1.5 + C24), (A2 + B1.6 + C24), (A2 + B1.7 + C24), (A2 + B1.8 + C24),
(A2 + B1.9 + C24), (A2 + B1.10 + C24), (A2 + B2.1 + C24), (A2 + B2.2 + C24),
(A2 + B2.3 + C24), (A2 + B2.4 + C24), (A2 + B5.1 + C24), (A2 + B5.2 + C24), (A2 + B7.1 + C24),
(A2 + B8.1 + C24), (A2 + B9.1 + C24), (A2 + B10.1 + C24), (A3 + B1.1 + C24),
(A3 + B1.2 + C24), (A3 + B1.3 + C24), (A3 + B1.4 + C24), (A3 + B1.5 + C24), (A3 + B1.6 + C24),
(A3 + B1.7 + C24), (A3 + B1.8 + C24), (A3 + B1.9 + C24), (A3 + B1.10 + C24),
(A3 + B2.1 + C24), (A3 + B2.2 + C24), (A3 + B2.3 + C24), (A3 + B2.4 + C24), (A3 + B5.1 + C24),
(A3 + B5.2 + C24), (A3 + B7.1 + C24), (A3 + B8.1 + C24), (A3 + B9.1 + C24),
(A3 + B10.1 + C24), (A4 + B1.1 + C24), (A4 + B1.2 + C24), (A4 + B1.3 + C24),
(A4 + B1.4 + C24), (A4 + B1.5 + C24), (A4 + B1.6 + C24), (A4 + B1.7 + C24), (A4 + B1.8 + C24),
(A4 + B1.9 + C24), (A4 + B1.10 + C24), (A4 + B2.1 + C24), (A4 + B2.2 + C24),
(A4 + B2.3 + C24), (A4 + B2.4 + C24), (A4 + B5.1 + C24), (A4 + B5.2 + C24), (A4 + B7.1 + C24),
(A4 + B8.1 + C24), (A4 + B9.1 + C24), (A4 + B10.1 + C24),
(A1 + B1.1 + C25), (A1 + B1.2 + C25), (A1 + B1.3 + C25), (A1 + B1.4 + C25), (A1 + B1.5 + C25),
(A1 + B1.6 + C25), (A1 + B1.7 + C25), (A1 + B1.8 + C25), (A1 + B1.9 + C25),
(A1 + B1.10 + C25),
(A1 + B2.1 + C25), (A1 + B2.2 + C25), (A1 + B2.3 + C25), (A1 + B2.4 + C25), (A1 + B5.1 + C25),
(A1 + B5.2 + C25), (A1 + B7.1 + C25), (A1 + B8.1 + C25), (A1 + B9.1 + C25),
(A1 + B10.1 + C25), (A2 + B1.1 + C25), (A2 + B1.2 + C25), (A2 + B1.3 + C25),
(A2 + B1.4 + C25), (A2 + B1.5 + C25), (A2 + B1.6 + C25), (A2 + B1.7 + C25), (A2 + B1.8 + C25),
(A2 + B1.9 + C25), (A2 + B1.10 + C25), (A2 + B2.1 + C25), (A2 + B2.2 + C25),
(A2 + B2.3 + C25), (A2 + B2.4 + C25), (A2 + B5.1 + C25), (A2 + B5.2 + C25), (A2 + B7.1 + C25),
(A2 + B8.1 + C25), (A2 + B9.1 + C25), (A2 + B10.1 + C25), (A3 + B1.1 + C25),
(A3 + B1.2 + C25), (A3 + B1.3 + C25), (A3 + B1.4 + C25), (A3 + B1.5 + C25), (A3 + B1.6 + C25),
(A3 + B1.7 + C25), (A3 + B1.8 + C25), (A3 + B1.9 + C25), (A3 + B1.10 + C25),
(A3 + B2.1 + C25), (A3 + B2.2 + C25), (A3 + B2.3 + C25), (A3 + B2.4 + C25), (A3 + B5.1 + C25),
(A3 + B5.2 + C25), (A3 + B7.1 + C25), (A3 + B8.1 + C25), (A3 + B9.1 + C25),
(A3 + B10.1 + C25), (A4 + B1.1 + C25), (A4 + B1.2 + C25), (A4 + B1.3 + C25),
(A4 + B1.4 + C25), (A4 + B1.5 + C25), (A4 + B1.6 + C25), (A4 + B1.7 + C25), (A4 + B1.8 + C25),
(A4 + B1.9 + C25), (A4 + B1.10 + C25), (A4 + B2.1 + C25), (A4 + B2.2 + C25),
(A4 + B2.3 + C25), (A4 + B2.4 + C25), (A4 + B5.1 + C25), (A4 + B5.2 + C25), (A4 + B7.1 + C25),
(A4 + B8.1 + C25), (A4 + B9.1 + C25), (A4 + B10.1 + C25).

These combinations according to the invention of safener A, herbicide B and fungicide C or insecticide C are to be understood in particular such that the seed of the crop plant is dressed with a safener A and a fungicide C or insecticide C, and there is a later application of the herbicide B in question.

In a further particularly preferred embodiment, the herbicidal compositions are compositions in which the combinations, mentioned in Table 4, of A3 with two herbicides B are in each case combined with a fungicide or insecticide C.

The compositions according to the invention can be employed for the selective control of annual and perennial monocotyledonous and dicotyledonous harmful plants in crops of cereals (for example barley, oats, rye, wheat), corn and rice and in crops of transgenic useful plants or crops of useful plants selected by classical means which are resistant to the active compounds B. Likewise, they can be employed for controlling unwanted harmful plants in plantation crops such as oil palm, sugarcane, coconut palm, indian-rubber tree, citrus, pineapple, cotton, coffee, cocoa and the like, and also in fruit production and viticulture. By virtue of their good compatibility, they are particularly suitable for use in cereals and corn, especially corn.

The compositions according to the invention act against a broad spectrum of weeds. They are suitable for controlling annual and perennial harmful plants such as, for example, from the species Abutilon, Alopecurus, Avena, Chenopodium, Cynoden, Cyperus, Digitaria, Echinochloa, Elymus, Galium, lpomoea, Kochia, Lamium, Matricaria, Polygonum, Scirpus, Setaria, Sorghum, Veronica, Viola and Xanthium.

A further advantage of the compositions according to the invention is their excellent action against many harmful plants which have now become resistant to sulfonylureas, such as, for example, Kochia.

The invention also provides a method for controlling unwanted vegetation, which comprises applying the herbicide B and one or more safeners A to the harmful plants, to parts of the harmful plants or to the area under cultivation.

The herbicidal compositions according to the invention can be applied both as mixed formulations of the safeners A and the herbicides B, if appropriate together with other customary formulation auxiliaries, which mixed formulations are then applied in the usual manner in the form of a dilution with water, or else they can be prepared in the form of tank mixes by joint dilution with water of the components which are formulated separately, or partly separately.

The herbicidal compositions according to the invention can be formulated in various ways, depending on the prevailing biological and/or physicochemical parameters. Suitable general possibilities for formulations are, for example: wettable powders (WP), emulsifiable concentrates (EC), aqueous solutions (SL), emulsions (EW) such as oil-in-water and water-in-oil emulsions, sprayable solutions or emulsions, oil suspension concentrate (SC), oil- or water-based dispersions, suspoemulsions, dusts (DP), seed dressing products, granules for soil application or for broadcasting or water-dispersible granules (WG), water-dispersible granules (WDG), water-emulsifiable granules (WEG), ULV formulations, microcapsules or waxes.

The individual types of formulation are known in principle and are described, for example, in: Winnacker-Küchler, “Chemische Technologie” [Chemical Technology], Vol. 7, C. HauserVerlag Munich, 4th Ed. 1986; van Valkenburg, “Pesticides Formulations”, Marcel Dekker N.Y., 1973; K. Martens, “Spray Drying Handbook”, 3rd Ed. 1979, G. Goodwin Ltd. London. The formulation auxiliaries required, such as inert materials, surfactants, solvents and other additives, are also known and are described, for example, in: Watkins, “Handbook of Insecticide Dust Diluents and Carriers”, 2nd Ed., Darland Books, Caldwell N.J.; H.v. Olphen, “Introduction to Clay Colloid Chemistry”; 2nd Ed., J. Wiley & Sons, N.Y.; Marsden, “Solvents Guide”, 2nd Ed., Interscience, N.Y. 1950; McCutcheon's, “Detergents and Emulsifiers Annual”, MC PubI. Corp., Ridgewood N.J.; Sisley and Wood, “Encyclopedia of Surface Active Agents”, Chem. Publ. Co. Inc., N.Y. 1964; Schonfeldt, “Grenzflächenaktive Äthylenoxidaddukte” [Surface-active ethylene oxide adducts], Wiss. Verlagsgesellschaft, Stuttgart 1976; Winnacker-Küchler, “Chemische Technologie” [Chemical Technology], Vol. 7, C. Hauser Verlag Munich, 4th Ed. 1986.

Based on these formulations, it is also possible to prepare combinations with other pesticidally active substances, such as other herbicides, fungicides or insecticides, and also safeners, fertilizers and/or growth regulators, for example in the form of a ready mix or tank mix.

Wettable powders are preparations which are uniformly dispersible in water and which, besides the active compound, also comprise ionic or nonionic surfactants (wetting agents, dispersants), for example polyethoxylated alkylphenols, polyethoxylated fatty alcohols or fatty amines, alkanesulfonates or alkylbenzene-sulfonates, sodium lignosulfonate, sodium 2,2′-dinaphthylmethane-6,6′-disulfonate, sodium dibutylnaphthalenesulfonate or else sodium oleoylmethyltaurinate, in addition to a diluent or an inert substance.

Emulsifiable concentrates are prepared by dissolving the active compound in an organic solvent, for example butanol, cyclohexanone, dimethylformamide, xylene or else higher-boiling aromatics or hydrocarbons, with the addition of one or more ionic or nonionic surfactants (emulsifiers). Examples of emulsifiers which can be used are: calcium alkylarylsulfonates, such as calcium dodecylbenzenesulfonate, or nonionic emulsifiers, such as fatty acid polyglycol esters, alkylaryl polyglycol ethers, fatty alcohol polyglycol ethers, propylene oxide/ethylene oxide condensates, alkyl polyethers, sorbitan fatty acid esters, polyoxyethylene sorbitan fatty acid esters or polyoxyethylene sorbitol esters.

Dusts are obtained by grinding the active compound with finely divided solid materials, for example talc, natural clays, such as kaolin, bentonite and pyrophyllite, or diatomaceous earth.

Granules can be prepared either by spraying the active compound onto adsorptive, granulated inert material, or by applying active compound concentrates to the surface of carriers, such as sand, kaolinite or granulated inert material, with the aid of binders, for example polyvinyl alcohol, sodium polyacrylate or else mineral oils. Suitable active compounds can also be granulated in the manner customary for the preparation of fertilizer granules, if desired as a mixture with fertilizers. Water-dispersible granules are, in general, prepared by processes such as spray-drying, fluidized-bed granulation, disk granulation, mixing using high-speed mixers, and extrusion without solid inert material.

The agrochemical preparations generally comprise from 0.1 to 99 percent by weight, in particular from 0.2 to 95% by weight, of components A and B, the following concentrations being customary, depending on the type of formulation: in wettable powders, the active compound concentration is, for example, approximately 10 to 95% by weight, the remainder to 100% by weight being composed of customary formulation constituents. In the case of emulsifiable concentrates, the active compound concentration can be, for example, from 5 to 80% by weight. Formulations in the form of dusts in most cases comprise from 5 to 20% by weight of active compound, sprayable solutions approximately 0.2 to 25% by weight of active compound. In the case of granules, such as dispersible granules, the active compound content depends partly on whether the active compound is in liquid or solid form and on which granulation auxiliaries and fillers are used. In general, the content in the water-dispersible granules amounts to between 10 and 90% by weight. In addition, the active compound formulations mentioned comprise, if appropriate, the tackifiers, wetting agents, dispersants, emulsifiers, preservatives, antifreeze agents, solvents, fillers, colorants, carriers, antifoams, evaporation inhibitors and pH or viscosity regulators which are customary in each case.

For use, the formulations, which are in commercially available form, are, if appropriate, diluted in a customary manner, for example using water in the case of wettable powders, emulsifiable concentrates, dispersions and water-dispersible granules. Preparations in the form of dusts, soil granules, granules for spreading and sprayable solutions are conventionally not diluted any further with other inert substances prior to use.

The active compounds can be applied to the plants, to parts of plants, to plant seeds or to the area under cultivation (tilled soil), preferably to the green plants and parts of the plants and, if desired, additionally to the tilled soil.

A possible use is the joint application of the active compounds in the form of tank mixes, where the concentrated formulations of the individual active compounds, in the form of their optimal formulations, are mixed jointly with water in the tank, and the spray mixture obtained is applied.

A joint herbicidal formulation of the herbicidal compositions according to the invention has the advantage that it can be applied more easily because the amounts of the components have already been adjusted with respect to one another to the correct ratio. Moreover, the auxiliaries of the formulation can be selected to.suit each other in the best possible way, while a tank mix of various formulations may result in undesirable combinations of auxiliaries.

### A. FORMULATIONS EXAMPLES

a) A dust (WP) is obtained by mixing 10 parts by weight of an active compound/active compound mixture and 90 parts by weight of talc as inert substance and comminuting the mixture in a hammer mill.

b) A wettable powder (WG) which is readily dispersible in water is obtained by mixing 25 parts by weight of an active compound/active compound mixture, 64 parts by weight of kaolin-containing quartz as inert substance, 10 parts by weight of potassium lignosulfonate and 1 part by weight of sodium oleoylmethyltaurinate as wetting agent and dispersant, and grinding the mixture in a pinned-disk mill.

c) A dispersion concentrate which is readily dispersible in water is obtained by mixing 20 parts by weight of an active compound/active compound mixture with 6 parts by weight of alkylphenol polyglycol ether (Triton X 207), 3 parts by weight of isotridecanol polyglycol ether (8 EO) and 71 parts by weight of paraffinic mineral oil (boiling range for example approximately 255 to 277° C.) and grinding the mixture in a ball mill to a fineness of below 5 microns.

d) An emulsifiable concentrate (EC) is obtained from 15 parts by weight of an active compound/active compound mixture, 75 parts by weight of cyclohexanone as solvent and 10 parts by weight of ethoxylated nonylphenol as emulsifier.

e) Water-dispersible granules are obtained by mixing
75 parts by weight of an active compound/active compound mixture,
10 parts by weight of calcium lignosulfonate,
5 parts by weight of sodium lauryl sulfate, 3 parts.by weight of polyvinyl alcohol and
7 parts by weight of kaolin,
   grinding the mixture in a pinned-disk mill and granulating the powder in a fluidized bed by spraying on water as granulation liquid.

f) Water-dispersible granules are also obtained. by homogenizing and precomminuting, in a colloid mill,
25 parts by weight of an active compound/active compound mixture,
5 parts by weight of sodium 2,2′-dinaphthylmethane-6,6′-disulfonate,
2 parts by weight of sodium oleoylmethyltaurinate,
1 part by weight of polyvinyl alcohol,
17 parts by weight of calcium carbonate and
50 parts by weight of water,
   subsequently grinding the mixture in a bead mill and atomizing and drying the resulting suspension in a spray tower by means of a single-substance nozzle.

### B. BIOLOGICAL EXAMPLES

1. Herbicidal Pre-Emergence Action

Seeds of monocotyledonous and dicotyledonous weed and crop plants are placed into sandy loam in cardboard pots and covered with soil. The herbicidal compositions according to the invention, formulated in the form of wettable powders or emulsion concentrates, are then applied as an aqueous suspension or emulsion with a water application rate of 600 to 800 l/ha (converted) in different dosages to the surface of the covering soil. After the treatment, the pots are placed in a greenhouse and kept under good growth conditions for the weeds. Optical scoring of the damage to the plants or the emergence damage is carried out after emergence of the test plants after a test period of 3 to 4 weeks, by comparison with untreated controls. The results are summarized in Table A.

2. Herbicidal Post-Emergence Action

Seeds of monocotyledonous and dicotyledonous weed and crop plants are placed into sandy loam in wood fiber pots or in plastic pots, covered with soil and cultivated in a greenhouse, including during the vegetation period outdoors outside of the greenhouse, under good growth conditions. 2-3 weeks after sowing, the test plants are treated at the one- to three-leaf stage. The herbicidal compositions according to the invention, formulated as wettable powders (WP) or liquid (EC) are, in various dosages with a water application rate of 300 l/ha (converted), with added wetting agent (0.2 to 0.3%), sprayed onto the plants and the surface of the soil. 3 to 4 weeks after the treatment of the test plants, the effect of the preparations is rated visually in comparison to untreated controls. The results are summarized in Table B.

3. Treatment of Seed

Corn seed is treated (dressed) with various amounts of a safener and then placed-in sandy loam and covered with soil. The herbicides, formulated as emulsifiable concentrates or dust, are applied using a water application rate of 300 to 800 l/ha (converted) at various dosages to the surface of the covering soil. The optical scoring of the damage to the useful plants is carried out 3 to 5 weeks after the treatment. The results are summarized in Tables C and D.

The herbicidal activity or damage is in each case stated in percent: 100% activity=the plants have died, 0% activity=like untreated control plants. The abbreviation “a.i.” means active ingredient.

TABLE A
Pre-emergence action

| | Dosage | Damage to | Damage |
|---|---|---|---|
| Component | [g of a.i./ha] | corn | reduced by |
| B1.1 | 31 | 90% | 78% |
| B1.1 + A3 | 31 + 100 | 20% | |
| B1.3 | 25 | 65% | 69% |
| B1.3 + A3 | 25 + 100 | 20% | |
| B1.4 | 50 | 45% | 33% |
| B1.4 + A3 | 50 + 100 | 30% | |
| B1.6 | 125 | 30% | 67% |
| B1.6 + A3 | 125 + 100 | 10% | |
| B1.8 | 125 | 60% | 67% |
| B1.8 + A3 | 125 + 100 | 20% | |
| B1.9 | 25 | 30% | 100% |
| B1.9 + A3 | 25 + 100 | 0% | |
| B1.10 | 20 | 20% | 50% |
| B1.10 + A3 | 20 + 100 | 10% | |
| B1.11 | 31 | 70% | 43% |
| B1.11 + A3 | 31 + 100 | 40% | |
| B1.13 | 63 | 40% | 50% |
| B1.13 + A3 | 63 + 100 | 20% | |
| B1.16 | 200 | 70% | 57% |
| B1.16 + A3 | 200 + 100 | 30% | |
| B1.22 | 75 | 90% | 56% |
| B1.22 + A3 | 75 + 100 | 40% | |
| B1.28 | 150 | 70% | 71% |
| B1.28 + A3 | 150 + 100 | 20% | |
| B1.32 | 31 | 80% | 38% |
| B1.32 + A3 | 31 + 100 | 50% | |
| B3.1 | 1280 | 10% | 50% |
| B3.1 + A3 | 1280 + 1280 | 5% | |
| B5.2 | 1500 | 23% | 78% |
| B5.2 + A3 | 1500 + 300 | 5% | |
| B10.1 | 3300 | 65% | 54% |
| B10.1 + A3 | 3300 + 300 | 30% | |

TABLE B
Post-emergence action

| | Dosage | Damage to | Damage |
|---|---|---|---|
| Component | [g of a.i./ha] | corn | reduced by |
| B1.1 | 31 | 100% | 70% |
| B1.1 + A3 | 31 + 100 | 30% | |
| B1.2 | 50 | 40% | 100% |
| B1.2 + A3 | 50 + 100 | 0% | |
| B1.5 | 13 | 50% | 80% |
| B1.5 + A3 | 13 + 100 | 10% | |
| B1.11 | 63 | 60% | 50% |
| B1.11 + A3 | 63 + 100 | 30% | |
| B1.12 | 31 | 70% | 86% |
| B1.12 + A3 | 31 + 100 | 10% | |
| B1.15 | 50 | 80% | 88% |
| B1.15 + A3 | 50 + 100 | 10% | |
| B1.13 | 63 | 40% | 50% |
| B1.13 + A3 | 63 + 100 | 20% | |
| B1.16 | 200 | 70% | 43% |
| B1.16 + A3 | 200 + 100 | 40% | |
| B1.17 | 31 | 10% | 100% |
| B1.17 + A3 | 31 + 100 | 0% | |
| B1.18 | 40 | 50% | 40% |
| B1.18 + A3 | 31 + 100 | 30% | |
| B1.19 | 125 | 60% | 33% |
| B1.19 + A3 | 125 + 100 | 40% | |
| B1.21 | 100 | 70% | 71% |
| B1.21 + A3 | 100 + 100 | 20% | |
| B1.25 | 125 | 50% | 80% |
| B1.25 + A3 | 125 + 100 | 10% | |
| B1.26 | 25 | 70% | 86% |
| B1.26 + A3 | 25 + 100 | 10% | |
| B1.31 | 38 | 40% | 75% |
| B1.31 + A3 | 38 + 100 | 10% | |
| B2.1 | 200 | 65% | 77% |
| B2.1 + A3 | 200 + 50 | 15% | |
| B2.3 | 200 | 60% | 83% |
| B2.3 + A3 | 200 + 200 | 10% | |
| B2.4 | 200 | 28% | 64% |
| B2.4 + A3 | 200 + 100 | 10% | |
| B4.1 | 3500 | 13% | 62% |
| B4.1 + A3 | 3500 + 100 | 5% | |
| B7.1 | 400 | 30% | 100% |
| B7.1 + A3 | 400 + 50 | 0% | |
| B1.36 | 40 | 35% | 100% |
| B1.36 + A3 | 40 + 60 | 0% | |

In Tables 3 and 4, the dosage of the herbicide (component B) is stated in gram per hectare and that of the safener (component A) is stated in gram per kilogram of seed.

TABLE C
Action in the case of seed treatment, pre-emergence

| Component | Dosage | Damage to corn | Damage reduced by |
|---|---|---|---|
| B1.10 | 63 | 50% | 60% |
| B1.10 + A3 | 63 + 0.5 | 20% | |
| B1.25 | 40 | 40% | 50% |
| B1.25 + A3 | 40 + 0.5 | 20% | |

TABLE D
Action in the case of seed treatment, post-emergence

| Component | Dosage | Damage to corn | Damage reduced by |
|---|---|---|---|
| B1.1 | 31 | 100% | 80% |
| B1.1 + A3 | 31 + 0.5 | 20% | |
| B1.2 | 50 | 40% | 100% |
| B1.2 + A3 | 50 + 0.5 | 0% | |
| B1.5 | 13 | 50% | 80% |
| B1.5 + A3 | 13 + 0.5 | 10% | |
| B1.12 | 31 | 70% | 71% |
| B1.12 + A3 | 31 + 0.5 | 20% | |
| B1.15 | 50 | 80% | 63% |
| B1.15 + A3 | 50 + 0.5 | 30% | |
| B1.23 | 38 | 95% | 68% |
| B1.23 + A3 | 38 + 0.5 | 30% | |
| B1.25 | 125 | 65% | 69% |
| B1.25 + A3 | 125 + 0.5 | 20% | |
| B1.26 | 25 | 70% | 57% |
| B1.26 + A3 | 25 + 0.5 | 30% | |
| B1.31 | 38 | 40% | 75% |
| B1.31 + A3 | 38 + 0.5 | 10% | |
| B1.33 | 38 | 95% | 47% |
| B1.33 + A3 | 38 + 0.5 | 50% | |

The results of Tables A to D show that the herbicidal compositions according to the invention result in a considerable reduction of the damage to crop plants.

1. A herbicidal composition, comprising an effective amount of
A) an antidotically effective amount of one or more safeners from the group of the acylsulfamoylbenzamides of the formula (I), if appropriate also in salt form, (component A) 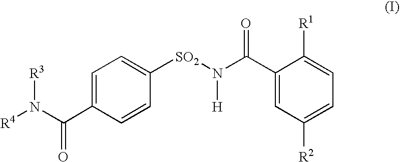
in which
R¹ is methyl, methoxy or trifluoromethoxy;
R² is hydrogen, chlorine or methyl;
R³ is hydrogen, ethyl or propargyl;
R⁴ is ethyl, cyclopropyl, isopropyl or propargyl, or
R³ and R⁴ together form the group (CH₂)₄;
and
B) a herbicidally effective amount of one or more herbicides (component B) comprising flucarbazone, foramsulfuron, iodosulfuron, metosulam, metsulfuron, nicosulfuron, primisulfuron, prosulfuron, thifensulfuron, tribenuron, cloransulam-methyl, chlorimuron, ethoxysulfuron, flazasulfuron, florasulam, flumetsulam, halosulfuron, imazamox, imazapic, imazapyr, imazethapyr, mesosulfuron, propoxycarbazone, sulfosulfuron, amidosulfuron, chlorsulfuron, imazaquin, triasulfuron, sulfometuron, cyclosulfamuron, flupyrsulfuron, pyrazosulfuron, azimsulfuron, bensulfuron, bispyribac, rimsulfuron, tritosulfuron, sulcotrione, clomazone, mesotrione, topramezone, metribuzin, bentazone, bromoxynil, propanil, atrazine, terbuthylazine, EPTC, tepraloxydim, clethodim, alloyxdim, sethoxydim, tralkoxydim, clodinafop-propargyl, cyhalofop-butyl, diclofop-methyl, fenoxaprop-P-ethyl, fluazifop-P-butyl, haloxyfop-methyl, haloxyfop-etotyl, haloxyfop-R-methyl, haloxyfop-ethoxyethyl, propaquizafop, quizalofop-P-tefuryl, quizalofop-P-ethyl, acetochlor, S-metolachlor, flumioxazin, flumiclorac, fomesafen, sulfentrazone, dicamba, MCPA, MCPB, 2,4-D, clopyralid, fluroxypyr, picloram, triclopyr, glufosinate, glyphosate and pendimethalin,
where these compositions comprise the components A and B in a weight ratio of from 1:200 to 200:1.

2. The herbicidal composition as claimed in claim 1 which comprises an effective amount of
A) one or more safeners A of the formula (I) (component A),
and
B) a herbicidally effective amount of one or more herbicides (component B) flucarbazone, foramsulfuron, iodosulfuron, metosulam, metsulfuron, nicosulfuron, primisulfuron, prosulfuron, thifensu lfuron, tribenu ron, cloransulam-methyl, chlorimuron, ethoxysulfuron, flazasulfuron, florasulam, flumetsulam, halosulfuron, imazamox, imazapic, imazapyr, imazethapyr, mesosulfuron, propoxycarbazone; sulfosulfuron, amidosulfuron, chlorsulfuron, imazaquin, triasulfuron, sulfometuron, cyclosulfamuron, flupyrsulfuron, pyrazosulfuron, azimsulfuron, bensulfuron, bispyribac, sulcotrione, clomazone, mesotrione, topramezone, metribuzin, bentazone, bromoxynil, propanil, EPTC, tepraloxydim, clethodim, acetochlor, S-metolachlor, flumioxazin, flumiclorac, fomesafen, sulfentrazone, dicamba, MCPA, MCPB, 2,4-D, clopyralid, fluroxypyr, picloram, triclopyr, glufosinate, glyphosate and pendimethalin.

3. The herbicidal composition as claimed in claim 1 which comprises, as component A, acylsulfamoylbenzamides of the formula (I) in which
R¹ is methoxy;
R² is hydrogen, chlorine or methyl;
R³ is hydrogen or ethyl;
R⁴ is ethyl, cyclopropyl or isopropyl.

4. The herbicidal composition as claimed in claim 1 which comprises, as component A, one or more safeners A1, A2, A3 or A4:

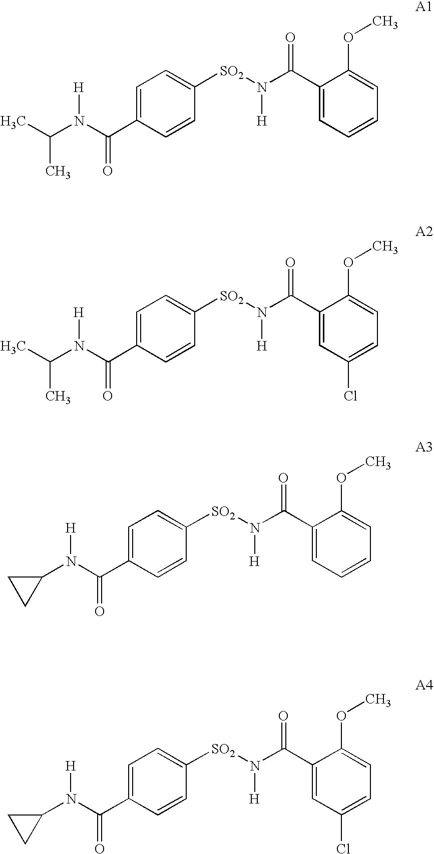

5. The herbicidal composition as claimed in claim 1 which comprises, as component B, one or more herbicides selected from the group consisting of flucarbazone, foramsulfuron, iodosulfuron, metosulam, metsulfuron, nicosulfuron, primisulfuron, prosulfuron, thifensulfuron, tribenuron, cloransulam-methyl, chlorimuron, ethoxysulfuron, flazasulfuron, florasulam, flumetsulam, halosulfuron, imazamox, imazapic, imazapyr, imazethapyr, mesosulfuron, propoxycarbazone, sulfosulfuron, sulcotrione, mesotrione, topramezone, metribuzin, acetochlor, S-metolachlor, sulfentrazone, dicamba, MCPA, MCPB, 2,4-D, glufosinate and glyphosate.

6. The herbicidal composition as claimed in claim 1, wherein the. seed of a crop plant is dressed with a safener A and the herbicide B is applied before or after the emergence of the plants.

7. The herbicidal composition as claimed in claim 6, wherein the seed of a crop plant is additionally dressed with one or more fungicides and/or insecticides comprising the compounds N-[2-(1,3-dimethylbutyl)phenyl]-5-fluoro-1,3-dimethyl-1H-pyrazole-4-carboxamide, carbendazim, fluoxastrobin, fluquinconazole, iprodione, prothioconazole, tebuconazole, triadimenol, trifloxystrobin, triticonazole, fludioxinil, metalaxyl, mefenoxam, captan, TMTD, beta-cyfluthrin, clothianidin, ethiprole, fipronil, imidacloprid, methiocarb, thiodicarb, thiamethoxam, azoxystrobin and ipoconazole.

8. A method for controlling harmful plants in crops of useful plants which comprises applying a herbicidally effective amount of a herbicidally active composition according to claim 1 to the harmful plants, the crop plants, the plant seeds or the area in which the plants grow.

9. The method as claimed in claim 8 wherein safener and fungicide and/or insecticide and herbicide are applied at different times.

10. The method as claimed in claim 8 wherein the seed is dressed with safener and fungicide and/or insecticide in a pretreatment step and the herbicide is applied in a further step.

11. The method as claimed in claim 8 for controlling harmful plants in crops of monocotyledonous plants.

12. The method as claimed in claim 8, wherein the plants are from the group consisting of corn, wheat, rye, barley, oats, rice, sorghum, cotton and soybeans.

13. The method as claimed in claim 12 wherein the crop plants are genetically modified or have been obtained by mutation selection.
